(19) United States
(12) Patent Application Publication
(10) Pub. No.: US 2007/0082254 A1
(43) Pub. Date: Apr. 12, 2007

(54) Solid oxide fuel cell

(76) Inventor: Kenichi Hiwatashi, Kitakyushu-shi (JP)

Correspondence Address: LADAS & PARRY, 26 WEST 61ST STREET, NEW YORK, NY, 10023, US

(21) Appl. No.: 10/567,239

(22) PCT Filed: Aug. 6, 2004
(86) PCT No.: PCT/JP04/11368

§ 371 Date: Oct. 4, 2006

(30) Foreign Application Priority Data
Aug. 6, 2003 (JP) 2003-288039

(51) Int. Cl. H01M 4/90; H01M 8/12

(52) U.S. Cl. 429/44; 429/30

(57) ABSTRACT

A solid oxide fuel cell is disclosed which is excellent in output performance and durability. The solid oxide fuel cell comprises at least an electrolyte, an air electrode and a fuel electrode, and the air electrode includes a perovskite oxide containing at least manganese. A layer which is in contact with the fuel electrode is formed to contain 0.3 to 4 weight % of manganese in the surface facing the fuel electrode. This invention has been made basing on the finding such that, in a solid oxide fuel cell having an air electrode composed of a perovskite oxide containing manganese, the manganese content in the fuel electrode side surface of a layer which is in contact with the fuel electrode greatly affects the performance of the fuel cell, and thus an excellent fuel cell can be obtained by controlling this manganese content.

### BACKGROUND OF THE INVENTION

1. Field of invention

The present invention relates to a solid oxide fuel cell. More particularly, the present invention relates to a solid oxide fuel cell possessing excellent output performance and durability.

2. Background art

Solid oxide fuel cells have a high operating temperature (900 to 1000° C.) and are expected as a highly efficient fuel cell. Various proposals have been made for realizing solid oxide fuel cells possessing excellent output performance and durability.

For example, Japanese Patent Laid-Open Nos. 22821/2003 and 22822/2003 propose the addition of at least one oxide selected from the group consisting of group 4A, 5A, 7A, and 4B elements into solid oxide fuel cells, in order to improve oxygen ion conductivity stability and high temperature strength stability of an electrolyte formed of zirconia containing scandia in solid solution.

These publications have, however, no disclosure of a combination of the oxide with an air electrode formed of a manganese-containing perovskite. Further, these publications describe that manganese is added as an oxide of group 7A element MnO₂. The addition amount thereof, however, is not clear.

Further, Japanese Patent Laid-Open No. 187811/2003 proposes a mixed material composed of an electron conductive perovskite oxide and a high-melting dielectric oxide which is provided between an air electrode and an electrolyte in order to realize an efficient reaction represented by formula (1) described later, in which oxygen gas produced in the air electrode and the electrolyte is reacted with electrons to produce oxygen ions. Lanthanum manganite containing Sr or Ca in solid solution may be mentioned as a representative example of the perovskite oxide used in this technique. Examples of compositions thereof include (La, Sr)_{1-δ}MnO₃, (La, Ca)_{1-δ}MnO₃, and (La, Sr)_{1-δ}(Mn_{y}Fe_{1-y})O₃. Further, cerium-containing oxides containing Sm₂O₃ or Gd₂O₃ in solid solution are proposed as a typical example of the high-melting dielectric oxide.

Japanese Patent Laid-Open No. 41674/1996 proposes, as an air electrode in a solid oxide fuel cell, the use of a material, prepared by mixing 40 to 60 parts by weight of zirconia containing yttria in solid solution to a lanthanum manganite represented by (La_{1-X1}Sr_{X1})MnO₃ wherein 0.1≦x1≦0.4, in order to improve an electrode reaction between an air electrode and an electrolyte, as well as to provide excellent durability.

Japanese Patent Laid-Open No. 180886/1996 discloses a thin layer formed of zirconia containing yttria in solid solution which is provided between an air electrode and an electrolyte, in order to reduce contact resistance between the air electrode and the electrolyte and to improve the output performance. The air electrode material used in this technique is lanthanum manganite containing Sr in solid solution.

Japanese Patent Laid-Open No. 44245/2000 discloses the provision of a layer formed of a powder of a mixture of lanthanum manganite containing Ca and/or Sr in solid solution with zirconia containing yttria in solid solution between an air electrode and an electrolyte. This is to reduce contact resistance between the air electrode and the electrolyte and to improve the output performance.

Japanese Patent Laid-Open No. 173801/2003 proposes that, in a solid oxide fuel cell, a layer having a porosity of not more than 25% and formed of a cerium-containing oxide represented by Ce₁₋ₓLnₓO_{2-δ}, wherein Ln represents a rare earth element; and 0.05≦x≦0.3, is provided to prevent a reaction between an electrolyte and a fuel electrode.

So far as the present inventors know, however, even in these prior art techniques neither disclose nor suggest the suppression of diffusion of manganese through the electrolyte.

On the other hand, Japanese Patent Laid-Open No. 134132/2002 proposes the provision of an oxide layer containing yttria, zirconia, and ceria between an air electrode and an electrolyte in a solid oxide fuel cell prepared by co-sintering an air electrode formed of a manganese-containing peroviskite oxide and an electrolyte formed of zirconia. This is to suppress the diffusion of manganese into a fuel electrode. However, the oxide containing yttria, zirconia, and ceria is poor in degree of sintering, and a sintering temperature of about 1500° C. is necessary for the formation of a gas permeation-free electrolyte. Therefore, it is considered that the control of the amount of manganese diffused into the fuel electrode through the electrolyte is difficult.

### SUMMARY OF THE INVENTION

The present inventors have now found that, in a solid oxide fuel cell comprising an air electrode formed of a perovskite oxide containing at least manganese, the content of manganese in the layer, in contact with the fuel electrode, in its surface on the fuel electrode side greatly affects the performance of the fuel cell, and the regulation of the manganese content can provide an excellent fuel cell. The present invention has been made base on such finding.

Accordingly, an object of the present invention is to provide a solid oxide fuel cell possessing excellent output performance and durability.

According to the present invention, there is provided a solid oxide fuel cell comprising at least an electrolyte, an air electrode, and a fuel electrode, characterized in that the air electrode comprises a perovskite oxide containing at least manganese, and the content of manganese in the surface of a layer which is in contact with the fuel electrode is 0.3 to 4% by weight, where the surface is on the fuel electrode side of the layer.

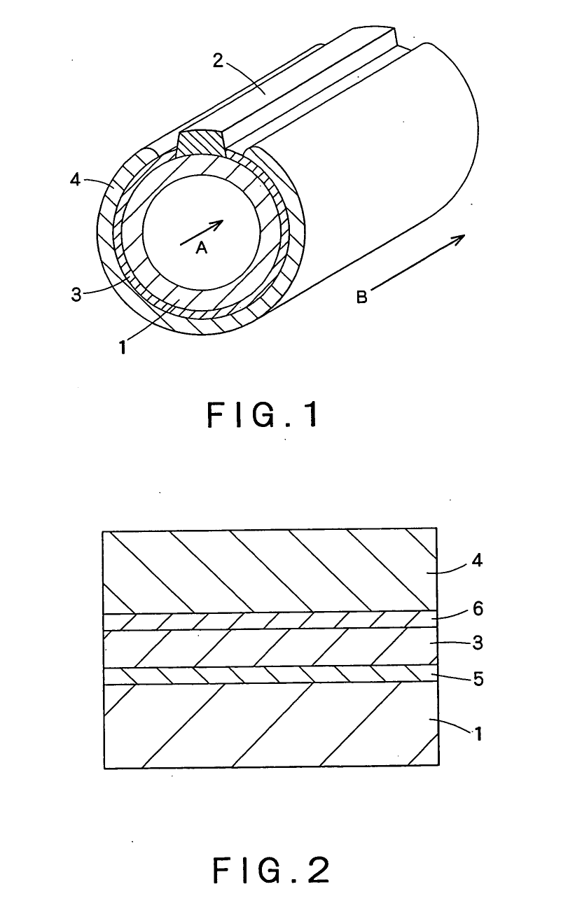

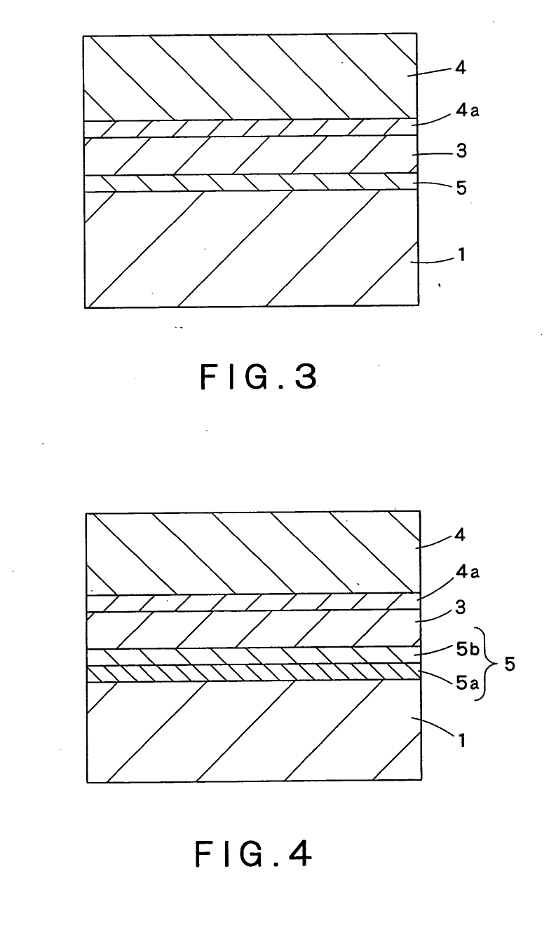

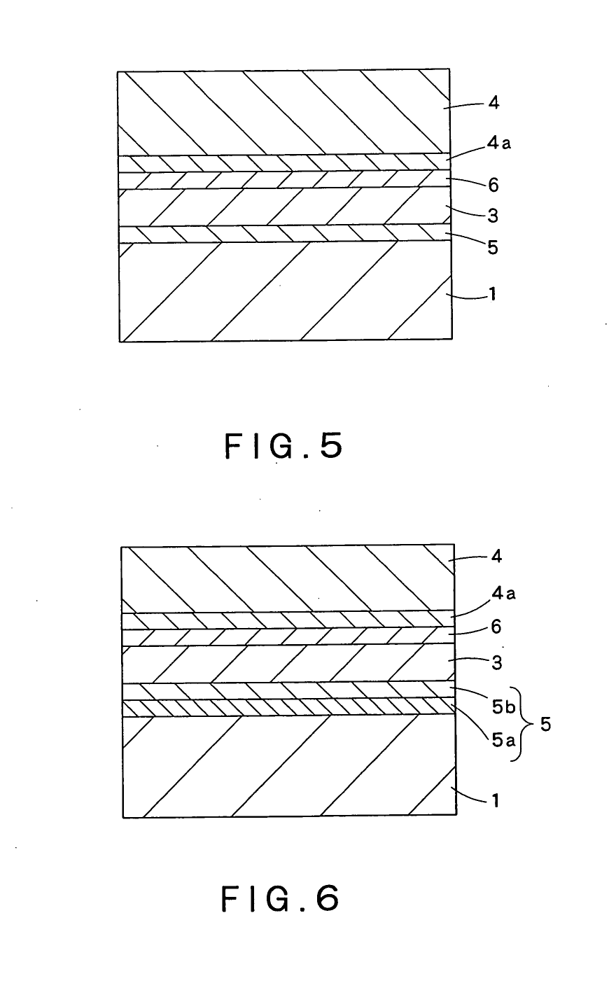

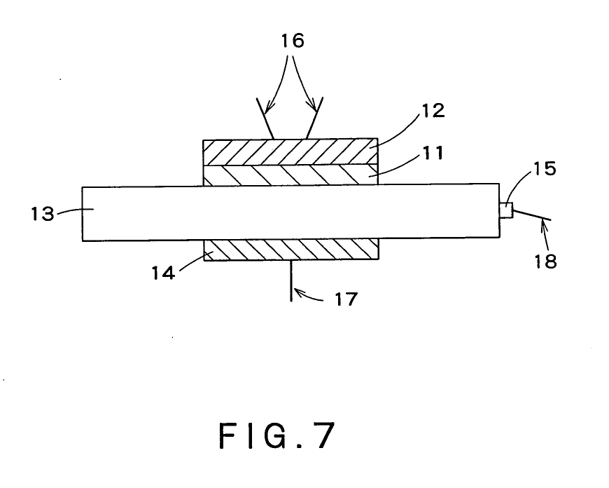

### BRIEF DESCRIPTION OF THE DRAWINGS

[FIG. 1] is a cross-sectional view of a cylindrical solid oxide fuel cell.

[FIG. 2] is an enlarged cross-sectional view showing the basic construction of a solid oxide fuel cell according to the present invention. The solid oxide fuel cell according to the present invention has a basic construction comprising an air electrode support 1, an electrolyte 3, and a fuel electrode 4. In this drawing, an air-side electrode reaction layer 5 as one embodiment of the air electrode is provided between the air electrode support 1 and the electrolyte 3, and a porous layer 6 is provided between the electrolyte 3 and the fuel electrode 4. Air (oxygen) is allowed to flow in a direction indicated by an arrow into the air support 1 to bring air into contact with the air electrode. A fuel gas (for example, hydrogen, carbon monoxide, or methane) is allowed to flow in a direction indicated by an arrow along the fuel electrode 4 to bring the fuel gas into contact with the fuel electrode.

[FIG. 3] is an enlarged cross-sectional view of a solid oxide fuel cell having the same construction as in FIG. 2, except that the porous layer 6 is not provided, and a fuel-side electrode reaction layer 4a is provided between the electrolyte 3 and the fuel electrode 4.

[FIG. 4] is an enlarged view of a solid oxide fuel cell having the same construction as in FIG. 3, except that the air-side electrode reaction layer 5 has a structure of a plurality of layers (5a, 5b).

[FIG. 5] is an enlarged view of a solid oxide fuel cell in which, in the structure shown in FIG. 3, a porous layer 6 is additionally provided between the fuel-side electrode reaction layer 4a and the electrolyte 3.

[FIG. 6] is an enlarged view of a solid oxide fuel cell having the same construction as in FIG. 5, except that the air-side electrode reaction layer 5 has a structure of a plurality of layers (5a, 5b).

[FIG. 7] is a diagram having a cell construction for measuring a reaction overvoltage for evaluating electrode characteristics.

### DETAILED DESCRIPTION OF THE INVENTION

Basic Construction of Solid Oxide Fuel Cell

The structure of the solid oxide fuel cell according to the present invention is not particularly limited so far as the construction and composition of the present invention which will be described later are satisfied. For example, any of a flat plate type and a cylindrical type may be adopted. The solid oxide fuel cell in the present invention can also be applied to a microtube type (outer diameter: not more than 10 mm, more preferably not more than 5 mm). For example, a cylindrical construction will be described below. Specifically, FIG. 1 is a cross-sectional view of a cylindrical solid oxide full cell. This solid oxide fuel cell is constructed so that a strip-shaped interconnector 2 and an electrolyte 3 are provided on a cylindrical air electrode support 1 and, further, a fuel electrode 4 is provided on the electrolyte 3 so as not to come into contact with the interconnector 2. When air (oxygen) is allowed to flow through the interior of the air electrode support while a fuel gas is allowed to flow through the outside, oxygen is converted to oxygen ion at the interface of the air electrode and the electrolyte according to the following reaction.
1/2O₂+2e⁻→O²⁻ (1)

This oxygen ion is passed through the electrolyte and reaches the fuel electrode. In the fuel electrode in its part near the electrolyte, the fuel gas is reacted with the oxygen ion to give water and carbon dioxide. These reactions are expressed by the following formulae.
H₂+O²⁻→H₂O+2e⁻ (2)
CO+O²⁻→CO₂+2e⁻ (3)

Electricity can be taken out to the outside by connecting the fuel electrode 4 to the interconnector 2.

FIG. 2 is an enlarged cross-sectional view showing the basic construction of a solid oxide fuel cell according to the present invention. The solid oxide fuel cell according to the present invention has a basic structure comprising an air electrode support 1, an electrolyte 3, and a fuel electrode 4. In FIG. 2, an air-side electrode reaction layer 5 as one embodiment of the air electrode is provided between the air electrode support 1 and the electrolyte 3, and a porous layer 6 is provided between the electrolyte 3 and the fuel electrode 4. The air-side electrode reaction layer 5 and the porous layer 6 are not indispensable to the present invention but is preferably provided.

Further, in another preferred embodiment of the present invention, as shown in FIG. 3, the solid oxide fuel cell according to the present invention may be provided with a fuel-side electrode reaction layer 4a as one embodiment of the fuel electrode.

Further, in still another preferred embodiment of the present invention, as shown in FIG. 4, the air-side electrode reaction layer 5 in the solid oxide fuel cell may have a multilayer structure of a plurality of layers (5a, 5b).

In a further embodiment of the present invention, there is provided an embodiment comprising a combination of the above constituent elements. For example, as shown in FIG. 5, there is provided a solid oxide fuel cell comprising a porous layer 6 provided between a fuel electrode 4 (an aspect including a fuel-side electrode reaction layer 4a) and an electrolyte 3. In another embodiment of the present invention, there is provided a solid oxide fuel cell having a construction shown in FIG. 6 in which the air-side electrode reaction layer has a multilayer structure of a plurality of layers.

The present invention is characterized in that the content of manganese in a layer, in contact with the fuel electrode, in its surface on the fuel electrode side is 0.3 to 4% by weight.

Accordingly, when the electrolyte is provided in contact with the fuel electrode, and the content of manganese in the surface of the electrolyte on its fuel electrode side is 0.3 to 4% by weight. In a preferred embodiment of the present invention, the content of manganese in the surface of the electrode on its fuel electrode side is preferably 0.6 to 3.5% by weight, more preferably 0.9 to 3% by weight. Further, in this embodiment, the content of manganese in the surface of the electrolyte on its air electrode side is preferably less than about 10% by weight, more preferably less than 6% by weight. In a further preferred embodiment of the present invention, the content of manganese in the surface of the electrolyte on its air electrode side is larger than the content of the manganese component in the surface of the electrolyte on its fuel electrode side.

When a porous layer is provided between the fuel electrode and the electrolyte, the content of manganese in the surface of the porous layer on its fuel electrode side is 0.3 to 4% by weight. In a preferred embodiment of the present invention, the content of manganese in the surface of the porous layer on its fuel electrode side is preferably 0.6 to 3.5% by weight, more preferably 0.9 to 3% by weight. In a further preferred embodiment of the present invention, the content of manganese in the surface of the electrolyte on its air electrode side is larger than the content of manganese in the surface of the porous layer on its fuel electrode side.

In the present invention, the “content of manganese in the surface of the layer” in the “content of manganese in the layer, in contact with the fuel electrode, in its surface on the fuel electrode side” refers to the content of manganese, in the layer in contact with the fuel electrode, in its part of not more than 3 μm depth from the surface of the fuel electrode. The content of manganese may be determined by any of analysis from the fuel electrode side and analysis in which a section is prepared and analysis is carried out from the sectional direction.

In the present invention as described above, in the layer in contact with the fuel electrode, the content of manganese in the surface on its fuel electrode side is regulated. It is considered that this manganese is diffused from manganese-containing perovskite oxide constituting the air electrode during sintering in the production of the layer. The regulation of the diffusion amount can realize a solid oxide fuel cell that possesses excellent output properties and, even when it undergoes a thermal cycle, can maintain the performance, that is, possesses excellent durability. The reason why the regulation of the manganese content can realize a good solid oxide fuel cell has not been fully elucidated yet. Without wishing to be bound by theory, it is believed that the content of manganese falls within the above-defined range at the interface of the fuel electrode and the layer in contact with the fuel electrode, satisfactory sintering can significantly improve the adhesion between the two layers and, further, the electrolyte ensures good ion conductivity to contribute to an improvement in the properties.

In the present invention, the content of manganese in the layer, in contact with the fuel electrode, in its surface on the fuel electrode side can be regulated by regulating the composition and physical construction of the cell and production conditions. Elements constituting the solid oxide fuel cell according to the present invention including specific means for the regulation of the manganese content will be described in detail.

Electrolyte

In the present invention, the electrolyte has high oxygen ion (O²⁻) conductivity at elevated temperatures, is a gas permeability-free layer, and is preferably a layer formed of zirconia containing scandia and/or yttria in solid solution. In the present specification, zirconia containing scandia in solid solution will be referred to as “SSZ,” zirconia containing scandia and yttria in solid solution will be referred to as “ScYSZ” or “SSZ/YSZ,” and zirconia containing yttria in solid solution will be referred to as “YSZ.”

In a preferred embodiment of the present invention, the amount of solid solution of scandia in SSZ, the total amount of solid solution of scandia and yttria in ScYSZ, and the amount of solid solution of yttria in YSZ are preferably about 3 to 12% by mole from the viewpoint of realizing a high level of oxygen ion conductivity. More preferably, the lower limit of the solid solution amount is about 8% by mole. In a preferred embodiment of the present invention, in order to improve the oxygen ion conductivity, at least one oxide selected from the group consisting of CeO₂, Sm₂O₃, Gd₂O₃, Yb₂O₃, Gd₂O₃, Er₂O₃, Nd₂O₃, Eu₂O₃, Ey₂O₃, Tm₂O₃, Pr₂O₃, La₂O₃, and Bi₂O₃ may be contained in solid solution in a total amount of about 5% by mole or less. Further, for example, Bi₂O₃, Al₂O₃, and SiO₂ may be added to realize sintering at low temperatures.

Further, in a preferred embodiment of the present invention, the electrolyte in its film surface on the fuel electrode side has such a crystal grain size distribution that 3% of the crystal grains has a diameter of not less than 3 μm and 97% of the crystal grains has a diameter of not more than 20 μm. When the crystal grain size distribution is in the above-defined range, by virtue of good sinterability, an electrolyte can be realized which is free from gas permeability and has good adhesion to the fuel electrode.

The crystal grain size in the electrolyte surface on the fuel electrode side refers to a grain size distribution determined by a planimetric method. Specifically, at the outset, a photograph of the electrolyte surface is taken with SEM. A known circle having an area (S) is drawn on this photograph, and the number of grains N_{G} per unit area is determined from the number of grains n_{c} present within the circle and the number of grains nᵢ present on the circumference by the following equation:
N_{G}=(n_{c}+1/2nᵢ)/(S/m²)

wherein m represents the magnification of the photograph. Since 1/N_{G} represents the area occupied by one particle, when the crystal grain diameter is an equivalent circle diameter, 2/√(πN_{G}) may be adopted for the determination, while, in the case of square, 1/√N_{G} may be adopted.

Further, in the present invention, 3% diameter of crystal grains in the electrolyte refers to the grain diameter corresponding to the third smallest grain, when the crystal grain diameter of 100 crystal grains is measured by a planimetric method and the grains are placed in diameter ascending order, and 97% diameter refers to the grain diameter corresponding to the 97th smallest grain.

In the present invention, that the electrolyte is free from gas permeability can be specifically confirmed by providing a pressure difference between the one side of the electrolyte and the opposite side of the electrolyte and determining the amount of permeation of N₂ gas through the electrolyte. In a preferred embodiment of the present invention, the gas permeation amount Q of the electrolyte is preferably Q≦2.8×10⁻⁹ ms⁻¹Pa⁻¹, more preferably Q≦2.8×10⁻¹⁰ ms⁻¹Pa⁻¹.

In the present invention, the thickness of the electrolyte may be properly determined. Preferably, however, the thickness of the electrolyte is about 10 μm to 100 μm from the viewpoint of durability and the like.

The electrolyte according to the present invention may be prepared from a raw material powder of zirconia containing scandia and/or yttria in solid solution. A raw material powder, which has been regulated so that the BET value is 0.5 to 20 m²g⁻¹ and the particle size distribution is such that the 3% diameter is not less than 0.1 μm, the 97% diameter is not more than 2 μm, and the average particle diameter is about 0.3 to 1 μm, is more preferred from the viewpoint of preparing an electrolyte which is free from gas permeability and can realize proper crystal grain diameters. In the present invention, the BET value is preferably a value as determined by measurement with a flow type specific surface area measuring device Flow Sorb II 2300 manufactured by Shimadzu Seisakusho Ltd. The particle size distribution is preferably determined by measurement with a laser diffraction-type particle size distribution measuring device SALD-2000 manufactured by Shimadzu Seisakusho Ltd. Further, the average particle diameter is preferably a median diameter (50% diameter) value determined by measurement with a laser diffraction-type particle size distribution measuring device SALD-2000 manufactured by Shimadzu Seisakusho Ltd.

The electrolyte may be prepared by any method without particular limitation. Slurry coating, screen printing, and sheet bonding are preferred from the viewpoints of excellent mass productivity and low cost.

The raw material for the electrolyte may be prepared by any method without particular limitation so far as yttria and/or scandia are homogeneously contained in solid solution. However, coprecipitation is a common method and is preferred.

In another preferred embodiment of the present invention, the electrolyte has a multilayer structure of at least two layers. The multilayer structure may be such that a layer of zirconia containing yttria in solid solution (YSZ) is provided on the air-side electrode layer reaction side and a layer of zirconia containing scandia in solid solution (SSZ) is provided on the fuel electrode side. Alternatively, the multilayer structure may be such that zirconia containing scandia in solid solution (SSZ) is provided on the air-side electrode layer reaction side and a layer of zirconia containing yttria in solid solution (YSZ) is provided on the fuel electrode side.

Further, in still another preferred embodiment of the present invention, the electrolyte have a multilayer structure of at least three layers. In this case, a layer of SSZ, a layer of YSZ, and a layer of SSZ may be stacked in that order.

In a further preferred embodiment of the present invention, in the electrolyte, the proportion ratio of SSZ/YSZ may be varied. For example, the proportion ratio may be such that, in the electrolyte on its air electrode side, SSZ/YSZ=3/1 while, in the electrolyte on its fuel electrode side, SSZ/YSZ=1/3. In another embodiment, the proportion ratio may be varied from the air electrode side toward the fuel electrode side so that SSZ/YSZ=3/1, SSZ/YSZ=1/3, and SSZ/YSZ=3/1. SSZ/YSZ=3/1 represents the molar ratio between scandia and yttria contained in solid solution in zirconia. For example, 88 mol ZrO₂-9Sc₂O₃-3Y₂O₃ corresponds to this.

Air Electrode

In the present invention, the air electrode is preferably such that, under an air atmosphere, the electron conductivity is on a high level, the oxygen gas permeability is on a high level, and the oxygen ion can be efficiently produced. In the present invention, the air electrode may be constructed as an air electrode support which maintains the strength of the cell and has a function as an air electrode.

In the present invention, the air electrode comprises a perovskite oxide containing at least manganese. In a preferred embodiment of the present invention, this air electrode is formed of a lanthanum manganite represented by (La₁₋ₓAₓ)_{y}MnO₃ wherein A represents Ca or Sr; x satisfies 0.15≦x≦0.3; and y satisfies 0.97≦y≦1.

In a preferred embodiment of the present invention, the air electrode or the air electrode support is formed of a mixed electrically conductive ceramic material prepared by intimately mixing a perovskite oxide containing manganese and nickel with an oxide having oxygen ion conductive properties. A preferred example thereof is a mixture of a lanthanum manganite represented by (La₁₋ₓAₓ)_{y}(Mn_{1-z}Ni_{z})O₃ wherein A represents Ca or Sr; x satisfies 0.15≦x≦0.3; y satisfies 0.97≦y≦1; and z satisfies 0.02≦z≦0.10, with SSZ. The proportion of the perovskite oxide containing manganese and nickel is preferably 30 to 70% by weight. The air electrode has suitable pore diameter and porosity from the viewpoints of oxygen and gas permeability. Preferably, the pore diameter is not less than 0.5 μm, and the porosity is not less than 5%. A composition which can highly suppress the diffusion of manganese into the electrolyte is more preferred from the viewpoint of improving the durability.

In a more preferred embodiment of the present invention, the composition of the perovskite oxide containing manganese and nickel is represented by (Ln₁₋ₓAₓ)_{y}(Mn_{1-z}Ni_{z})O₃ wherein Ln represents one or at least two elements selected from the group consisting of Sc, Y, La, Ce, Pr, Nd, Pm, Sm, Eu, Gd, Tb, Dy, Ho, Er, Tm, Yb, and Lu; A represents Ca or Sr; x satisfies 0.15≦x≦0.3; y satisfies 0.97≦y≦1; and z satisfies 0.02≦z≦0.10. When z is 0.02≦z≦0.10, advantageously, the solid solution is highly stable and the suppression of the diffusion of manganese within the perovskite structure into other electrode on the highest level. When x satisfies 0.15≦x≦0.3, good electron conductivity is ensured and, at the same time, oxygen ions can be efficiently produced. When y satisfies 0.97≦y≦1, advantageously, the content of manganese within the perovskite structure may be rendered proper and the excess lanthanum component absorbs moisture and consequently is converted to lanthanum hydroxide to effectively prevent a lowering in stability of the material per se.

The oxide having oxygen ion conductivity constituting the air electrode is preferably at least zirconia-containing oxide, cerium-containing oxide, and lanthanum gallate oxide. More preferred zirconia-containing oxides include SSZ, ScYSZ, and YSZ.

The amount of solid solution of scandia in SSZ as the air electrode is preferably in the range of 3 to 12% by mole. The total amount of solid solution of scandia and yttria in ScYSZ is preferably in the range of 3 to 12% by mole. The amount of solid solution of yttria in YSZ is in the range of 3 to 12% by mole. When the amount of solid solution of scandia and yttria is excessive, regarding the crystal phase, in addition to cubic crystals, rhombohedral crystals are produced, resulting in lowered oxygen ion conductivity. Further, since scandia and yttria are expensive materials, dissolution thereof to form a solid solution to such an extent that the oxygen ion conductivity is low, is disadvangeously impractical. Accordingly, care should be taken in the use of scandia and yttria. Further, SSZ and ScYSZ may contain not more than 5% by mole of at least one oxide selected from CeO₂, Sm₂O₃, Gd₂O₃, Yb₂O₃, and Er₂O₃ in solid solution from the viewpoint of ensuring good oxygen ion conductivity.

The cerium-containing oxide as the oxide having oxygen ion conductivity in the air electrode is represented by general formula (CeO₂)_{1-2X1}(J₂O₃)_{X1} wherein J represents at least one element selected from Sm, Gd, and Y; and X1 satisfies 0.05≦X1≦0.15. This compound has low sinterability, and, thus, a sintering temperature of 1500° C. or above is necessary for the formation of an electrolyte having no gas permeability. Due to high temperature sintering, there is a tendency toward an increase in diffusion of manganese from the manganese-containing perovskite oxide into the electrolyte. The incorporation of nickel suppresses the diffusion of manganese into the electrolyte.

The lanthanum gallate oxide as the oxide having oxygen ion conductivity in the air electrode is preferably represented by general formula La₁₋ₐDₐGa_{1-b}E_{b}O₃ or La₁₋ₐDₐGa_{1-b-c}E_{b}L_{c}O₃ wherein D represents one or at least two of Sr, Ca, and Ba; E represents one or at least two of Mg, Al, and In; and L represents one or at least two of Co, Fe, Ni, and Cr. Co-sintering with manganese-containing perovskite oxide causes mutual dispersion which is likely to facilitate diffusion of manganese. The incorporation of nickel can effectively suppress the diffusion of manganese.

Fuel Electrode

In the present invention, the fuel electrode may be any conventional one used as the fuel electrode in a solid oxide fuel cell. Specifically, the fuel electrode that, in a fuel gas atmosphere of the solid oxide fuel cell, the electron conductivity and fuel gas permeability are on a high level and a reaction between oxygen ions being moved through the electrolyte and the fuel gas to give water and carbon dioxide proceeds with high efficiency, suffices for satisfactory results.

In a preferred embodiment of the present invention, the fuel electrode is preferably formed of a sinter of nickel oxide and zirconia. Nickel oxide is reduced under a fuel gas atmosphere to give nickel which exhibits catalytic activity and electron conductivity.

In a preferred embodiment of the present invention, the fuel electrode is preferably formed of nickel oxide and zirconia containing yttrium in solid solution (NiO/YSZ), because this material has high electron conductivity and low IR loss. The NiO/YSZ weight ratio is preferably 50/50 to 90/10 from the viewpoints of realizing high electron conductivity and effectively preventing a lowering in durability caused by aggregation of Ni particles.

In a preferred embodiment of the present invention, zirconia containing NiO/SSZ and NiO/calucium in solid solution (hereinafter referred to as “NiO/CSZ”) may be mentioned as the material for the fuel electrode. Since YSZ is more inexpensive than SSZ, YSZ is preferred. CSZ is more inexpensive than YSZ, and, thus, NiO/CSZ is most preferred from the viewpoint of cost. Also for NiO/CSZ, under a fuel gas atmosphere of a solid oxide fuel cell, NiO/CSZ is converted to Ni/CSZ.

The raw material for a fuel electrode may be prepared by any method without particular limitation so far as fuel electrode materials such as NiO/SSZ and NiO/YSZ are intimately mixed. Examples of such methods include coprecipitation and spray drying.

In order to allow a reaction between oxygen ions and fuel gas to efficiently proceed, a fuel-side electrode reaction layer is preferably provided between the electrolyte and the fuel electrode. The fuel-side electrode reaction layer will be described later in detail.

Air-Side Electrode Reaction Layer

In a preferred embodiment of the present invention, preferably, the provision of an air-side electrode reaction layer between the air electrode and the electrolyte is preferred from the viewpoint of accelerating, at the interface of the air electrode and the electrolyte, a reaction represented by
1/2O₂+2e⁻→O²⁻.

In the present invention, preferably, the air-side electrode reaction layer has high oxygen ion conductivity. The possession of electron conductivity is more preferred because the above reaction can be further accelerated. Further, preferred is a material that has a coefficient of thermal expansion close to the electrolyte, has low reactivity with the electrolyte and the air electrode, and has good adhesion.

From the above viewpoints, in a preferred embodiment of the present invention, the air-side electrode reaction layer is preferably a layer formed of an intimate mixture of lanthanum manganite represented by LaAMnO₃, wherein A represents Ca or Sr, with SSZ. In a preferred embodiment of the present invention, for example, from the viewpoints of electron conductivity and material stability at 700° C. or above, the material has a composition represented by (La₁₋ₓAx)_{y}MnO₃ wherein x and y satisfy 0.15≦x≦0.3 and 0.97≦y≦1. In this composition range, high electron conductivity can be ensured, the production of lanthanum hydroxide can be prevented, and a high-output fuel cell can be realized.

In a preferred embodiment of the present invention, the lanthanum manganite may contain, in addition to Sr or Ca, Ce, Sm, Gd, Pr, Nd, Co, Al, Fe, Cr, Ni and the like in solid solution. In particular, a composition of (La, A)(Mn, Ni)O₃ containing Ni in solid solution is preferred, because the production of an insulating layer called lanthanum zirconate represented by La₂Zr₂O₇ can be suppressed and, at the same time, the diffusion of manganese can be suppressed.

SSZ as the air-side electrode reaction layer in the present invention may further contain CeO₂, Sm₂O₃, Gd₂O₃, Bi₂O₃ or the like in solid solution in an amount of not more than about 5% by mole. Two or more of them may be contained in solid solution. The dissolution of these materials in solid solution is preferred because an improvement in oxygen ion conductivity can be expected. In a preferred embodiment of the present invention, the amount of solid solution of scandia in SSZ in the air-side electrode reaction layer in the present invention is preferably about 3 to 12% by mole from the viewpoint of oxygen ion conductivity, more preferably about 8 to 12% by mole.

In a preferred embodiment of the present invention, the air-side electrode reaction layer is a layer that is formed of an intimate mixture of lanthanum manganite with SSZ and a cerium oxide represented by general formula (CeO₂)_{1-2X}(B₂O₃)_{X} wherein B represents Sm, Gd or Y; and X satisfies 0.05≦X≦0.15, and has interconnected open pores. The presence of cerium oxide can be expected to suppress the reaction between the air electrode and the electrolyte. The mixing amount of cerium oxide is preferably about 3 to 30% by weight based on the whole material from the viewpoints of inhibiting the reaction between the air electrode and the electrolyte and ensuring adhesion between both the air electrode and the electrolyte.

In another preferred embodiment of the present invention, preferably, the air-side electrode reaction layer is formed of a mixed electrically conductive ceramic that comprises a manganese- and nickel-containing perovskite oxide, and zirconia-containing oxide, cerium oxide, or a lanthanum- and gallium-containing perovskite oxide and has interconnected open pores.

The manganese- and nickel-containing perovskite oxide is preferably represented by (Ln₁₋ₓAₓ)_{y}(Mn_{1-z}Ni_{z})O₃ wherein Ln represents one or at least two elements selected from the group consisting of Sc, Y, La, Ce, Pr, Nd, Pm, Sm, Eu, Gd, Tb, Dy, Ho, Er, Tm, Yb, and Lu; A represents Ca or Sr; x satisfies 0.15≦x≦0.3; y satisfies 0.97≦y≦1; z satisfies 0.02≦z≦0.10.

The zirconia-containing oxide preferably refers to zirconia containing scandia in solid solution or zirconia containing scandia and yttria in solid solution.

The cerium oxide is preferably represented by formula (CeO₂)_{1-2X1}(J₂O₃)_{X1} wherein J represents Sm, Gd, or Y; and X1 satisfies 0.05≦X1≦0.15.

In this embodiment, preferably, the content of the manganese- and nickel-containing perovskite oxide in the air-side electrode reaction layer is about 30 to 70% by weight.

In another preferred embodiment of the present invention, the air-side electrode reaction layer has a multilayer structure of at least two layers of a first layer on the air electrode side and a second layer on the electrolyte side.

In this embodiment, the first layer is preferably a layer that is formed of an intimate mixture of an electron conductive oxide with an oxygen ion conductive oxide and has interconnected open pores.

The electron conductive oxide preferably has electron conductivity and is stable in an air atmosphere of a solid oxide fuel cell, and a specific example thereof is lanthanum manganite containing Sr or Ca in solid solution. When a low level of diffusion of manganese into the electrolyte and a high level of electron conductivity are taken into consideration, more preferred is a lanthanum manganite represented by (La₁₋ₓAₓ)_{y}MnO₃ wherein A represents Ca or Sr; x satisfies 0.15≦x≦0.3; and y satisfies 0.97≦y≦1. This lanthanum manganite may contain Ce, Sm, Pr, Nd, Co, Al, Fe, Ni, Cr and the like in solid solution. In particular, the dissolution of Ni in a solid solution form is preferred. The material containing Ni in solid solution is preferably represented by (La₁₋ₓAₓ)_{y}(Mn_{1-z}Ni_{z})O₃ wherein A represents Ca or Sr; x satisfies 0.15≦x≦0.3; y satisfies 0.97≦y≦1; and z satisfies 0.02≦z≦0.10.

Satisfying the requirement that the oxide has oxygen ion conductivity and is stable under an air atmosphere of the solid oxide fuel cell, suffices for the oxide having oxygen ion conductivity in the first layer. Specific examples of such oxides include SSZ, ScYSZ, YSZ, cerium-containing oxides, perovskite oxides containing at least lanthanum and gallium (hereinafter referred to as “lanthanum gallate oxide”).

The amount of solid solution of scandia in SSZ as the first layer is preferably in the range of 3 to 12% by mole. The total amount of solid solution of scandia and yttria in ScYSZ as the first layer is preferably in the range of 3 to 12% by mole. The amount of solid solution of yttria in YSZ preferable as the first layer is in the range of 3 to 12% by mole. When the amount of solid solution of scandia or yttria is excessive, regarding the crystal phase, in addition to cubic crystals, rhombohedral crystals are produced, resulting in lowered oxygen ion conductivity. Further, since scandia and yttria are expensive materials, dissolution thereof to form a solid solution to such an extent that the oxygen ion conductivity is low, is disadvantageously impractical. Accordingly, care should be taken in the use of scandia and yttria. Further, SSZ and ScYSZ may contain not more than 5% by mole of at least one oxide selected from CeO₂, Sm₂O₃, Gd₂O₃, Yb₂O₃, and Er₂O₃ in solid solution from the viewpoint of ensuring good oxygen ion conductivity.

The cerium-containing oxide as the first layer is represented by general formula (CeO₂)_{1-2X1}(J₂O₃)_{X1} wherein J represents Sm, Gd, or Y; and X1 satisfies 0.05≦X1≦0.15.

The lanthanum gallate oxide as the first layer is preferably represented by general formula La₁₋ₐDₐGa_{1-b}E_{b}O₃ or La₁₋ₐDₐGa_{1-b-c}E_{b}L_{c}O₃ wherein D represents one or at least two of Sr, Ca, and Ba; E represents one or at least two of Mg, Al and In; and L represents one or at least two of Co, Fe, Ni, and Cr.

Electron conductive oxides and oxygen ion conductive oxides, which are preferred as the first layer, have been mentioned above. Oxides having both electron conductivity and oxygen ion conductivity may also be used. Examples of such oxides include lanthanum cobaltite oxides which are oxides containing at least lanthanum and cobalt.

Preferably, the second layer has at least oxygen ion conductivity, can suppress the diffusion of the manganese component into the electrolyte, and has interconnected open pores.

The reason why the second layer preferably has at least oxygen ion conductivity is for efficiently supplying oxygen ions considered to be produced mainly in the first layer to the electrolyte. Further, the reason why the second layer preferably has the effect of suppressing the diffusion of the manganese component into the electrolyte is that the development of electron conductivity in the electrolyte can be suppressed and, further, a lowering in adhesion between the electrolyte and the fuel electrode caused by the occurrence of such a phenomenon that the size of particles on the fuel electrode-side surface of the electrolyte is rendered excessively large by improved sinterability, can be suppressed. The reason why the second layer preferably has interconnected open pores is that, when there is no gas permeability, the manganese component diffused from the first layer and the air electrode is disadvantageously diffused with high efficiency. The point of control of the diffusion amount of manganese resides in the microstructure in the second layer, and the optimization of pore diameter, porosity, and thickness is particularly important. The pore diameter is preferably 0.1 to 10 μm, the porosity is preferably 3 to 40%, and the thickness is preferably 5 to 50 μm.

In this embodiment, for the above reason, the second layer is preferably formed of a material that has high oxygen ion conductivity but not have high sinterability, that is, a material that is less likely to diffuse manganese into the electrolyte. Further, a material having the effect of absorbing manganese diffused from the air electrode is preferred. From this viewpoint, SSZ and cerium-containing oxides may be mentioned as representative examples of such materials. The utilization of ScYSZ is also preferred from the viewpoint of improving the adhesion between the first layer and the electrolyte although the sinterability is higher than that of SSZ. The reason why the second layer preferably has the effect of absorbing manganese diffused from the air electrode is that the entry of manganese in the second layer leads to the development of electron conductivity in the second layer that, as with the first layer, can realize the production of oxygen ions. This embodiment can be an advantageous embodiment of the present invention in that, by virtue of this effect, higher output performance can be realized.

In this embodiment, SSZ and cerium-containing oxide as the second layer may be the same as described above in connection with the first layer. Further, ScYSZ may be the same as described above in connection with the first layer. Preferably, however, the proportion of scandia to the total amount of scandia and yttria in ScYSZ is not less than 20% by mole. When the amount of scandia is excessively small, the effect of suppressing the dispersion of manganese is reduced. Further, ScYSZ may contain not more than 5% by mole of at least one oxide selected from CeO₂, Sm₂O₃, Gd₂O₃, Yb₂O₃, and Er₂O₃ in solid solution.

Accordingly, embodiments of the present invention in which the air-side electrode reaction layer has a two-layer structure include

an embodiment in which the first layer is formed of a mixture of a manganese-containing perovskite oxide with zirconia containing scandia and/or yttria in solid solution and has interconnected open pores and the second layer is formed of zirconia containing scandia in solid solution and has larger porosity than the electrolyte,

an embodiment in which the first layer is formed of a mixture of a manganese-containing perovskite oxide with a cerium-containing oxide and has interconnected open pores, and the second layer is formed of zirconia containing scandia in solid solution and has a larger porosity than the electrolyte,

an embodiment in which the first layer is formed of a mixture of a manganese-containing perovskite oxide with a lanthanum- and gallium-containing perovskite oxide and has interconnected open pores, and the second layer is formed of zirconia containing scandia in solid solution and has larger porosity than the electrolyte,

an embodiment in which the first layer is formed of a lanthanum- and cobalt-containing perovskite oxide and has interconnected open pores, and the second layer is formed of zirconia containing scandia in solid solution and has larger porosity than the electrolyte, and

an embodiment in which the first layer is formed of a mixture of a manganese-containing perovskite oxide with zirconia containing scandia and/or yttria in solid solution and has interconnected open pores, and the second layer is formed of cerium oxide and has larger porosity than the electrolye.

Further, in a preferred embodiment of the present invention, in the embodiment in which the air-side electrode reaction layer has a two-layer structure, the following relationship is preferably satisfied: d1>d2>d3 wherein d1 represents the diameter of pores in the air electrode; d2 represents the diameter of pores in the first layer; and d3 represents the diameter of pores in the second layer, from the viewpoint of realizing a fuel cell possessing excellent output performance.

According to another preferred embodiment of the present invention, in the embodiment in which the air-side electrode reaction layer has a two-layer structure, the following relationship is preferably satisfied: a1≧a2≦a3>a4 wherein a1 represents the porosity of the air electrode; a2 represents the porosity of the first layer; a3 represents the porosity of the second layer; and a4 represents the porosity of the electrolyte.

The thickness of the first layer and the thickness of the second layer may be properly determined. Preferably, the thickness of the second layer is 5 to 50 μm, and the thickness of the first layer is 5 to 50 μm.

Porous Layer

In a preferred embodiment of the present invention, a porous layer is provided between the fuel electrode and the electrolyte. In the present invention, this porous layer is formed of a zirconia-containing fluorite oxide, has a thickness of 5 to 40 μm, and has a larger porosity than the electrolyte. As described above, the present invention is characterized in that the content of manganese in the porous layer in its surface on the fuel electrode side is 0.3 to 4% by weight.

Further, in a preferred embodiment of the present invention, the content of the manganese component in the porous layer in its surface on the fuel electrode side is preferably 0.6 to 3.5% by weight, more preferably 0.9 to 3% by weight.

In the present invention, this porous layer can suppress the diffusion of manganese into the fuel electrode and, at the same time, has the function of efficiently moving oxygen ions being moved through the electrolyte into the fuel electrode. From this viewpoint, preferably, the porous layer has high oxygen ion conductivity. The regulation of the thickness of the porous layer is also important for preventing the diffusion of manganese from the electrolyte into the fuel electrode and for preventing a deterioration in output performance caused by resistance of the material per se. In a preferred embodiment of the present invention, the thickness of the porous layer is preferably 5 to 40 μm. Further, regarding the porous layer, from the viewpoints of output performance and durability, the porosity is preferably 3 to 30%, and the pore diameter is preferably about 0.05 to 2 μm. On the other hand, the porous layer is preferably free from any hole which extends from the fuel electrode side to the electrolyte, from the viewpoint of preventing H₂ gas from being transferred from the fuel electrode side and reaching the electrolyte surface.

In a preferred embodiment of the present invention, preferably, the following relationship is satisfied: a1<a2<a3 wherein a1 represents the porosity of the electrolyte; a2 represents the porosity of the porous layer formed of the fluorite oxide; and a3 represents the porosity of the fuel electrode.

In a preferred embodiment of the present invention, the zirconia-containing fluorite oxide constituting the porous layer is stable under a fuel gas atmosphere of the solid oxide fuel cell and has high oxygen ion conductivity. Preferred are SSZ, ScYSZ, and YSZ. These SSZ, ScYSZ and YSZ may be the same as those for constituting the air-side electrode reaction layer except for physical properties required of the porous layer. This is true of the preferred embodiment.

Fuel-Side Electrode Reaction Layer

In a preferred embodiment of the present invention, the provision of a fuel-side electrode reaction layer between the electrolyte and the fuel electrode is preferred from the viewpoints of an efficient reaction in the fuel electrode and improving output performance. In the present invention, since the fuel-side electrode reaction layer is one embodiment of the fuel electrode, in an embodiment in which a fuel-side electrode reaction layer is provided, the term “layer in contact with the fuel electrode” refers to a layer in contact with the fuel-side electrode reaction layer.

In the present invention, preferably, the fuel-side electrode reaction layer is formed of NiO/SSZ or Ni/SSZ which is excellent in both electron conductivity and oxygen ion conductivity. Here NiO is reduced under a fuel atmosphere to Ni, and the fuel-side electrode reaction layer is formed of Ni/SSZ.

In a preferred embodiment of the present invention, the ratio of NiO/SSZ is 10/90 to 50/50 in terms of weight ratio because good electron conductivity and oxygen ion conductivity can be realized.

The amount of solid solution of scandia in SSZ constituting the fuel-side electrode reaction layer is preferably about 3 to 12% by mole, because the oxygen ion conductivity is high and the reaction in the fuel electrode can be accelerated. SSZ may further contain one or at least two of CeO₂, Sm₂O₃, Gd₂O₃, and Bi₂O₃ in solid solution in an amount of not more than 5% by mole. By virtue of the dissolution of these oxides in a solid solution, not only an improvement in oxygen ion conductivity under a fuel gas atmosphere but also an improvement in electron conductivity can be expected.

In a preferred embodiment of the present invention, a layer formed of a mixture prepared by intimately mixing NiO, SSZ and cerium oxide together at a predetermined weight ratio (hereinafter referred to as “NiO/SSZ/cerium oxide) is preferred as the fuel-side electrode reaction layer. This layer is advantageous in that, under a fuel gas atmosphere, the oxygen ion conductivity is high and the electron conductivity is high. NiO is reduced under a fuel gas atmosphere to Ni, and, consequently, this layer is formed of Ni/SSZ/cerium oxide. The cerium oxide is not particularly limited so far as the oxide contains cerium. However, a cerium oxide represented by general formula (CeO₂)_{1-2X}(B₂O₃)_{X}, wherein B represents Sm, Gd or Y; and X satisfies 0.05≦X≦0.15, is preferred from the viewpoint of realizing high oxygen ion conductivity.

Interconnector

In an air atmosphere and a fuel gas atmosphere at a power generation temperature in a solid oxide fuel cell, preferably, the interconnector provided in the solid oxide fuel cell according to the present invention has high electron conductivity, has no gas permeability, and is stable against a redox atmosphere. Lanthanum chromite is preferred from this viewpoint.

Lanthanum chromite is resistant to sintering, and, hence, it is difficult to prepare a gas permeability-free interconnector at a firing temperature (1500° C. or below) of the solid oxide fuel cell. In order to improve the sinterability, Ca, Sr, or Mg is prferably used in solid solution. The dissolution of Ca in a solid solution form is preferred, because the sinterability is the highest, and a film having no gas permeability can be prepared at substantially the same temperature as that used in sintering of other electrode such as the electrolyte in the solid oxide fuel cell.

The electron conductivity enhances with increasing the amount of solid solution of lanthanum chromite containing Ca in solid solution used in the interconnector. In this case, however, since there is a fear of causing a lowering in stability of the material, the amount of solid solution is preferably about 10 to 40% by mole.

In a preferred embodiment of the present invention, a precoat layer, which has a composition represented by (La₁₋ₓAₓ)_{y}MnO₃, wherein A represents Sr or Ca; x satisfies 0.15≦x≦0.3; and y satisfies 0.97≦y≦1, and is dense, may be provided between the air electrode and the interconnector. Advantageously, this precoat layer can effectively suppress the diffusion of a calcium chromite component as a sintering aid component for lanthanum chromite containing Ca in solid solution into the air electrode. The dense precoat layer is evaluated in terms of the amount of permeated gas determined by providing a pressure difference between one side of the precoat layer and the opposite side of the precoat layer and measuring the amount of gas permeated through the precoat layer. The dense precoat layer preferably refers to one having a gas permeability Q≦1.4×10⁻⁷ ms⁻¹Pa⁻¹ or more.

When the solid oxide fuel cell is in a flat plate form, the interconnector is called “separator,” and the function of the separator is the same as that of the interconnector. The separator may be formed of a heat resistant metal such as ferrite stainless steel.

Production Process of Solid Oxide Fuel Cell

The solid oxide fuel cell according to the present invention may be produced by an appropriate production process while taking into consideration the shape of the solid oxide fuel cell and the like. A cylindrical solid oxide fuel cell as shown in FIG. 1 can be produced as follows.

An air electrode site which serves as a support is first prepared as a high-strength and porous air electrode support by mixing a perovskite oxide containing at least manganese and other component(s) as raw materials preferably with a binder, extruding this mixture, removing the binder from the extrudate at a temperature of about 300 to 500° C., and then firing the heat treated extrudate at about 1400 to 1500° C. A suspension firing method and a lateral sintering method may be mentioned as the sintering method. The lateral sintering is preferred.

Subsequently, an air-side electrode reaction layer, an electrolyte, an interconnector, and a fuel electrode are formed in a film form onto the surface of the air electrode support. These electrodes are preferably formed by a wet method from the viewpoint of cost. Wet methods include a dipping method in which a slurry is prepared from a raw material powder, a binder, and a solvent followed by dipping in this slurry, to prepare the electrode, a screen printing method in which a film is formed using paste having higher viscosity than slurry through a screen, and a sheet bonding method in which a film sheeted on another base material such as a PET film is applied onto the surface of the cell. The production process may be properly selected depending upon the shape of a part on which the film is to be formed. In the case of a cylindrical cell shown in FIG. 1, the air-side electrode reaction layer and the electrolyte are preferably formed by the dipping method. On the other hand, the interconnector and the fuel electrode are preferably formed by a screen printing method or a sheet bonding method which is a masking-free method.

Preferably, the cell formed in a film form by the above method is heat treated at a temperature of about 300 to 500° C. to remove the binder, and the cell is then fired at a temperature below the firing temperature of the air electrode support and in the range of about 1300 to 1500° C. Firing may be carried out by any of a successive firing method in which individual layers are fired separately from each other, and a co-firing method in which a few layers are simultaneously fired. The co-firing method is preferred from the viewpoint of cost. In the present invention using a perovskite oxide containing at least manganese as an air electrode support, there is a fear that the output performance is significantly lowered by the diffusion of manganese. For this reason, in some cases, the successive firing method is preferred.

Co-firing with the air electrode molded product is also possible. In the case of firing of the air electrode support, firing is carried out at a temperature above other electrode(s). Therefore, when the diffusion of manganese is taken into consideration, successive firing is preferred.

### EXAMPLES

The following Examples further illustrate the present invention. However, it should be noted that the present invention is not limited to these examples.

In the Examples, various properties, performance and the like were determined by the following testing methods.

Measurement of Diameter of Crystal Grains on Surface of Electrolyte Film

The surface of the electrolyte film was observed under SEM (S-4100, manufactured by Hitachi, Ltd.) to photograph the surface of the electrolyte on its fuel electrode side at a magnification of 300 times. The grain size distribution was determined by calculation using the photograph by a planimetric method. Further, the average crystal grain diameter was also determined. Specifically, a known circle having an area (A) is drawn on the photograph, and the number of grains N_{G} per unit area is determined from the number of grains n_{c} present within the circle and the number of grains nᵢ present on the circumference by the following equation:
N_{G}=(n_{c}+1/2nᵢ)/(A/m²)

wherein m represents the magnification of the photograph. Since 1/N_{G} represents the area occupied by one particle, when the crystal grain diameter is an equivalent circle diameter, 2/√(πN_{G}) may be adopted for the determination, while, in the case of one side of square, 1/√N_{G} may be adopted.

In the grain size distribution in the film surface, 3% diameter of crystal grains in the electrolyte refers to the grain diameter corresponding to the third smallest grain, when the crystal grain diameter of 100 crystal grains is measured by a planimetric method and the grains are placed in diameter ascending order, and 97% diameter refers to the grain diameter corresponding to the 97th smallest grain. In the measurement, upon sintering, even though particles were seen as if they were bonded to one another, when a grain boundary was observed, they were regarded as separate grains.

Gas Leakage Test

Before the power generation test, nitrogen gas was allowed to flow into the air electrode support, and a pressure of 0.1 MPa was applied from within the air electrode to determine the amount of gas permeated through the electrolyte, and, based on the results, whether or not the electrolyte is gas permeable was determined.

Power Generation Test

A power generation test was carried out using the prepared cell (fuel electrode effective area: 150 cm²). The power generation test was carried out under the following operating conditions.

Fuel: (H₂+11% H₂O):N₂=1:2

Oxidizing agent: Air

Power generation temp.: 800° C.

Current density: 0.3 Acm⁻²

Durability Test

The cell was held under the same conditions as that in the power generation test for 1000 hr. Thereafter, in such a state that the current density was lowered to 0 A cm⁻², the temperature was lowered to room temperature. The temperature was then again raised to 800° C., and the cell was held under the same conditions for 500 hr. In such a state that the current density was again reduced to 0 A cm⁻², the temperature was lowered to room temperature. Thereafter, the temperature was raised to 800° C., and the cell was held under the same conditions for 500 hr. Thus, a 2000-hr (total) durability test was carried out including two heat cycles.

Compositional Analysis of Electrolyte Surface

The content of manganese in the electrolyte in its surface on the fuel electrode side was determined for a cell prepared in the same manner as in the cell for the power generation test. The content of manganese was measured with a Shimadzu electron probe micro analyzer EPMA-8705 manufactured by Shimadzu Seisakusho Ltd. under the following measurement conditions.

Acceleration voltage: 15 kW

Irradiation current quantity: 50 nA

Analyzing crystal: LiF

Analytical line: MnKα line (2.103 angstroms)

Porosity

The cell was cut, and the cut surface from the air electrode toward the fuel electrode was polished for planishing. An SEM photograph of the section from the electrolyte to the fuel electrode part was taken, and a pore part and a particle part were traced using a different color for each part on a transparent film. The film distinguished by different colors was subjected to image processing to calculate the proportion of the pore part to determine the porosity.

Pore Diameter

The pore diameter was determined by the following method.

The cell was cut, and the cut surface from the air electrode toward the fuel electrode was polished for planishing. An SEM photograph of the section from the air electrode to the electrode reaction layer part was taken, and a pore part and a particle part were traced using a different color for each part on a transparent film. The size of the pore part was measured. For example, when the pore is an equivalent circle, the diameter thereof is regarded as a pore diameter while, in an equivalent square, the length of one side is regarded as a pore diameter. The pore diameter of 0.1 to 10 μm refers to the 50th pore diameter in the range of 3rd to 97th pore diameter, when the diameter of 100 pores is measured by the above method and the diameters are placed in ascending order. That is, the pore diameter of 0.1 to 10 μm means that the diameter corresponding to 50% diameter in pore diameters in the range of 3% 15 diameter to 97% diameter is 0.1 to 10 μm.

### Example A1

### Fuel Cell Wherein Electrolyte is Layer Formed of SSZ

### Example A1-1

(1) Preparation of Air Electrode Support

Lanthanum manganite containing Sr in solid solution and having a composition represented by La_{0.75}Sr_{0.25}MnO₃ was used as an air electrode. After preparation by coprecipitation, heat treatment was carried out to prepare a raw material powder for an air electrode. The average particle diameter was 30 μm. A cylindrical molded product was prepared by extrusion, and the molded product was then fired at 1500° C. to prepare an air electrode support.

(2) Preparation of Air-Side Electrode Reaction Layer

La_{0.75}Sr_{0.25}Mn_{0.95}Ni_{0.05}O₃/90 mol % ZrO₂-10 mol % Sc₂O₃=50/50 was used as an air-side electrode reaction layer. An aqueous solution of nitrate of La, an aqueous solution of nitrate of Sr, an aqueous solution of nitrate of Mn, an aqueous solution of nitrate of Ni, an aqueous solution of nitrate of Zr, and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 2 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. The slurry was coated onto the air electrode support (outer diameter 15 mm, wall thickness 1.5 mm, effective length 400 mm) to form a coating which was then sintered at 1400° C. The sinter had a thickness of 20 μm.

(3) Preparation of Slurry for Electrolyte:

The electrolyte comprised 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.5 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 140 mPas.

(4) Preparation of Electrolyte

The slurry prepared above was coated onto the air-side electrode reaction layer to form a coating which was then fired at 1400° C. The thickness of the electrolyte thus formed was 30 μm. In this case, the air electrode support in its part on which an interconnector film is to be formed in a later step was masked so as not to be coated.

(5) Preparation of Slurry for Fuel-Side Electrode Reaction Layer

The fuel-side electrode reaction layer comprised NiO/90 mol % ZrO₂-10 mol % Sc₂O₃. An aqueous solution of nitrate of Ni, an aqueous solution of nitrate of Zr, and an aqueous solution of nitrate of Sc were provided and were mixed with each other so as to give the above composition, followed by coprecipitation with oxalic acid. Heat treatment was further carried out, and the particle diameter was regulated to prepare a raw material. In this case, two types of compositions for the fuel-side electrode reaction layer, that is, NiO/90 mol % ZrO₂-10 mol % Sc₂O₃=20/80 and 50/50 were prepared. For both the cases, the average particle diameter was 0.5 μm. This powder (100 parts by weight) was mixed with 500 parts by weight of an organic solvent (ethanol), 10 parts by weight of a binder (ethylcellulose), 5 parts by weight of a dispersant (polyoxyethylene alkylphosphate), 1 part by weight of an antifoaming agent (sorbitan sesquioleate), and 5 parts by weight of a plasticizer (DBP). The mixture was then thoroughly stirred to prepare a slurry. This slurry had a viscosity of 70 mPas.

(6) Preparation of Slurry for Fuel Electrode

The fuel electrode comprised NiO/90 mol % ZrO₂-10 mol % Y₂O₃=70/30. An aqueous solution of nitrate of Ni, an aqueous solution of nitrate of Zr, and an aqueous solution of nitrate of Y were provided and were mixed with each other so as to give the above composition, followed by coprecipitation with oxalic acid. Heat treatment was further carried out, and the particle diameter was regulated to prepare a raw material. The average particle diameter was 2 μm. This powder (100 parts by weight) was mixed with 500 parts by weight of an organic solvent (ethanol), 20 parts by weight of a binder (ethylcellulose), 5 parts by weight of a dispersant (polyoxyethylene alkylphosphate), and 1 part by weight of an antifoaming agent (sorbitan sesquioleate), and 5 parts by weight of a plasticizer (DBP). The mixture was then thoroughly stirred to prepare a slurry. This slurry had a viscosity of 250 mPas.

(7) Preparation of Fuel Electrode

The electrolyate prepared in the above step (4) was masked so that the effective area was 150 cm². The slurries for a fuel-side electrode reaction layer were first coated on the electrolyte in the order of NiO/90 mol % ZrO₂-10 mol % Sc₂O₃ (average particle diameter)=20/80 (0.5 μm) and 50/50 (0.5 μm). The film thickness (after firing) was 10 μm. The slurry for a fuel electrode was coated thereon. The film thickness (after firing) was 90 μm. The assembly was further fired at 1400° C.

(8) Preparation of Interconnector:

The interconnector had a composition of lanthanum chromite containing Ca in solid solution represented by La_{0.80}Ca_{0.20}CrO₃. A raw material powder was prepared by spray pyrolysis and was then heat treated. The average particle diameter was 1 μm. This powder (40 parts by weight) was mixed with 100 parts by weight of a solvent (ethanol), 2 parts by weight of a binder (ethylcellulose), 1 part by weight s of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. An interconnector was formed by slurry coating using this slurry and was then fired at 1400° C. The thickness of the interconnector after firing was 40 μm.

### Example A1-2

A solid oxide fuel cell was prepared in the same manner as in Example 1, except that the electrolyte firing temperature was 1360° C.

### Example A1-3

A fuel cell was prepared in the same manner as in Example 1, except that the electrolyte firing temperature was 1380° C.

### Example A1-4

A fuel cell was prepared in the same manner as in Example 1, except that the electrolyte firing temperature was 1420° C.

### Example A1-5

A fuel cell was prepared in the same manner as in Example 1, except that the electrolyte firing temperature was 1440° C.

### Comparative Example A1-1

A fuel cell was prepared in the same manner as in Example 1, except that the electrolyte firing temperature was 1340° C.

### Comparative Example A1-2

A fuel cell was prepared in the same manner as in Example 1, except that the electrolyte firing temperature was 1460° C.

### Example 2

### Fuel Cell in Which Electrolyte is Layer of YSZ

### Example A2-1

A fuel cell was prepared in the same manner as in Example A1-1, except that the electrolyte had a composition of 90 mol % ZrO₂-10 mol % Y₂O₃.

### Example A2-2

A fuel cell was prepared in the same manner as in Example A1-1, except that the electrolyte had a composition of 90 mol % ZrO₂-10 mol % Y₂O₃ and the firing temperature of the electrolyte was 1350° C.

### Example A2-3

A fuel cell was prepared in the same manner as in Example A1-1, except that the electrolyte had a composition of 90 mol % ZrO₂-10 mol % Y₂O₃ and the firing temperature of the electrolyte was 1380° C.

### Example A2-4

A fuel cell was prepared in the same manner as in Example A1-1, except that the electrolyte had a composition of 90 mol % ZrO₂-10 mol % Y₂O₃ and the firing temperature of the electrolyte was 1410° C.

### Example A2-5

A fuel cell was prepared in the same manner as in Example A1-1, except that the electrolyte had a composition of 90 mol % ZrO₂-10 mol % Y₂O₃ and the firing temperature of the electrolyte was 1420° C.

### Comparative Example A2-1

A fuel cell was prepared in the same manner as in Example A1-1, except that the electrolyte had a composition of 90 mol % ZrO₂-10 mol % Y₂O₃ and the firing temperature of the electrolyte was 1330° C.

### Comparative Example A2-2

A fuel cell was prepared in the same manner as in Example A1-1, except that the electrolyte had a composition of 90 mol % ZrO₂-10 mol % Y₂O₃ and the firing temperature of the electrolyte was 1440° C.

### Example 3

### Fuel Cell in Which Electrolyte is Layer of SSZ/YSZ

### Example A3-1

A fuel cell was prepared in the same manner as in Example A1-1, except that the electrolyte had a composition of 90 mol % ZrO₂-5 mol % Sc₂O₃-5 mol % Y₂O₃.

### Example A3-2

A fuel cell was prepared in the same manner as in Example A1-1, except that the electrolyte had a composition of 90 mol % ZrO₂-5 mol % Sc₂O₃-5 mol % Y₂O₃ and the firing temperature of the electrolyte was 1350° C.

### Example A3-3

A fuel cell was prepared in the same manner as in Example A1-1, except that the electrolyte had a composition of 90 mol % ZrO₂-5 mol % Sc₂O₃-5 mol % Y₂O₃ and the firing temperature of the electrolyte was 1380° C.

### Example A3-4

A fuel cell was prepared in the same manner as in Example A1-1, except that the electrolyte had a composition of 90 mol % ZrO₂-5 mol % Sc₂O₃-5 mol % Y₂O₃ and the firing temperature of the electrolyte was 1420° C.

### Example A3-5

A fuel cell was prepared in the same manner as in Example A1-1, except that the electrolyte had a composition of 90 mol % ZrO₂-5 mol % Sc₂O₃-5 mol % Y₂O₃ and the firing temperature of the electrolyte was 1430° C.

The measurement of particle size distribution, a gas leakage test, a power generation test, and a durability test were carried out for the fuel cells thus obtained. The results were as shown in tables below.

TABLE 1

| | 3% | 97% | Average | | Gas permeability, |
|---|---|---|---|---|---|
| | diameter, | diameter, | crystal grain | Mn content, | ×10⁻¹⁰ |
| | μm | μm | diameter, μm | wt % | ms⁻¹Pa⁻¹ |
| Example A1-1 | 3 | 8 | 5 | 0.9 | 3.5 |
| Example A1-2 | 3 | 5 | 4 | 0.3 | 25.5 |
| Example A1-3 | 3 | 7 | 4.5 | 0.6 | 12.7 |
| Example A1-4 | 3 | 12 | 7.5 | 1.5 | 3.0 |
| Example A1-5 | 4 | 20 | 12 | 2.9 | 3.7 |
| Comparative | 1 | 4 | 2 | 0.1 | 320 |
| Example A1-1 | | | | | |
| Comparative | 5 | 26 | 15 | 4.3 | 5.5 |
| Example A1-2 | | | | | |

TABLE 2

| | Initial | After | | After |
|---|---|---|---|---|
| | potential, V | 1000 hr, V | After 1500 hr, V | 2000 hr, V |
| Example A1-1 | 0.67 | 0.67 | 0.67 | 0.67 |
| Example A1-2 | 0.65 | 0.65 | 0.65 | 0.65 |
| Example A1-3 | 0.66 | 0.66 | 0.66 | 0.66 |
| Example A1-4 | 0.67 | 0.67 | 0.67 | 0.67 |
| Example A1-5 | 0.66 | 0.66 | 0.66 | 0.66 |
| Comparative | 0.45 | 0.44 | 0.43 | 0.42 |
| Example A1-1 | | | | |
| Comparative | 0.64 | 0.64 | 0.63 | 0.62 |
| Example A1-2 | | | | |

TABLE 3

| | 3% | | Average | Mn | Gas permeability, |
|---|---|---|---|---|---|
| | diameter, | 97% diameter, | crystal grain | content, | ×10⁻¹⁰ |
| | μm | μm | diameter, μm | wt % | ms⁻¹Pa⁻¹ |
| Example A2-1 | 3 | 13 | 7 | 1.3 | 1.5 |
| Example A2-2 | 3 | 5 | 4 | 0.5 | 3.1 |
| Example A2-3 | 3 | 8 | 5 | 0.9 | 2.2 |
| Example A2-4 | 4 | 16 | 9 | 2.5 | 0.8 |
| Example A2-5 | 5 | 20 | 12 | 4.0 | 0.9 |
| Comparative | 2 | 4 | 2.5 | 0.2 | 175 |
| Example A2-1 | | | | | |
| Comparative | 5 | 28 | 17 | 5.0 | 1.1 |
| Example A2-2 | | | | | |

TABLE 4

| | Initial | After | | After |
|---|---|---|---|---|
| | potential, V | 1000 hr, V | After 1500 hr, V | 2000 hr, V |
| Example A2-1 | 0.58 | 0.58 | 0.58 | 0.58 |
| Example A2-2 | 0.57 | 0.57 | 0.57 | 0.57 |
| Example A2-3 | 0.58 | 0.58 | 0.58 | 0.58 |
| Example A2-4 | 0.58 | 0.58 | 0.58 | 0.58 |
| Example A2-5 | 0.57 | 0.57 | 0.57 | 0.57 |
| Comparative | 0.42 | 0.41 | 0.40 | 0.39 |
| Example A2-1 | | | | |
| Comparative | 0.56 | 0.56 | 0.55 | 0.54 |
| Example A2-2 | | | | |

TABLE 5

| | 3% | 97% | Average | | Gas permeability, |
|---|---|---|---|---|---|
| | diameter, | diameter, | crystal grain | Mn content, | ×10⁻¹⁰ |
| | μm | μm | diameter, μm | wt % | ms⁻¹Pa⁻¹ |
| Example A3-1 | 3 | 12 | 6 | 1.1 | 0.7 |
| Example A3-2 | 3 | 6 | 3.5 | 0.5 | 20 |
| Example A3-3 | 3 | 8 | 4.7 | 0.9 | 3.5 |
| Example A3-4 | 3 | 16 | 9 | 2.5 | 0.7 |
| Example A3-5 | 4 | 20 | 11 | 3.7 | 0.6 |
| Comparative | 2 | 4 | 2.3 | 0.2 | 280 |
| Example A3-1 | | | | | |
| Comparative | 4 | 28 | 14 | 4.5 | 1.1 |
| Example A3-2 | | | | | |

TABLE 6

| | Initial | | After | After |
|---|---|---|---|---|
| | potential, V | After 1000 hr, V | 1500 hr, V | 2000 hr, V |
| Example A3-1 | 0.68 | 0.68 | 0.68 | 0.68 |
| Example A3-2 | 0.66 | 0.66 | 0.66 | 0.66 |
| Example A3-3 | 0.67 | 0.67 | 0.67 | 0.67 |
| Example A3-4 | 0.68 | 0.68 | 0.68 | 0.68 |
| Example A3-5 | 0.67 | 0.67 | 0.67 | 0.67 |
| Comparative | 0.46 | 0.45 | 0.44 | 0.43 |
| Example A3-1 | | | | |
| Comparative | 0.66 | 0.66 | 0.65 | 0.64 |
| Example A3-2 | | | | |

### Example A4

### Fuel Cell in Which Layer Formed of SSZ on Air Electrode Side and Layer Formed of YSZ on Fuel Electrode Side Were Provided as Electrolyte

### Example A4-1

A layer formed of SSZ having a composition of 90 mol % ZrO₂-10 mol % Sc₂O₃ was formed by slurry coating on the air-side electrode reaction layer. A layer formed of YSZ having a composition of 90 mol % ZrO₂-10 mol % Y₂O₃ was formed on this layer by slurry coating, and the assembly was then fired at 1400° C. The thickness of the electrolyte was 30 μm (layer formed of SSZ: 15 μm, layer formed of YSZ: 15 μm). A fuel cell was prepared in the same manner as in Example A1-1 except for the above matter.

### Example A4-2

A layer formed of SSZ having a composition of 90 mol % ZrO₂-10 mol % Sc₂O₃ was formed by slurry coating on the air-side electrode reaction layer. A layer formed of YSZ having a composition of 90 mol % ZrO₂-10 mol % Y₂O₃ was formed on this layer by slurry coating, and the assembly was then fired at 1350° C. The thickness of the electrolyte was 30 μm (layer formed of SSZ: 15 μm, layer formed of YSZ: 15 μm). A fuel cell was prepared in the same manner as in Example A1-1 except for the above matter.

### Example A4-3

A layer formed of SSZ having a composition of 90 mol % ZrO₂-10 mol % Sc₂O₃ was formed by slurry coating on the air-side electrode reaction layer. A layer formed of YSZ having a composition of 90 mol % ZrO₂-10 mol % Y₂O₃ was formed on this layer by slurry coating, and the assembly was then fired at 1380° C. The thickness of the electrolyte was 30 μm (layer formed of SSZ: 15 μm, layer formed of YSZ: 15 μm). A fuel cell was prepared in the same manner as in Example A1-1 except for the above matter.

### Example A4-4

A layer formed of SSZ having a composition of 90 mol % ZrO₂-10 mol % Sc₂O₃ was formed by slurry coating on the air-side electrode reaction layer. A layer formed of YSZ having a composition of 90 mol % ZrO₂-10 mol % Y₂O₃ was formed on this layer by slurry coating, and the assembly was then fired at 1415° C. The thickness of the electrolyte was 30 μm (layer formed of SSZ: 15 μm, layer formed of YSZ: 15 μm). A fuel cell was prepared in the same manner as in Example A1-1 except for the above matter.

### Example A4-5

A layer formed of SSZ having a composition of 90 mol % ZrO₂-10 mol % Sc₂O₃ was formed by slurry coating on the air-side electrode reaction layer. A layer formed of YSZ having a composition of 90 mol % ZrO₂-10 mol % Y₂O₃ was formed on this layer by slurry coating, and the assembly was then sintered at 1425° C. The thickness of the electrolyte was 30 μm (layer formed of SSZ: 15 μm, layer formed of YSZ: 15 μm). A fuel cell was prepared in the same manner as in Example A1-1 except for the above matter.

### Comparative Example A4-1

A layer formed of SSZ having a composition of 90 mol % ZrO₂-10 mol % Sc₂O₃ was formed by slurry coating on the air-side electrode reaction layer. A layer formed of YSZ having a composition of 90 mol % ZrO₂-10 mol % Y₂O₃ was formed on this layer by slurry coating, and the assembly was then fired at 1330° C. The thickness of the electrolyte was 30 μm (layer formed of SSZ: 15 μm, layer formed of YSZ: 15 μm). A fuel cell was prepared in the same manner as in Example A1-1 except for the above matter.

### Comparative Example A4-2

A layer formed of SSZ having a composition of 90 mol % ZrO₂-10 mol % Sc₂O₃ was formed by slurry coating on the air-side electrode reaction layer. A layer formed of YSZ having a composition of 90 mol % ZrO₂-10 mol % Y₂O₃ was formed on this layer by slurry coating, and the assembly was then sintered at 1440° C. The thickness of the electrolyte was 30 μm (layer formed of SSZ: 15 μm, layer formed of YSZ: 15 μm). A fuel cell was prepared in the same manner as in Example A1-1 except for the above matter.

The measurement of particle size distribution, a gas leakage test, a power generation test, and a durability test were carried out for the fuel cells thus obtained. The results were as shown in tables below.

TABLE 7

| | 3% | 97% | Average | | Gas permeability, |
|---|---|---|---|---|---|
| | diameter, | diameter, | crystal grain | Mn content, | ×10⁻¹⁰ |
| | μm | μm | diameter, μm | wt % | ms⁻¹Pa⁻¹ |
| Example A4-1 | 3 | 12 | 7 | 1.2 | 0.6 |
| Example A4-2 | 3 | 6 | 4 | 0.3 | 13 |
| Example A4-3 | 3 | 9 | 5 | 0.9 | 2.7 |
| Example A4-4 | 4 | 16 | 9 | 2.6 | 0.6 |
| Example A4-5 | 4 | 20 | 11 | 4.0 | 0.7 |
| Comparative | 2 | 3 | 2.3 | 0.2 | 140 |
| Example A4-1 | | | | | |
| Comparative | 5 | 28 | 15 | 4.7 | 1.1 |
| Example A4-2 | | | | | |

TABLE 8

| | Initial | | After | After |
|---|---|---|---|---|
| | Potential, V | After 1000 hr, V | 1500 hr, V | 2000 hr, V |
| Example A4-1 | 0.68 | 0.68 | 0.68 | 0.68 |
| Example A4-2 | 0.67 | 0.67 | 0.67 | 0.67 |
| Example A4-3 | 0.68 | 0.68 | 0.68 | 0.68 |
| Example A4-4 | 0.68 | 0.68 | 0.68 | 0.68 |
| Example A4-5 | 0.67 | 0.67 | 0.67 | 0.67 |
| Comparative | 0.46 | 0.45 | 0.44 | 0.43 |
| Example A4-1 | | | | |
| Comparative | 0.66 | 0.65 | 0.65 | 0.64 |
| Example A4-2 | | | | |

### Example A5

### Fuel Cell in Which Layer Formed of YSZ on Air Electrode Side and Layer Formed of SSZ on Fuel Electrode Side Were Provided as Electrolyte

### Example A5-1

A layer formed of YSZ having a composition of 90 mol % ZrO₂-10 mol % Y₂O₃ was formed by slurry coating on the air-side electrode reaction layer. A layer formed of SSZ having a composition of 90 mol % ZrO₂-1 0 mol % SC₂O₃ was formed on this layer by slurry coating, and the assembly was then fired at 1400° C. The thickness of the electrolyte was 30 μm (layer formed of YSZ: 15 μm, layer formed of SSZ: 15 μm). A fuel cell was prepared in the same manner as in Example A1-1 except for the above matter.

### Example A5-2

A layer formed of YSZ having a composition of 90 mol % ZrO₂-10 mol % Y₂O₃ was formed by slurry coating on the air-side electrode reaction layer. A layer formed of SSZ having a composition of 90 mol % ZrO₂-10 mol % Sc₂O₃ was formed on this layer by slurry coating, and the assembly was then fired at 1350° C. The thickness of the electrolyte was 30 μm (layer formed of YSZ: 15 μm, layer formed of SSZ: 15 μm). A fuel cell was prepared in the same manner as in Example A1-1 except for the above matter.

### Example A5-3

A layer formed of YSZ having a composition of 90 mol % ZrO₂-10 mol % Y₂O₃ was formed by slurry coating on the air-side electrode reaction layer. A layer formed of SSZ having a composition of 90 mol % ZrO₂-10 mol % Sc₂O₃ was formed on this layer by slurry coating, and the assembly was then fired at 1380° C. The thickness of the electrolyte was 30 μm (layer formed of YSZ: 15 μm, layer formed of SSZ: 15 μm). A fuel cell was prepared in the same manner as in Example A1-1 except for the above matter.

### Example A5-4

A layer formed of YSZ having a composition of 90 mol % ZrO₂-10 mol % Y₂O₃ was formed by slurry coating on the air-side electrode reaction layer. A layer formed of SSZ having a composition of 90 mol % ZrO₂-10 mol % Sc₂O₃ was formed on this layer by slurry coating, and the assembly was then fired at 1420° C. The thickness of the electrolyte was 30 μm (layer formed of YSZ: 15 μm, layer formed of SSZ: 15 μm). A fuel cell was prepared in the same manner as in Example A1-1 except for the above matter.

### Example A5-5

A layer formed of YSZ having a composition of 90 mol % ZrO₂-10 mol % Y₂O₃ was formed by slurry coating on the air-side electrode reaction layer. A layer formed of SSZ having a composition of 90 mol % ZrO₂-10 mol % Sc₂O₃ was formed on this layer by slurry coating, and the assembly was then fired at 1430° C. The thickness of the electrolyte was 30 μm (layer formed of YSZ: 15 μm, layer formed of SSZ: 15 μm). A fuel cell was prepared in the same manner as in Example A1-1 except for the above matter.

### Comparative Example A5-1

A layer formed of YSZ having a composition of 90 mol % ZrO₂-10 mol % Y₂O₃ was formed by slurry coating on the air-side electrode reaction layer. A layer formed of SSZ having a composition of 90 mol % ZrO₂-10 mol % Sc₂O₃ was formed on this layer by slurry coating, and the assembly was then fired at 1330° C. The thickness of the electrolyte was 30 μm (layer formed of YSZ: 15 μm, layer formed of SSZ: 15 μm). A fuel cell was prepared in the same manner as in Example A1-1 except for the above matter.

### Comparative Example A5-2

A layer formed of YSZ having a composition of 90 mol % ZrO₂-10 mol % Y₂O₃ was formed by slurry coating on the air-side electrode reaction layer. A layer formed of SSZ having a composition of 90 mol % ZrO₂-10 mol % Sc₂O₃ was formed on this layer by slurry coating, and the assembly was then fired at 1450° C. The thickness of the electrolyte was 30 μm (layer formed of YSZ: 15 μm, layer formed of SSZ: 15 μm). A fuel cell was prepared in the same manner as in Example A1-1 except for the above matter.

The measurement of particle size distribution, a gas leakage test, a power generation test, and a durability test were carried out for the fuel cells thus obtained. The results were as shown in tables below.

TABLE 9

| | 3% | 97% | Average | | Gas permeability, |
|---|---|---|---|---|---|
| | diameter, | diameter, | crystal grain | Mn content, | ×10⁻¹⁰ |
| | μm | μm | diameter, μm | wt % | ms⁻¹Pa⁻¹ |
| Example A5-1 | 3 | 10 | 6 | 1.0 | 1.7 |
| Example A5-2 | 3 | 6 | 4 | 0.3 | 13 |
| Example A5-3 | 3 | 8 | 5 | 0.7 | 5.5 |
| Example A5-4 | 3 | 15 | 9 | 2.1 | 1.3 |
| Example A5-5 | 4 | 20 | 11 | 4.0 | 1.5 |
| Comparative | 1 | 3 | 2 | 0.2 | 260 |
| Example A5-1 | | | | | |
| Comparative | 4 | 27 | 15 | 4.6 | 1.6 |
| Example A5-2 | | | | | |

TABLE 10

| | Initial, | | After | After |
|---|---|---|---|---|
| | potential, V | After 1000 hr, V | 1500 hr, V | 2000 hr, V |
| Example A5-1 | 0.67 | 0.67 | 0.67 | 0.67 |
| Example A5-2 | 0.66 | 0.66 | 0.66 | 0.66 |
| Example A5-3 | 0.67 | 0.67 | 0.67 | 0.67 |
| Example A5-4 | 0.67 | 0.67 | 0.67 | 0.67 |
| Example A5-5 | 0.66 | 0.66 | 0.66 | 0.66 |
| Comparative | 0.45 | 0.44 | 0.43 | 0.42 |
| Example A5-1 | | | | |
| Comparative | 0.65 | 0.65 | 0.64 | 0.63 |
| Example A5-2 | | | | |

### Example A6

### Fuel Cell in Which Electrolyte Has Three-Layer Structure

### Example A6-1

A layer formed of SSZ having a composition of 90 mol % ZrO₂-10 mol % Sc₂O₃ was formed by slurry coating on the air-side electrode reaction layer. A layer formed of YSZ having a composition of 90 mol % ZrO₂-10 mol % Y₂O₃ was formed on this layer by slurry coating. Further, a layer formed of SSZ having a composition of 90 mol % ZrO₂-10 mol % Sc₂O₃ was formed by slurry coating, and the assembly was then fired at 1400° C. The thickness of the electrolyte was 30 μm (layer formed of SSZ on the air side: 10 μm, layer formed of YSZ: 10 μm, layer formed of SSZ on the fuel electrode side: 10 μm). A fuel cell was prepared in the same manner as in Example A1-1 except for the above matter.

### Example A6-2

A layer formed of SSZ having a composition of 90 mol % ZrO₂-10 mol % Sc₂O₃ was formed by slurry coating on the air-side electrode reaction layer. A layer formed of YSZ having a composition of 90 mol % ZrO₂-10 mol % Y₂O₃ was formed on this layer by slurry coating. Further, a layer formed of SSZ having a composition of 90 mol % ZrO₂-10 mol % Sc₂O₃ was formed by slurry coating, and the assembly was then fired at 1360° C. The thickness of the electrolyte was 30 μm (layer formed of SSZ on the air side: 10 μm, layer formed of YSZ: 10 μm, layer formed of SSZ on the fuel electrode side: 10 μm). A fuel cell was prepared in the same manner as in Example A1-1 except for the above matter.

### Example A6-3

A layer formed of SSZ having a composition of 90 mol % ZrO₂-10 mol % Sc₂O₃ was formed by slurry coating on the air-side electrode reaction layer. A layer formed of YSZ having a composition of 90 mol % ZrO₂-10 mol % Y₂O₃ was formed on this layer by slurry coating. Further, a layer formed of SSZ having a composition of 90 mol % ZrO₂-10 mol % Sc₂O₃ was formed by slurry coating, and the assembly was then fired at 1380° C. The thickness of the electrolyte was 30 μm (layer formed of SSZ on the air side: 10 μm, layer formed of YSZ: 10 μm, layer formed of SSZ on the fuel electrode side: 10 μm). A fuel cell was prepared in the same manner as in Example A1-1 except for the above matter.

### Example A6-4

A layer formed of SSZ having a composition of 90 mol % ZrO₂-10 mol % Sc₂O₃ was formed by slurry coating on the air-side electrode reaction layer. A layer formed of YSZ having a composition of 90 mol % ZrO₂-10 mol % Y₂O₃ was formed on this layer by slurry coating. Further, a layer formed of SSZ having a composition of 90 mol % ZrO₂-10 mol % Sc₂O₃ was formed by slurry coating, and the assembly was then fired at 1420° C. The thickness of the electrolyte was 30 μm (layer formed of SSZ on the air side: 10 μm, layer formed of YSZ: 10 μm, layer formed of SSZ on the fuel electrode side: 10 μm). A fuel cell was prepared in the same manner as in Example A1-1 except for the above matter.

### Example A6-5

A layer formed of SSZ having a composition of 90 mol % ZrO₂-10 mol % Sc₂O₃ was formed by slurry coating on the air-side electrode reaction layer. A layer formed of YSZ having a composition of 90 mol % ZrO₂-10 mol % Y₂O₃ was formed on this layer by slurry coating. Further, a layer formed of SSZ having a composition of 90 mol % ZrO₂-10 mol % Sc₂O₃ was formed by slurry coating, and the assembly was then fired at 1440° C. The thickness of the electrolyte was 30 μm (layer formed of SSZ on the air side: 10 μm, layer formed of YSZ: 10 μm, layer formed of SSZ on the fuel electrode side: 10 μm). A fuel cell was prepared in the same manner as in Example A1-1 except for the above matter.

### Comparative Example A6-1

A layer formed of SSZ having a composition of 90 mol % ZrO₂-10 mol % Sc₂O₃ was formed by slurry coating on the air-side electrode reaction layer. A layer formed of YSZ having a composition of 90 mol % ZrO₂-10 mol % Y₂O₃ was formed on this layer by slurry coating. Further, a layer formed of SSZ having a composition of 90 mol % ZrO₂-10 mol % Sc₂O₃ was formed by slurry coating, and the assembly was then sintered at 1330° C. The thickness of the electrolyte was 30 μm (layer formed of SSZ on the air side: 10 μm, layer formed of YSZ: 10 μm, layer formed of SSZ on the fuel electrode side: 10 μm). A fuel cell was prepared in the same manner as in Example A1-1 except for the above matter.

### Comparative Example A6-2

A layer formed of SSZ having a composition of 90 mol % ZrO₂-10 mol % Sc₂O₃ was formed by slurry coating on the air-side electrode reaction layer. A layer formed of YSZ having a composition of 90 mol % ZrO₂-10 mol % Y₂O₃ was formed on this layer by slurry coating. Further, a layer formed of SSZ having a composition of 90 mol % ZrO₂-10 mol % Sc₂O₃ was formed by slurry coating, and the assembly was then sintered at 1450° C. The thickness of the electrolyte was 30 μm (layer formed of SSZ on the air side: 10 μm, layer formed of YSZ: 10 μm, layer formed of SSZ on the fuel electrode side: 10 μm). A fuel cell was prepared in the same manner as in Example A1-1 except for the above matter.

The measurement of particle size distribution, a gas leakage test, a power generation test, and a durability test were carried out for the fuel cells thus obtained. The results were as shown in tables below.

TABLE 11

| | 3% | 97% | Average | | Gas permeability, |
|---|---|---|---|---|---|
| | diameter, | diameter, | crystal grain | Mn content, | ×10⁻¹⁰ |
| | μm | μm | diameter, μm | wt % | ms⁻¹Pa⁻¹ |
| Example A6-1 | 3 | 8 | 5 | 0.9 | 1.1 |
| Example A6-2 | 3 | 5 | 4 | 0.3 | 10.3 |
| Example A6-3 | 3 | 6 | 4 | 0.6 | 2.7 |
| Example A6-4 | 3 | 14 | 8 | 1.8 | 0.9 |
| Example A6-5 | 3 | 20 | 11 | 3.6 | 0.9 |
| Comparative | 2 | 4 | 2.3 | 0.2 | 130 |
| Example A6-1 | | | | | |
| Comparative | 4 | 27 | 15 | 4.4 | 1.0 |
| Example A6-2 | | | | | |

TABLE 12

| | Initial | After | | After |
|---|---|---|---|---|
| | potential, V | 1000 hr, V | After 1500 hr, V | 2000 hr, V |
| Example A6-1 | 0.69 | 0.69 | 0.69 | 0.69 |
| Example A6-2 | 0.67 | 0.67 | 0.67 | 0.67 |
| Example A6-3 | 0.68 | 0.68 | 0.68 | 0.68 |
| Example A6-4 | 0.69 | 0.69 | 0.69 | 0.69 |
| Example A6-5 | 0.68 | 0.68 | 0.68 | 0.68 |
| Comparative | 0.48 | 0.47 | 0.46 | 0.45 |
| Example A6-1 | | | | |
| Comparative | 0.67 | 0.67 | 0.66 | 0.65 |
| Example A6-2 | | | | |

### Example A7

### Thickness of Electrolyte Film

### Example A7-1

A fuel cell was prepared in the same manner as in Example A1-1, except that the electrolyte film had a composition of 90 mol % ZrO₂-5 mol % Sc₂O₃-5 mol % Y₂O₃, was sintered at 1420° C., and had a thickness of 8 μm.

### Example A7-2

A fuel cell was prepared in the same manner as in Example A1-1, except that the electrolyte film had a composition of 90 mol % ZrO₂-5 mol %. Sc₂O₃-5 mol % Y₂O₃, was sintered at 1420° C., and had a thickness of 10 μm.

### Example A7-3

A fuel cell was prepared in the same manner as in Example A1-1, except that the electrolyte film had a composition of 90 mol % ZrO₂-5 mol % Sc₂O₃-5 mol % Y₂O₃, was sintered at 1420° C., and had a thickness of 15 μm.

### Example A7-4

A fuel cell was prepared in the same manner as in Example A1-1, except that the electrolyte film had a composition of 90 mol % ZrO₂-5 mol % Sc₂O₃-5 mol % Y₂O₃, was sintered at 1420° C., and had a thickness of 30 μm.

### Example A7-5

A fuel cell was prepared in the same manner as in Example A1-1, except that the electrolyte film had a composition of 90 mol % ZrO₂-5 mol % Sc₂O₃-5 mol % Y₂O₃, was sintered at 1420° C., and had a thickness of 50 μm.

### Example A7-6

A fuel cell was prepared in the same manner as in Example A1-1, except that the electrolyte film had a composition of 90 mol % ZrO₂-5 mol % Sc₂O₃-5 mol % Y₂O₃, was sintered at 1420° C., and had a thickness of 80 μm.

### Example A7-7

A fuel cell was prepared in the same manner as in Example A1-1, except that the electrolyte film had a composition of 90 mol % ZrO₂-5 mol % Sc₂O₃-5 mol % Y₂O₃, was sintered at 1420° C., and had a thickness of 100 μm.

### Example A7-8

A fuel cell was prepared in the same manner as in Example A1-1, except that the electrolyte film had a composition of 90 mol % ZrO₂-5 mol % Sc₂O₃-5 mol % Y₂O₃, was sintered at 1420° C., and had a thickness of 120 μm.

The measurement of particle size distribution, a gas leakage test, a power generation test, and a durability test were carried out for the fuel cells thus obtained. The results were as shown in tables below.

TABLE 13

| | 3% | 97% | Average | | Gas permeability, |
|---|---|---|---|---|---|
| | diameter, | diameter, | crystal grain | Mn content, | ×10⁻¹⁰ |
| | μm | μm | diameter, μm | wt % | ms⁻¹Pa⁻¹ |
| Example A7-1 | 5 | 8 | 7 | 4.0 | 28 |
| Example A7-2 | 5 | 10 | 8 | 3.8 | 20 |
| Example A7-3 | 5 | 13 | 9 | 3.4 | 7.5 |
| Example A7-4 | 3 | 16 | 9 | 2.5 | 0.7 |
| Example A7-5 | 3 | 11 | 6 | 1.5 | 0.6 |
| Example A7-6 | 3 | 8 | 5 | 1.0 | 0.5 |
| Example A7-7 | 3 | 5 | 4 | 0.6 | 0.4 |
| Example A7-8 | 3 | 4 | 3.3 | 0.3 | 0.3 |

TABLE 14

| | Initial | After | | After |
|---|---|---|---|---|
| | potential, V | 1000 hr, V | After 1500 hr, V | 2000 hr, V |
| Example A7-1 | 0.61 | 0.61 | 0.61 | 0.61 |
| Example A7-2 | 0.64 | 0.64 | 0.64 | 0.64 |
| Example A7-3 | 0.66 | 0.66 | 0.66 | 0.66 |
| Example A7-4 | 0.67 | 0.67 | 0.67 | 0.67 |
| Example A7-5 | 0.67 | 0.67 | 0.67 | 0.67 |
| Example A7-6 | 0.67 | 0.67 | 0.67 | 0.67 |
| Example A7-7 | 0.66 | 0.66 | 0.66 | 0.66 |
| Example A7-8 | 0.63 | 0.63 | 0.63 | 0.63 |

### Example B1

(1) Preparation of Electrolyte

(1-1) Preparation of Raw Material Powder for Electrolyte

An SSZ material represented by 90 mol % ZrO₂-10 mol % Sc₂O₃ was provided as an electrolyte material. Specifically, ZrO₂ was dissolved in not less than 3 N concentrated nitric acid heated at 100° C., and the solution was diluted with distilled water to give an aqueous nitrate solution. Also for Sc₂O₃, an aqueous nitrate solution was prepared in the same manner as described above. The aqueous nitrate solutions thus obtained were mixed with each other so as to give the above composition, followed by the addition of an aqueous oxalic acid solution for coprecipitation. The liquid obtained by coprecipitation was dried at about 200° C., was heat decomposed at 500° C., and was further heat treated at 800° C. to prepare a raw material powder. The average particle diameter was 0.5 μm.

(1-2) Preparation of Pressed Product

A binder PVA was added, to the powder, in an amount of 10% by weight based on the SSZ material. The mixture was kneaded and was dried. The dried product was then monoaxially molded in a disk-shaped mold and was subjected to pressing at 1000 kg/cm².

(1-3) Preparation of Pressed Sinter

The pressed product was sintered at 1430° C. Further, after the sintering, the sinter was ground to a thickness of 1 mm.

(1-4) Measurement of Porosity

The porosity of the pressed sinter was measured by an Archimedes' method and was found to be 0.8%, confirming that the electrolyte is not permeable to gas.

(2) Preparation of Mixed Electrically Conductive Ceramic Electrode

(2-1) Preparation of Raw Material

A mixed electrically conductive ceramic material prepared by intimately mixing a manganese- and nickel-containing perovskite oxide with an oxygen ion-conductive oxide was provided. The material had a composition of (La_{0.75}Sr_{0.25})_{0.98}(Mn_{0.95}Ni_{0.05})O₃ and SSZ represented by 90 mol % ZrO₂-10 mol % Sc₂O₃ (hereinafter referred to as “(La_{0.75}Sr_{0.25})_{0.98}(Mn_{0.95}Ni_{0.05})O₃/90 mol % ZrO₂-10 mol % Sc₂O₃”) at a weight ratio of 50/50. (La_{0.75}Sr_{0.25})_{0.98}(Mn_{0.95}Ni_{0.05})O₃ was prepared as follows. An aqueous solution of nitrate of La, an aqueous solution of nitrate of Sr, an aqueous solution of nitrate of Mn, and an aqueous solution of nitrate of Ni were prepared and were mixed together to provide the above composition, and oxalic acid was added to the mixture for precipitation. The precipitate was further heat treated. The resultant raw material was ground and was then fired at 1300° C. to prepare a raw material powder. On the other hand, 90 mol % ZrO₂-10 mol % Sc₂O₃ was prepared as follows. Specifically, ZrO₂ was dissolved in not less than 3 N concentrated nitric acid heated at 100° C., and the solution was diluted with distilled water to give an aqueous nitrate solution. Also for Sc₂O₃, an aqueous nitrate solution was prepared in the same manner as described above. The aqueous nitrate solutions thus obtained were mixed with each other so as to give the above composition, followed by the addition of an aqueous oxalic acid solution for coprecipitation. The liquid obtained by coprecipitation was dried at about 200° C., was heat decomposed at 500° C., and was further heat treated at 1200° C. to prepare a raw material powder. The raw material powders thus obtained were mixed together, and the mixture was heat treated at 1300° C. to prepare a raw material powder. The particle diameter was regulated to an average particle diameter of 2 μm.

(2-2) Preparation of Paste

Ethylcellulose (10 parts by weight) as a binder and 90 parts by weight of α-terpineol as a solvent were added to 100 parts by weight of the raw material powder of (La_{0.75}Sr_{0.25})_{0.98}(Mn_{0.95}Ni_{0.05})O₃/90 mol % ZrO₂-10 mol % Sc₂O₃=50/50, and the mixture was kneaded for 30 min to prepare a paste.

(2-3) Preparation of Electrode

The paste was screen printed on one side of the electrolyte in the pressed product so that the diameter was 6 mm, followed by sintering at 1400° C. The thickness of the electrode after firing was 20 μm. A platinum electrode was screen printed on this electrode and on the pressed product in its side remote from the electrode so that the diameter was 6 mm, followed by sintering at 1100° C. to prepare a fuel cell specimen.

### Example B2

A fuel cell specimen was prepared in the same manner as in Example B1, except that the mixed electrically conductive ceramic electrode was prepared so as to have a composition of (La_{0.75}Sr_{0.25})_{0.98}(Mn_{0.99}Ni_{0.01})O₃/90 mol % ZrO₂-10 mol % Sc₂O₃=50/50.

### Example B3

A fuel cell specimen was prepared in the same manner as in Example B1, except that the mixed electrically conductive ceramic electrode was prepared so as to have a composition of (La_{0.75}Sr_{0.25})_{0.98}(Mn_{0.98}Ni_{0.02})O₃/90 mol % ZrO₂-10 mol % Sc₂O₃=50/50.

### Example B4

A fuel cell specimen was prepared in the same manner as in Example B1, except that the mixed electrically conductive ceramic electrode was prepared so as to have a composition of (La_{0.75}Sr_{0.25})_{0.98}(Mn_{0.92}Ni_{0.08})O₃/90 mol % ZrO₂-10 mol % Sc₂O₃=50/50.

### Example B5

A fuel cell specimen was prepared in the same manner as in Example B1, except that the mixed electrically conductive ceramic electrode was prepared so as to have a composition of (La_{0.75}Sr_{0.25})_{0.98}(Mn_{0.90}Ni_{0.10})O₃/90 mol % ZrO₂-10 mol % Sc₂O₃=50/50.

### Example B6

A fuel cell specimen was prepared in the same manner as in Example B1, except that the mixed electrically conductive ceramic electrode was prepared so as to have a composition of (La_{0.75}Sr_{0.25})_{0.98}(Mn_{0.87}Ni_{0.13})O₃/90 mol % ZrO₂-10 mol % Sc₂O₃=50/50.

### Comparative Example B1

A fuel cell specimen was prepared in the same manner as in Example B1, except that the mixed electrically conductive ceramic electrode was prepared so as to have a composition of (La_{0.75}Sr_{0.25})_{0.98}MnO₃/90 mol % ZrO₂-10 mol % Sc₂O₃=50/50.

Measurement of Overvoltage

The specimen prepared above was constructed as shown in FIG. 7 for the measurement reaction of overvoltage. Specifically, an electrode 11 formed of a mixed electrically conductive ceramic is provided on one side of an electrolyte 13 formed of an SSZ material. A platinum electrode 12 is provided on the surface of the electrode 11, and a counter electrode 14 of platinum is provided on the electrode on its side remote from the electrode 11. A reference electrode 15 of platinum is provided on the side face of the electrolyte 13. Further, two lead wires16 are mounted on the platinum electrode 12, a lead wire 17 is mounted on the counter electrode, and a lead wire 18 is mounted on the reference electrode 15. The temperature of the cell was raised to 800° C. under the atmosphere, and the overvoltage was then measured by a current chopping method. The current chopping method is a method in which current flown into the cell is instantaneously interrupted and, based on a voltage change at that time, reaction-derived overvoltage and ohmic resistance-derived overvoltage are quantitatively determined. In this test, the reaction overvoltage was measured under conditions of 0.2 Acm⁻². In general, it is the that, when the reaction overvoltage is lower, the electrode characteristics are better.

TABLE 15

| | | Reaction |
|---|---|---|
| | z value in | overvoltage, |
| | (La_{0.75}Sr_{0.25})_{0.98}(Mn_{1-z}Ni_{z})O₃ | mV |
| Example B1 | 0.05 | 25 |
| Example B2 | 0.01 | 70 |
| Example B3 | 0.02 | 45 |
| Example B4 | 0.08 | 24 |
| Example B5 | 0.10 | 38 |
| Example B6 | 0.13 | 60 |
| Comparative | 0 | 80 |
| Example B1 | | |

A comparison of Examples B1 to B6 and Comparative Example B1 shows that the incorporation of Ni lowers the reaction overvoltage. The reason for this is believed to reside in that the incorporation of Ni suppresses the diffusion of manganese in the electrolyte. Thus, it could be confirmed that the incorporation of Ni suppresses the diffusion of manganese and can provide good electrode characteristics. Regarding the Ni content, there is a tendency that an Ni content of not less than 0.02 lowers the reaction overvoltage while an Ni content of more than 0.10 increases the reaction overvoltage. This demonstrates that an Ni content in the range of 0.02 to 0.10 is more preferred.

Tests were carried out below for (La_{0.75}Sr_{0.25})_{y}(Mn_{0.95}Ni_{0.05})O₃/90 mol % ZrO₂-10 mol % Sc₂O₃=50/50.

### Example B7

A fuel cell specimen was prepared in the same manner as in Example B1, except that the mixed electrically conductive ceramic electrode was prepared so as to have a composition of (La_{0.75}Sr_{0.25})_{0.96}(Mn_{0.95}Ni_{0.05})O₃/90 mol % ZrO₂-10 mol % Sc₂O₃=50/50.

### Example B8

A fuel cell specimen was prepared in the same manner as in Example B1, except that the mixed electrically conductive ceramic electrode was prepared so as to have a composition of (La_{0.75}Sr_{0.25})_{0.97}(Mn_{0.95}Ni_{0.05})O₃/90 mol % ZrO₂-10 mol % Sc₂O₃=50/50.

### Example B9

A fuel cell specimen was prepared in the same manner as in Example B1, except that the mixed electrically conductive ceramic electrode was prepared so as to have a composition of (La_{0.75}Sr_{0.25})_{0.99}(Mn_{0.95}Ni_{0.05})O₃/90 mol % ZrO₂-10 mol % Sc₂O₃=50/50.

### Example B10

A fuel cell specimen was prepared in the same manner as in Example B1, except that the mixed electrically conductive ceramic electrode was prepared so as to have a composition of (La_{0.75}Sr_{0.25})(Mn_{0.95}Ni_{0.05})O₃/90 mol % ZrO₂-10 mol % Sc₂O₃=50/50.

### Example B11

A fuel cell specimen was prepared in the same manner as in Example B1, except that the mixed electrically conductive ceramic electrode was prepared so as to have a composition of (La_{0.75}Sr_{0.25})_{1.01}(Mn_{0.95}Ni_{0.05})O₃/90 mol % ZrO₂-10 mol % Sc₂O₃=50/50.

Overvoltage Evaluation Test

The reaction overvoltage was measured by the same overvoltage measurement method as described above. The results were as summarized in the table below

TABLE 16

| | y value in | Reaction |
|---|---|---|
| | (La_{0.75}Sr_{0.25})_{y}(Mn_{0.95}Ni_{0.05})O₃ | overvoltage, mV |
| Example B1 | 0.98 | 25 |
| Example B7 | 0.96 | 70 |
| Example B8 | 0.97 | 45 |
| Example B9 | 0.99 | 17 |
| Example B10 | 1.00 | 20 |
| Example B11 | 1.01 | 45 |

The results show that, when y value is in the range of 0.97 to 1, the reaction overvoltage is low while, when y value is less than 0.97 and more than 1.00, a rapid increase in reaction overvoltage takes place, confirming that y value is more preferably 0.97≦y≦1.00.

Next, tests were carried out with varied weight ratios.

### Example B12

A fuel cell specimen was prepared in the same manner as in Example B1, except that the mixed electrically conductive ceramic electrode was prepared using as a material (La_{0.75}Sr_{0.25})_{0.98}(Mn_{0.95}Ni_{0.05})O₃/90 mol % ZrO₂-10 mol % Sc₂O₃=20/80 in terms of a weight ratio.

### Example B13

A fuel cell specimen was prepared in the same manner as in Example B1, except that the mixed electrically conductive ceramic electrode was prepared using as a material (La_{0.75}Sr_{0.25})_{0.98}(Mn_{0.95}Ni_{0.05})O₃/90 mol % ZrO₂-10 mol % Sc₂O₃=30/70 in terms of a weight ratio.

### Example B14

A fuel cell specimen was prepared in the same manner as in Example B1, except that the mixed electrically conductive ceramic electrode was prepared using as a material (La_{0.75}Sr_{0.25})_{0.98}(Mn_{0.95}Ni_{0.05})O₃/90 mol % ZrO₂-10 mol % Sc₂O₃=40/60 in terms of a weight ratio.

### Example B15

A fuel cell specimen was prepared in the same manner as in Example B1, except that the mixed electrically conductive ceramic electrode was prepared using as a material (La_{0.75}Sr_{0.25})_{0.98}(Mn_{0.95}Ni_{0.05})O₃/90 mol % ZrO₂-10 mol % Sc₂O₃=60/40 in terms of a weight ratio.

### Example B16

A fuel cell specimen was prepared in the same manner as in Example B1, except that the mixed electrically conductive ceramic electrode was prepared using as a material (La_{0.75}Sr_{0.25})_{0.98}(Mn_{0.95}Ni_{0.05})O₃/90 mol % ZrO₂-10 mol % Sc₂O₃=70/30 in terms of a weight ratio.

### Example B17

A fuel cell specimen was prepared in the same manner as in Example B1, except that the mixed electrically conductive ceramic electrode was prepared using as a material (La_{0.75}Sr_{0.25})_{0.98}(Mn_{0.95}Ni_{0.05})O₃/90 mol % ZrO₂-10 mol % Sc₂O₃=80/20 in terms of a weight ratio.

### Comparative Example B2

A fuel cell specimen was prepared in the same manner as in Example B1, except that the mixed electrically conductive ceramic electrode was prepared so as to have a composition of (La_{0.75}Sr_{0.25})_{0.98}(Mn_{0.95}Ni_{0.05})O₃, and, after firing at 1300° C., the average particle diameter was regulated to 2 μm.

### Comparative Example B3

A fuel cell specimen was prepared in the same manner as in Example B1, except that an SSZ material having a composition of 90 mol % ZrO₂-10 mol % Sc₂O₃ was used as the material for the mixed electrically conductive ceramic electrode, and, after firing at 1200° C., the average particle diameter was regulated to 2 μm.

Overvoltage Evaluation Test

The reaction overvoltage was measured by the same overvoltage measurement method as described above. The results were as summarized in the table below

TABLE 17

| | Weight ratio, wt % of | |
|---|---|---|
| | (La_{0.75}Sr_{0.25})y(Mn_{0.95}Ni_{0.05})O₃ in | |
| | (La_{0.75}Sr_{0.25})_{0.98}(Mn_{0.95}Ni_{0.05})O₃/ | Reaction |
| | 90 mol % ZrO₂•10 mol % Sc₂O₃ | overvoltage, mV |
| Example B1 | 50 | 25 |
| Example B12 | 20 | 65 |
| Example B13 | 30 | 39 |
| Example B14 | 40 | 27 |
| Example B15 | 60 | 27 |
| Example B16 | 70 | 37 |
| Example B17 | 80 | 56 |
| Comparative | 100 | 205 |
| Example B2 | | |
| Comparative | 0 | 270 |
| Example B3 | | |

When the weight ratio is in the range of 30 to 70% by weight, there is a tendency that the overvoltage is reduced.

A test was carried out for the influence of rare earth elements other than La.

### Example B18

A fuel cell specimen was prepared in the same manner as in Example B1, except that the mixed electrically conductive ceramic electrode was prepared so as to have a composition of (Y_{0.75}Sr_{0.25})_{0.98}(Mn_{0.95}Ni_{0.05})O₃/90 mol % ZrO₂-10 mol % Sc₂O =50/50.

### Example B19

A fuel cell specimen was prepared in the same manner as in Example B1, except that the mixed electrically conductive ceramic electrode was prepared so as to have a composition of (Sm_{0.75}Sr_{0.25})_{0.98}(Mn_{0.95}Ni_{0.05})O₃/90 mol % ZrO₂-10 mol % Sc₂O₃=50/50.

Overvoltage Evaluation Test

The reaction overvoltage was measured by the same overvoltage measurement method as described above. The results were as summarized in the table below

TABLE 18

| | | Reaction |
|---|---|---|
| | | overvoltage, |
| | Electrode material | mV |
| Example B1 | (La_{0.75}Sr_{0.25})_{0.98}(Mn_{0.95}Ni_{0.05})O₃/ | 25 |
| | 90 mol % ZrO₂•10 mol % Sc₂O₃ = 50/50 | |
| Example B18 | (Y_{0.75}Sr_{0.25})_{0.98}(Mn_{0.95}Ni_{0.05})O₃/ | 30 |
| | 90 mol % ZrO₂•10 mol % Sc₂O = 50/50 | |
| Example B19 | (Sm_{0.75}Sr_{0.25})_{0.98}(Mn_{0.95}Ni_{0.05})O₃/ | 28 |
| | 90 mol % ZrO₂•10 mol % Sc₂O₃ = 50/50 | |

It was confirmed that, when a perovskite oxide containing at least manganese and nickel is represented by (Ln₁₋ₓAₓ)_{y}(Mn_{1-z}Ni_{z})O₃, Ln may be Sm (samarium) or Y (yttrium). It can easily be estimated from this fact that the same effect can be attained also when Ln is one or at least two elements selected from Sc (scandium), Y (yttrium), La (lanthanum), Ce (cerium), Pr (praseodymium), Nd (neodymium), Pm (promethium), Sm (samarium), Eu (europium), Gd (gadolinium), Tb (terbium), Dy (dysprosium), Ho (holmium), Er (erbium), Tm (thulium), Yb (ytterbium), and Lu (lutetium). That is, it could be confirmed that these elements are prepared.

A test was carried out for the influence of materials having oxygen ion conductive properties.

### Example B20

A fuel cell specimen was prepared in the same manner as in Example B1, except that the mixed electrically conductive ceramic electrode was prepared so as to have a composition of (La_{0.75}Sr_{0.25})_{0.98}(Mn_{0.95}Ni_{0.05})O₃/90 mol % ZrO₂-10 mol % Y₂O₃=50/50.

### Example B21

A fuel cell specimen was prepared in the same manner as in Example B1, except that the mixed electrically conductive ceramic electrode was prepared so as to have a composition of (La_{0.75}Sr_{0.25})_{0.98}(Mn_{0.95}Ni_{0.05})O₃/90 mol % ZrO₂-5 mol % Y₂O₃-5 mol % Sc₂O₃=50/50.

### Example B22

The mixed electrically conductive ceramic electrode was prepared using as a material (La_{0.75}Sr_{0.25})_{0.98}(Mn_{0.95}Ni_{0.05})O₃ and a cerium-containing oxide represented by (CeO₂)_{0.8}(Sm₂O₃)_{0.1} (hereinafter referred to as “(La_{0.75}Sr_{0.25})_{0.98}(Mn_{0.95}Ni_{0.05})O₃/(CeO₂)_{0.8}(Sm₂O₃)_{0.1}”) at a weight ratio of 50/50. (CeO₂)_{0.8}(Sm₂O₃)_{0.1} was prepared from a solution of nitrate of Ce and a solution of nitrate of Sm by using coprecipitation with oxalic acid and was heat treated at 1200° C., and the powder of (CeO₂)_{0.8}(Sm₂O₃)_{0.1} was then mixed with the powder of (La_{0.75}Sr_{0.25})_{0.98}(Mn_{0.95}Ni_{0.05})O₃, and the mixture was fired at 1300° C. Further, this electrode was sintered at 1500° C. The electrode was prepared in the same manner as in Example B1 except for the above matter.

### Example B23

The mixed electrically conductive ceramic electrode was prepared using as a material (La_{0.75}Sr_{0.25})_{0.98}(Mn_{0.95}Ni_{0.05})O₃, 90 mol % ZrO₂-10 mol % Sc₂O₃., and a cerium-containing oxide represented by (CeO₂)_{0.8}(Sm₂O₃)_{0.1} (hereinafter referred to as “(La_{0.75}Sr_{0.25})_{0.98}(Mn_{0.95}Ni_{0.05})O₃/90 mol % ZrO₂-10 mol % Sc₂O₃/(CeO₂)0.8(Sm₂O₃)_{0.1}”) at a weight ratio of 50/25/25. (La_{0.75}Sr_{0.25})0.98(Mn_{0.95}Ni_{0.05})O₃, 90 mol % ZrO₂-10 mol % Sc₂O₃, and (CeO₂)_{0.8}(Sm₂O₃)_{0.1} were prepared by coprecipitation. The powders thereof were mixed together, and the mixture was fired at 1300° C. A fuel cell specimen was prepared in the same manner as in Example B1 except for the above matter.

### Example B24

The mixed electrically conductive ceramic electrode was prepared using a material (La_{0.75}Sr_{0.25})_{0.98}(Mn_{0.95}Ni_{0.05})O₃ and a lanthanum gallate represented by La_{0.8}Sr_{0.2}Ga_{0.8}Mg_{0.2}O₃ (hereinafter referred to as “(La_{0.75}Sr_{0.25})_{0.98}(Mn_{0.95}Ni_{0.05})O₃/La_{0.8}Sr_{0.2}Ga_{0.8}Mg_{0.2}O₃”) at a weight ratio of 50/50. La_{0.8}Sr_{0.2}Ga_{0.8}Mg_{0.2}O₃ was prepared by mixing La₂O₃, SrCO₃, Ga₂O₃, and MgO together so as to provide the above composition, ball milling the mixture and then heat treating the mixture at 1200° C. The powder of La_{0.8}Sr_{0.2}Ga_{0.8}Mg_{0.2}O₃ was mixed with the powder of (La_{0.75}Sr_{0.25})_{0.98}(Mn_{0.95}Ni_{0.05})O₃, and the mixture was fired at 1300° C. A fuel cell specimen was prepared in the same manner as in Example B1 except for the above matter.

### Comparative Example B4

A fuel cell specimen was prepared in the same manner as in Example B1, except that the mixed electrically conductive ceramic electrode was prepared so as to have a composition of (La_{0.75}Sr_{0.25})_{0.98}MnO₃/90 mol % ZrO₂-10 mol % Y₂O₃=50/50 (weight ratio).

### Comparative Example B5

A fuel cell specimen was prepared in the same manner as in Example B1, except that the mixed electrically conductive ceramic electrode was prepared so as to have a composition of (La_{0.75}Sr_{0.25})_{0.98}MnO₃/90 mol % ZrO₂-5 mol % Sc₂O₃-5 mol % Y₂O₃=50/50 (weight ratio).

### Comparative Example B6

A mixed electrically conductive ceramic electrode was prepared so as to have a composition of (La_{0.75}Sr_{0.25})_{0.98}MnO₃/(CeO₂)_{0.8}(Sm₂O₃)_{0.1}=50/50. (CeO₂)_{0.8}(Sm₂O₃)_{0.1} was prepared from a solution of nitrate of Ce and a solution of nitrate of Sm by coprecipitation with oxalic acid and was heat treated at 1200° C. The powder of (CeO₂)_{0.8}(Sm₂O₃)_{0.1} was then mixed with the powder of (La_{0.75}Sr_{0.25})_{0.99}MnO₃, and the mixture was fired at 1300° C. A fuel cell specimen was prepared in the same manner as in Example B22, except for the above matter.

### Comparative Example B7

A mixed electrically conductive ceramic electrode was prepared so as to have a composition of (La_{0.75}Sr_{0.25})_{0.98}MnO₃/90 mol % ZrO₂-10 mol % Sc₂O₃/(CeO₂)_{0.8}(Sm₂O₃)_{0.1}=50/25/25. (La_{0.75}Sr_{0.25})_{0.98}MnO₃, 90 mol % ZrO₂-10 mol % Sc₂O₃, and (CeO₂)0.8(Sm₂O₃)0.1 were prepared by coprecipitation. The powder of (La_{0.75}Sr_{0.25})_{0.98}MnO₃, the powder of 90 mol % ZrO₂-10 mol % Sc₂O₃, and the powder of (CeO₂)_{0.8}(Sm₂O₃)_{0.1} were mixed together, and the mixture was fired at 1300° C. A fuel cell specimen was prepared in the same manner as in Example B1, except for the above matter.

### Comparative Example B8

A mixed electrically conductive ceramic electrode was prepared so as to have a composition of (La_{0.75}Sr_{0.25})_{0.98}MnO₃/La_{0.8}Sr_{0.2}Ga_{0.8}Mg_{0.2}O₃=50/50. La_{0.8}Sr_{0.2}Ga_{0.8}Mg_{0.2}O₃ was prepared by mixing La₂O₃, SrCO₃, Ga₂O₃, and MgO together so as to give the above composition, ball milling the mixture, and heat treating the ball milled mixture at 1200° C. Thereafter, the power of (La_{0.75}Sr_{0.25})_{0.98}MnO₃ and the powder of La_{0.8}Sr_{0.2}Ga_{0.8}Mg_{0.2}O₃ were mixed together, and the mixture was fired at 1300° C. A fuel cell specimen was prepared in the same manner as in Example B1 except for the above matter.

Overvoltage Evaluation Test

The reaction overvoltage was measured by the same overvoltage measurement method as described above. The results were as summarized in the table below

TABLE 19

| | | Reaction |
|---|---|---|
| | | overvoltage, |
| | Electrode material | mV |
| Example B1 | (La_{0.75}Sr_{0.25})_{0.98}(Mn_{0.95}Ni_{0.05})O₃/ | 25 |
| | 90 mol % ZrO₂•10 mol % Sc₂O₃ = 50/50 | |
| Example B20 | (La_{0.75}Sr_{0.25})_{0.98}(Mn_{0.95}Ni_{0.05})O₃/ | 50 |
| | 90 mol % ZrO₂•10 mol % Y₂O₃ = 50/50 | |
| Example B21 | (La_{0.75}Sr_{0.25})_{0.98}(Mn_{0.95}Ni_{0.05})O₃/ | 35 |
| | 90 mol % ZrO₂•5 mol % Y₂O₃•5 mol % Sc₂O₃ = 50/50 | |
| Example B22 | (La_{0.75}Sr_{0.25})_{0.98}(Mn_{0.95}Ni_{0.05})O₃/ | 25 |
| | (CeO₂)_{0.8}(Sm₂O₃)_{0.1} | |
| Example B23 | (La_{0.75}Sr_{0.25})_{0.98}(Mn_{0.95}Ni_{0.05})O₃/ | 20 |
| | 90 mol % ZrO₂•10 mol % | |
| | Sc₂O₃/(CeO₂)_{0.8}(Sm₂O₃)_{0.1} | |
| Example B24 | (La_{0.75}Sr_{0.25})_{0.98}(Mn_{0.95}Ni_{0.05})O₃/ | 40 |
| | La_{0.8}Sr_{0.2}Ga_{0.8}Mg_{0.2}O₃ = 50/50 | |
| Comparative | (La_{0.75}Sr_{0.25})_{0.98}MnO₃/ | 105 |
| Example B4 | 90 mol % ZrO₂•10 mol % Y₂O₃ = 50/50 | |
| Comparative | (La_{0.75}Sr_{0.25})_{0.98}MnO₃/90 mol % | 96 |
| Example B5 | ZrO₂•5 mol % Sc₂O₃•5 mol % Y₂O₃ = 50/50 | |
| Comparative | (La_{0.75}Sr_{0.25})_{0.98}MnO₃/ | 75 |
| Example B6 | (CeO₂)_{0.8}(Sm₂O₃)_{0.1} = 50/50 | |
| Comparative | (La_{0.75}Sr_{0.25})_{0.98}MnO₃/90 mol % ZrO₂•10 mol % | 79 |
| Example B7 | Sc₂O₃/(CeO₂)_{0.8}(Sm₂O₃)_{0.1} = 50/25/25 | |
| Comparative | (La_{0.75}Sr_{0.25})_{0.98}MnO₃/ | 150 |
| Example B8 | La_{0.8}Sr_{0.2}Ga_{0.8}Mg_{0.2}O₃ = 50/50 | |

YSZ, ScYSZ, a cerium-containing oxide, a mixed material composed of SSZ and cerium oxide, and lanthanum gallate oxide were used as the material having oxygen ion conductive properties. It was confirmed that, for all the cases where mixing with a perovskite oxide containing at least manganese and nickel provides a low reaction overvoltage, whereas, for the nickel-free material, the reaction overvoltage is increased, and the incorporation of nickel in a manganese-containing perovskite oxide can significantly improve electrode characteristics. It is considered that the electrode characteristics were improved by suppression of the diffusion of manganese in the electrolyte.

Preparation of Solid Oxide Fuel Cell

### Example B25

(1) Preparation of Air Electrode Support

Lanthanum manganite containing Sr in solid solution and having a composition represented by La_{0.75}Sr_{0.25}MnO₃ was used as an air electrode. After preparation by coprecipitation, heat treatment was carried out to prepare a raw material powder for an air electrode. The average particle diameter was 30 μm. A cylindrical molded product was prepared by extrusion, and the molded product was then fired at 1500° C. to prepare an air electrode support. The air electrode support had a pore diameter of 14 μm, a porosity of 45%, and a wall thickness of 1.5 mm.

(2) Preparation of Air-Side Electrode Reaction Layer

A layer formed of an intimate mixture of manganese- and nickel-containing perovskite oxide with YSZ was prepared as an air-side electrode reaction layer. In this case, a material having a composition of (La_{0.75}Sr_{0.25})(Mn_{0.95}Ni_{0.05})O₃/90 mol % ZrO₂-10 mol % Sc₂O₃=50/50 (weight ratio) was prepared and used. An aqueous solution of nitrate of La, an aqueous solution of nitrate of Sr, an aqueous solution of nitrate of Mn, an aqueous solution of nitrate of Ni, an aqueous solution of nitrate of Zr, and an aqueous solution of nitrate of Y were provided and were mixed with each other so as to give the above composition, followed by coprecipitation with oxalic acid. Heat treatment was then carried out to prepare a raw material powder having a regulated particle diameter. The average particle diameter was 5 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. The slurry was coated onto the surface of the air electrode support (outer diameter 15 mm, wall thickness 1.5 mm, effective length 400 mm) to form a coating which was then sintered at 1400° C. The layer thus formed had a pore diameter of 5 μm, a porosity of 28%, and a thickness of 30 μm.

(3) Preparation of Slurry for Electrolyte:

YSZ having a composition of 90 mol % ZrO₂-10 mol % Y₂O₃ was prepared as a material for an electrolyte. An aqueous solution of nitrate of Zr and an aqueous solution of nitrate of Y were provided and were mixed with each other so as to give the above composition, followed by coprecipitation with oxalic acid. Heat treatment was then carried out to prepare a raw material powder having a regulated particle diameter. The average particle diameter was 0.5 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 140 mPas.

(4) Preparation of Electrolyte

The slurry prepared above was coated onto the surface of the air-side electrode reaction layer prepared in the above step (2), and the coating was sintered at 1400° C. The thickness of the electrolyte thus formed was 30 μm. In this case, the air electrode support in its part on which an interconnector film is to be formed in a later step was masked so as not to be coated.

(5) Preparation of Slurry for Fuel-Side Electrode Reaction Layer

NiO/SSZ having a composition of NiO/(ZrO₂)0.90(Sc₂O₃)0.10 was prepared as a material for a fuel-side electrode reaction layer. An aqueous solution of nitrate of Ni, an aqueous solution of nitrate of Zr, and an aqueous solution of nitrate of Sc were provided and were mixed with each other so as to give the above composition, and oxalic acid was then added for precipitation. The precipitate and the supernatant were dried, followed by heat treatment and particle diameter regulation to prepare a raw material. In this case, two types of compositions for the fuel-side electrode reaction layer, that is, NiO/(ZrO₂)_{0.90}(Sc₂O₃)_{0.10}=20/80 and 50/50 (weight ratio) were prepared. For both the cases, the average particle diameter was 0.5 μm. This powder (100 parts by weight) was mixed with 500 parts by weight of an organic solvent (ethanol), 10 parts by weight of a binder (ethylcellulose), 5 parts by weight of a dispersant (polyoxyethylene alkylphosphate), 1 part by weight of an antifoaming agent (sorbitan sesquioleate), and 5 parts by weight of a plasticizer (DBP). The mixture was then thoroughly stirred to prepare a slurry. This slurry had a viscosity of 70 mPas.

(6) Preparation of Fuel-Side Electrode Reaction Layer

The electrolyte layer formed in the above step (4) was masked so that the effective area was 150 cm². The slurry NiO/(ZrO₂)_{0.90}(Sc₂O₃)_{0.10}=20/80 (average particle diameter 0.5 μm) and the slurry NiO/(ZrO₂)_{0.90}(Sc₂O₃)_{0.10}=50/50 (average particle diameter 0.5 μm) prepared in the above step (5) were coated on the electrolyte layer in that order. The layer thickness (after sintering) was 10 μm.

(7) Preparation of Slurry for Fuel Electrode:

NiO/YSZ having a composition of NiO/(ZrO₂)_{0.90}(Y₂O₃)_{0.10} was prepared as a material for a fuel electrode. An aqueous solution of nitrate of Ni, an aqueous solution of nitrate of Zr, and an aqueous solution of nitrate of Y were provided and were mixed with each other so as to give the above composition, and oxalic acid was then added for precipitation. The precipitate and the supernatant were dried, followed by heat treatment and particle diameter regulation to prepare a raw material. In this case, a material having a composition of NiO/(ZrO₂)_{0.90}(Y₂O₃)_{0.10}=70/30 (weight ratio) was prepared. The average particle diameter was 2 μm. This powder (100 parts by weight) was mixed with 500 parts by weight of an organic solvent (ethanol), 20 parts by weight of a binder (ethylcellulose), 5 parts by weight of a dispersant (polyoxyethylene alkylphosphate), 1 part by weight of an antifoaming agent (sorbitan sesquioleate), and 5 parts by weight of a plasticizer (DBP). The mixture was then thoroughly stirred to prepare a slurry. This slurry had a viscosity of 250 mPas.

(8) Preparation of Fuel Electrode

The slurry prepared in the above step (7) was coated on the fuel-side electrode reaction layer formed in the above step (6). The film thickness (after sintering) was 90 μm. Further, the fuel-side electrode reaction layer and the fuel electrode were co-sintered at 1400° C.

(9) Preparation of Interconnector:

An interconnector having a composition of lanthanum chromite containing Ca in solid solution represented by La_{0.70}Ca_{0.30}CrO₃ was prepared. A raw material powder was prepared by spray pyrolysis and was then heat treated. The average particle diameter was 1 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. An interconnector was formed by slurry coating using this slurry and was then sintered at 1400° C. The thickness of the interconnector after sintering was 40 μm.

### Comparative Example B9

An air-side electrode reaction layer was prepared so as to have a composition of La_{0.75}Sr_{0.25}MnO₃/90 mol % ZrO₂-10 mol % Y₂O₃=50/50 (weight ratio). An aqueous solution of nitrate of La, an aqueous solution of nitrate of Sr, an aqueous solution of nitrate of Mn, an aqueous solution of nitrate of Ni, an aqueous solution of nitrate of Zr, and an aqueous solution of nitrate of Y were provided and were mixed with each other so as to give the above composition, followed by coprecipitation with oxalic acid. Heat treatment was then carried out to prepare a raw material powder having a regulated particle diameter. The average particle diameter was 5 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. The slurry was coated onto the surface of the air electrode support to form a coating which was then sintered at 1400° C. The sinter had a thickness of 30 μm. A fuel cell was prepared in the same manner as in Example B25 except for the above matter.

The determination of Mn content of the electrolyte in its surface on the fuel electrode side, a gas leakage test, a power generation test, and a durability test were carried out for the fuel cells thus obtained. The results were as shown in tables below.

TABLE 20

| | Gas | | |
|---|---|---|---|
| | permeability, | Mn content, | Initial potential, |
| | ×10⁻¹⁰ ms⁻¹Pa⁻¹ | wt % | V |
| Example B25 | 6.5 | 2.9 | 0.57 |
| Comparative | 6.5 | 5.5 | 0.48 |
| Example B9 | | | |

TABLE 21

| | | After | After | | Estimated |
|---|---|---|---|---|---|
| | After initial | 1000 | 1500 | After 2000 | potential, after |
| | potential, V | hr, V | hr, V | hr, V | 40,000 hr, V |
| Example B25 | 0.57 | 0.57 | 0.57 | 0.57 | 0.54 |
| Comparative | 0.48 | 0.48 | 0.48 | 0.475 | 0.38 |
| Example B9 | | | | | |

In Table 7, the estimated potential after 40000 hr is shown. This is so because the service life required of stationary fuel cells is 40000 hr. It is generally the that a potential lowering rate of not more than 10% at the time when a testing time of 40000 hr elapsed, poses no problem.

A test was carried out for the thickness of the air-side electrode reaction layer.

### Example B26

A fuel cell was prepared in the same manner as in Example B25, except that the thickness of the air-side electrode reaction layer was 3 μm.

### Example B27

A fuel cell was prepared in the same manner as in Example B25, except that the thickness of the air-side electrode reaction layer was 5 μm.

### Example B28

A fuel cell was prepared in the same manner as in Example B25, except that the thickness of the air-side electrode reaction layer was 20 μm.

### Example B29

A fuel cell was prepared in the same manner as in Example B25, except that the thickness of the air-side electrode reaction layer was 50 μm.

### Example B30

A fuel cell was prepared in the same manner as in Example B25, except that the thickness of the air-side electrode reaction layer was 55 μm.

A gas leakage test, a power generation test, a durability test, and a compositional analysis of the surface of the electrolyte were carried out for the fuel cells prepared above in the same manner as described above. The results were as shown in tables below.

TABLE 22

| | Thickness of | | | |
|---|---|---|---|---|
| | electrode | | Mn | Initial |
| | reaction layer, | Gas permeability, | content, | potential, |
| | μm | ×10⁻¹⁰ ms⁻¹Pa⁻¹ | wt % | V |
| Example B25 | 30 | 6.5 | 2.9 | 0.57 |
| Example B26 | 3 | 17.0 | 3.0 | 0.52 |
| Example B27 | 5 | 12.5 | 3.6 | 0.55 |
| Example B28 | 20 | 7.7 | 3.1 | 0.57 |
| Example B29 | 50 | 4.4 | 2.8 | 0.56 |
| Example B30 | 55 | 3.8 | 2.8 | 0.53 |

TABLE 23

| | | After | After | | Estimated |
|---|---|---|---|---|---|
| | After initial | 1000 | 1500 | After | potential, after |
| | potential, V | hr, V | hr, V | 2000 hr, V | 40,000 hr, V |
| Example B1 | 0.57 | 0.57 | 0.57 | 0.57 | 0.54 |
| Example B26 | 0.52 | 0.52 | 0.52 | 0.52 | 0.49 |
| Example B27 | 0.55 | 0.55 | 0.55 | 0.55 | 0.52 |
| Example B28 | 0.57 | 0.57 | 0.57 | 0.57 | 0.54 |
| Example B29 | 0.56 | 0.56 | 0.56 | 0.56 | 0.53 |
| Example B30 | 0.53 | 0.53 | 0.53 | 0.53 | 0.50 |

The above results show that an air-side electrode reaction layer thickness in the range of 5 to 50 μm is more preferred from the viewpoints of output performance and durability performance.

Effect of adoption of two-layer structure in air-side electrode reaction layer

### Example B31

A second air-side electrode reaction layer formed of an SSZ material having a composition of 90 mol % ZrO₂-10 mol % Sc₂O₃ was formed. In this case, an aqueous solution of nitrate of Zr, and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 2 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. The slurry was coated onto the surface of the air-side electrode reaction layer formed in the step (2) in Example B25 to form a coating which was then sintered at 1400° C. The second layer had a pore diameter of 1.5 μm and a porosity of 14% and a thickness of 10 μm. A fuel cell was prepared in the same manner as in Example B25 except for the above matter.

### Example B32

A fuel cell was prepared in the same manner as in Example B31, except that the thickness of the second air-side electrode reaction layer was 3 μm.

### Example B33

A fuel cell was prepared in the same manner as in Example B31, except that the thickness of the second air-side electrode reaction layer was 5 μm.

### Example B34

A fuel cell was prepared in the same manner as in Example B31, except that the thickness of the second air-side electrode reaction layer was 30 μm.

### Example B35

A fuel cell was prepared in the same manner as in Example B31, except that the thickness of the second air-side electrode reaction layer was 50 μm.

### Example B36

A fuel cell was prepared in the same manner as in Example B31, except that the thickness of the second air-side electrode reaction layer was 55 μm.

A gas leakage test, a power generation test, a durability test, and a compositional analysis of the surface of the electrolyte were carried out for the fuel cells prepared above in the same manner as described above. For the compositional analysis, in addition to the electrolyte on its surface in contact with the fuel electrode, the content of manganese in the electrolyte in its surface in contact with the second air-side electrode reaction layer was also determined in the same manner as described above. The same measurement was carried out for Comparative Example B9. The results were as shown in tables below.

TABLE 24

| | | | Air | Fuel | |
|---|---|---|---|---|---|
| | Thickness | | electrode | electrode | |
| | of second | Gas permeability, | side Mn, | side Mn | Initial |
| | layer, μm | ×10⁻¹⁰ ms⁻¹Pa⁻¹ | wt % | content, wt % | potential, V |
| Example B25 | 0 | 6.5 | 8.0 | 2.9 | 0.57 |
| Example B31 | 10 | 1.3 | 3.3 | 1.9 | 0.64 |
| Example B32 | 3 | 0.8 | 6.2 | 2.8 | 0.58 |
| Example B33 | 5 | 1.0 | 4.5 | 2.5 | 0.61 |
| Example B34 | 30 | 2.8 | 2.2 | 0.9 | 0.65 |
| Example B35 | 50 | 10.0 | 0.9 | 0.3 | 0.61 |
| Example B36 | 55 | 17.5 | 0.6 | 0.2 | 0.57 |
| Comparative | 0 | 6.5 | 10.5 | 5.5 | 0.48 |
| Example B9 | | | | | |

TABLE 25

| | | | | | Estimated |
|---|---|---|---|---|---|
| | | After | After | After | potential, |
| | After initial | 1000 hr, | 1500 hr, | 2000 hr, | after |
| | potential, V | V | V | V | 40,000 hr, V |
| Example B25 | 0.57 | 0.57 | 0.57 | 0.57 | 0.54 |
| Example B31 | 0.64 | 0.64 | 0.64 | 0.64 | 0.61 |
| Example B32 | 0.58 | 0.58 | 0.58 | 0.58 | 0.55 |
| Example B33 | 0.61 | 0.61 | 0.61 | 0.61 | 0.58 |
| Example B34 | 0.65 | 0.65 | 0.65 | 0.65 | 0.62 |
| Example B35 | 0.61 | 0.61 | 0.61 | 0.61 | 0.58 |
| Example B36 | 0.57 | 0.57 | 0.57 | 0.57 | 0.54 |

The above results show that the provision of the second air-side electrode reaction layer provides better results, and a thickness in the range 5 to 50 μm is more preferred.

A test was carried out for the construction of the electrolyte.

### Example B37

ScYSZ having a composition of 90 mol % ZrO₂-5 mol % Sc₂O₃-5 mol % Y₂O₃ was prepared as a material for an electrolyte. An aqueous solution of nitrate of Zr, an aqueous solution of nitrate of Y, and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.5 μm. A fuel cell was prepared in the same manner as in Example B25 except for the above matter.

### Example B38

SSZ having a composition of 90 mol % ZrO₂-10 mol % Sc₂O₃ was prepared as a material for an electrolyte. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.5 μm. A fuel cell was prepared in the same manner as in Example B25 except for the above matter.

### Example B39

SSZ having a composition of 90 mol % ZrO₂-10 mol % Sc₂O₃ and YSZ having a composition of 90 mol % ZrO₂-10 mol % Y₂O₃ were provided as materials for an electrolyte. YSZ was coated by slurry coating onto the surface of the air-side electrode reaction layer, and SSZ was then coated by slurry coating onto the surface of YSZ, and the assembly was sintered at 1400° C. The thickness of each of the layers was 15 μm. A fuel cell was prepared in the same manner as in Example B25 except for the above matter.

### Example B40

SSZ having a composition of 90 mol % ZrO₂-10 mol % Sc₂O₃ and YSZ having a composition of 90 mol % ZrO₂-10 mol % Y₂O₃ were provided as materials for an electrolyte. SSZ was coated by slurry coating onto the surface of the air-side electrode reaction layer, YSZ was then coated by slurry coating onto the surface of SSZ, and SSZ was further coated by slurry coating onto the surface of YSZ. The layers were co-sintered at 1400° C. The thickness of each of the layers was 10 μm. A fuel cell was prepared in the same manner as in Example B25 except for the above matter.

A gas leakage test, a power generation test, a durability test, and a compositional analysis of the surface of the electrolyte were carried out for the fuel cells prepared above in the same manner as described above. The results were as shown in tables below.

TABLE 26

| | Gas permeability, | Mn content, | Initial |
|---|---|---|---|
| | ×10⁻¹⁰ ms⁻¹Pa⁻¹ | wt % | potential, V |
| Example B25 | 6.5 | 2.9 | 0.57 |
| Example B37 | 5.7 | 2.7 | 0.60 |
| Example B38 | 11.3 | 2.1 | 0.61 |
| Example B39 | 6.5 | 2.1 | 0.61 |
| Example B40 | 6.8 | 2.0 | 0.62 |

TABLE 27

| | After | | | | Estimated |
|---|---|---|---|---|---|
| | initial | After | After | After | potential, |
| | potential, | 1000 hr, | 1500 hr, | 2000 hr, | after 40,000 hr, |
| | V | V | V | V | V |
| Example B25 | 0.57 | 0.57 | 0.57 | 0.57 | 0.54 |
| Example B37 | 0.60 | 0.60 | 0.60 | 0.60 | 0.57 |
| Example B38 | 0.61 | 0.61 | 0.61 | 0.61 | 0.58 |
| Example B39 | 0.61 | 0.61 | 0.61 | 0.61 | 0.58 |
| Example B40 | 0.62 | 0.62 | 0.62 | 0.62 | 0.59 |

### Example C1

(1) Preparation of Air Electrode Support

Lanthanum manganite containing Sr in solid solution and having a composition represented by La_{0.75}Sr_{0.25}MnO₃ was used as an air electrode. After preparation by coprecipitation, heat treatment was carried out to prepare a raw material powder for an air electrode. The average particle diameter was 30 μm. A cylindrical molded product was prepared by extrusion, and the molded product was then fired at 1500° C. to prepare an air electrode support. The air electrode support had a pore diameter of 14 μm, a porosity of 45%, and a wall thickness of 1.5 mm.

(2) Formation of Air-Side Electrode Reaction Layer (First Layer)

A layer formed of an intimate mixture of (La₁₋ₓAₓ)_{y}MnO₃ with YSZ was formed as a first layer using a material having a composition of La_{0.75}Sr_{0.25}MnO₃/90 mol % ZrO₂-10 mol % Y₂O₃=50/50 (weight ratio). An aqueous solution of nitrate of La, an aqueous solution of nitrate of Sr, an aqueous solution of nitrate of Mn, an aqueous solution of nitrate of Zr, and an aqueous solution of nitrate of Y were provided and were mixed with each other so as to give the above composition, followed by coprecipitation with oxalic acid. Heat treatment was then carried out to prepare a raw material powder having a regulated particle diameter. The average particle diameter was 5 μm. The powder for the first layer (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. The slurry was coated onto the surface of the air electrode support (outer diameter 15 mm, wall thickness 1.5 mm, effective length 400 mm) to form a coating which was then sintered at 1400° C. The first layer thus formed had a pore diameter of 5 μm, a porosity of 28%, and a thickness of 20 μm.

(3) Formation of Air-Side Electrode Reaction Layer (Second Layer)

SSZ having a composition of 90 mol % ZrO₂-10 mol % Sc₂O₃ was prepared as a material for a second layer. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 2 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. The slurry was coated onto the surface of the first layer to form a coating which was then sintered at 1400° C. The second layer had a pore diameter of 1.5 μm, a porosity of 14%, and a thickness of 10 μm.

(4) Preparation of Slurry for Elecrolyte

YSZ was provided as a material for an electrolyte. The composition of YSZ was 90 mol % ZrO₂-10 mol % Y₂O₃. An aqueous solution of nitrate of Zr and an aqueous solution of nitrate of Y were provided and were mixed with each other so as to give the above composition, followed by coprecipitation with oxalic acid. Heat treatment was then carried out to prepare a raw material powder having a regulated particle diameter. The average particle diameter was 0.5 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 140 mPas.

(5) Preparation of Electrolyte

The slurry prepared above was coated onto the second layer to form a coating which was then sintered at 1400° C. The thickness of the electrolyte thus formed was 30 μm. In this case, the air electrode support in its part on which an interconnector film is to be formed in a later step was masked so as not to be coated.

(6) Preparation of Slurry for Fuel-Side Electrode Reaction Layer

NiO/SSZ having a composition of NiO/(ZrO₂)_{0.90}(Sc₂O₃)_{0.10} was prepared as a material for a fuel-side electrode reaction layer. An aqueous solution of nitrate of Ni, an aqueous solution of nitrate of Zr, and an aqueous solution of nitrate of Sc were provided and were mixed with each other so as to give the above composition, and oxalic acid was then added for precipitation. The precipitate and the supernatant were dried, followed by heat treatment and particle diameter regulation to prepare a raw material. In this case, two types of compositions for the fuel-side electrode reaction layer, that is, NiO/(ZrO₂)_{0.90}(Sc₂O₃)_{0.10}=20/80 and 50/50 (weight ratio) were prepared. For both the cases, the average particle diameter was 0.5 μm. This powder (100 parts by weight) was mixed with 500 parts by weight of an organic solvent (ethanol), 10 parts by weight of a binder (ethylcellulose), 5 parts by weight of a dispersant (polyoxyethylene alkylphosphate), 1 part by weight of an antifoaming agent (sorbitan sesquioleate), and 5 parts by weight of a plasticizer (DBP). The mixture was then thoroughly stirred to prepare a slurry. This slurry had a viscosity of 70 mPas.

(7) Preparation of Fuel-Side Electrode Reaction Layer

The electrolyte layer formed in the above step (5) was masked so that the effective area was 150 cm². The slurry NiO/(ZrO₂)_{0.90}(Sc₂O₃)_{0.10} (average particle diameter)=20/80 (0.5 μm) and the slurry NiO/(ZrO₂)_{0.90}(Sc₂O₃)_{0.10}=50/50 (0.5 μm) were coated on the electrolyte layer in that order. The layer thickness. (after sintering) was 10 μm.

(8) Preparation of Slurry for Fuel Electrode:

NiO/YSZ having a composition of NiO/(ZrO₂)_{0.90}(Y₂O₃)_{0.10} was prepared as a material for a fuel electrode. An aqueous solution of nitrate of Ni, an aqueous solution of nitrate of Zr, and an aqueous solution of nitrate of Y were provided and were mixed with each other so as to give the above composition, and oxalic acid was then added for precipitation. The precipitate and the supernatant were dried, followed by heat treatment and particle diameter regulation to prepare a raw material. In this case, a material having a composition of NiO/(ZrO₂)_{0.90}(Y₂O₃)_{0.10}=70/30 (weight ratio) was prepared. The average particle diameter was 2 μm. This powder (100 parts by weight) was mixed with 500 parts by weight of an organic solvent (ethanol), 20 parts by weight of a binder (ethylcellulose), 5 parts by weight of a dispersant (polyoxyethylene alkylphosphate), 1 part by weight of an antifoaming agent (sorbitan sesquioleate), and 5 parts by weight of a plasticizer (DBP). The mixture was then thoroughly stirred to prepare a slurry. This slurry had a viscosity of 250 mPas

(9) Preparation of Fuel Electrode

The slurry for a fuel electrode was coated onto the fuel-side electrode reaction layer. The film thickness (after sintering) was 90 μm. Further, the fuel-side electrode reaction layer and the fuel electrode were co-sintered at 1400° C.

(10) Preparation of Interconnector:

An interconnector having a composition of lanthanum chromite containing Ca in solid solution represented by La_{0.70}Ca_{0.30}CrO₃ was prepared. A raw material powder was prepared by spray pyrolysis and was then heat treated. The average particle diameter was 1 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. An interconnector was formed by slurry coating using this slurry and was then sintered at 1400° C. The thickness of the interconnector after sintering was 40 μm.

### Comparative Example C1

YSZ was prepared as a material for an air-side electrode reaction layer. The composition of YSZ was 90 mol % ZrO₂-10 mol % Y₂O₃ (weight ratio). An aqueous solution of nitrate of Zr, and an aqueous solution of nitrate of Y were provided and were mixed with each other so as to give the above composition, followed by coprecipitation with oxalic acid. Heat treatment was then carried out to prepare a raw material powder having a regulated particle diameter. The average particle diameter was 2 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. The slurry was coated onto the surface of the air electrode support to form a coating which was then sintered at 1400° C. The sinter had a thickness of 30 μm. A fuel cell was prepared in the same manner as in Example C1 except for the above matter.

### Comparative Example C2

A layer formed of an intimate mixture composed of an intimate mixture of (La₁₋ₓAₓ)_{y}MnO₃ with YSZ and having a composition of La_{0.75}Sr_{0.25}MnO₃/90 mol % ZrO₂-10 mol % Y₂O₃=50/50 (weight ratio) was formed as an air-side electrode reaction layer. An aqueous solution of nitrate of La, an aqueous solution of nitrate of Sr, an aqueous solution of nitrate of Mn, an aqueous solution of nitrate of Zr, and an aqueous solution of nitrate of Y were provided and were mixed with each other so as to give the above composition, followed by coprecipitation with oxalic acid. Heat treatment was then carried out to prepare a raw material powder having a regulated particle diameter. The average particle diameter was 5 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. The slurry was coated onto the surface of the air electrode support, and the coating was then sintered at 1400° C. The thickness was 30 μm. A fuel cell was prepared in the same manner as in Example C1 except for the above matter.

### Comparative Example C3

A layer formed of an intimate mixture composed of an intimate mixture of (La₁₋ₓAₓ)_{y}MnO₃ with a cerium-containing oxide reprsented by general formula (CeO₂)_{0.8}(Y₂O₃)_{0.1} (hereinafter referred to as (La₁₋ₓAₓ)_{y}MnO₃/(CeO₂)_{0.8}(Y₂O₃)_{0.1}) was formed as an air-side electrode reaction layer. The composition of the intimate mixture was La_{0.75}Sr_{0.25}MnO₃/(CeO₂)_{0.8}(Y₂O₃)_{0.1}=50/50 (weight ratio). La_{0.75}Sr_{0.25}MnO₃ was prepared by preparing an aqueous solution of nitrate of La, an aqueous solution of nitrate of Sr, and an aqueous solution of ntirate of Mn, mixing the aqueous solutions together to give the above composition, then conducting coprecipitation with oxalic acid, and further heat treating the precipitate at 1200° C. (CeO₂)_{0.8}(Y₂O₃)_{0.1} was prepared by preparing an aqueous solution of nitrate of Ce and an aqueous solution of nitrate of Y, mixing the aqueous solutions together to give the above composition, then conducting coprecipitation with oxalic acid, and further heat treating the precipitate at 1200° C. The powder of La_{0.75}Sr_{0.25}MnO₃ and the powder of (CeO₂)_{0.8}(Y₂O₃)_{0.1} were mixed together, and the mixture was then heat treated at 1400° C., and the particle diameter was futher regulated to give a raw material powder. The average particle diameter was 5 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. The slurry was coated onto the surface of the air electrode support, and the coating was then sintered at 1400° C. The thickness was 30 μm. A fuel cell was prepared in the same manner as in Example C1 except for the above matter.

### Comparative Example C4

A fuel cell was prepared in the same manner as in Comparative Example C3, except that the electrolyte was sintered at 1500° C.

The determination of Mn content of the electrolyte in its surface on the fuel electrode side, a gas leakage test, a power generation test, and a durability test were carried out for the fuel cells thus obtained. The results were as shown in tables below.

TABLE 28

| | Gas permeability, | Mn content, | Initial |
|---|---|---|---|
| | ×10⁻¹⁰ ms⁻¹Pa⁻¹ | wt % | potential, V |
| Example C1 | 1.8 | 2.8 | 0.61 |
| Comparative | 3.0 | 4.8 | 0.40 |
| Example C1 | | | |
| Comparative | 6.5 | 5.5 | 0.48 |
| Example C2 | | | |
| Comparative | 210 | 0.1 | 0.41 |
| Example C3 | | | |
| Comparative | 17.5 | 4.8 | 0.54 |
| Example C4 | | | |

TABLE 29

| | | After | After | After | Estimated |
|---|---|---|---|---|---|
| | After initial | 1000 hr, | 1500 hr, | 2000 hr, | potential, after |
| | potential, V | V | V | V | 40,000 hr, V |
| Example C1 | 0.61 | 0.61 | 0.61 | 0.61 | 0.58 |
| Comparative | 0.40 | 0.40 | 0.40 | 0.395 | 0.30 |
| Example C1 | | | | | |
| Comparative | 0.48 | 0.48 | 0.48 | 0.475 | 0.38 |
| Example C2 | | | | | |
| Comparative | 0.41 | 0.41 | 0.40 | 0.38 | 0 |
| Example C3 | | | | | |
| Comparative | 0.51 | 0.51 | 0.51 | 0.505 | 0.41 |
| Example C4 | | | | | |

A test was carried out for the pore diameter of the second layer in the air-side electrode reaction layer.

### Example C2

A fuel cell was prepared in the same manner as in Example C1, except that the raw material for the second layer was regulated to an average particle diameter of 0.5 μm and was coated onto the surface of the first layer by slurry coating, and the coating was sintered at 1350° C.

### Example C3

A fuel cell was prepared in the same manner as in Example C1, except that the raw material for the second layer was regulated to an average particle diameter of 0.5 μm and was coated onto the surface of the first layer by slurry coating, and the coating was sintered at 1380° C.

### Example C4

A fuel cell was prepared in the same manner as in Example C1, except that the raw material for the second layer was regulated to an average particle diameter of 0.5 μm and was coated onto the surface of the first layer by slurry coating, and the coating was then sintered at 1400° C.

### Example C5

A fuel cell was prepared in the same manner as in Example C1, except that the raw material for the second layer was regulated to an average particle diameter of 2 μm and was coated onto the surface of the first layer by slurry coating, and the coating was then sintered at 1430° C.

### Example C6

A fuel cell was prepared in the same manner as in Example C1, except that the raw material for the second layer was regulated to an average particle diameter of 5 μm and was coated onto the surface of the first layer by slurry coating, and the coating was then sintered at 1430° C.

### Example C7

A fuel cell was prepared in the same manner as in Example C1, except that the raw material for the second layer was regulated to an average particle diameter of 5 μm and was coated onto the surface of the first layer by slurry coating, and the coating was then sintered at 1450° C.

The determination of Mn content of the electrolyte in its surface on the fuel electrode side, a gas leakage test, a power generation test, and a durability test were carried out for the fuel cells thus obtained. The results were as shown in tables below.

TABLE 30

| | Pore | | | | |
|---|---|---|---|---|---|
| | dia- | Poros- | Gas | Mn | Initial |
| | meter, | ity, | permeability, ×10⁻¹⁰ | content, | potential, |
| | μm | % | ms⁻¹Pa⁻¹ | wt % | V |
| Example | 2 | 14 | 1.8 | 2.8 | 0.61 |
| C1 | | | | | |
| Example | 0.2 | 6 | 1.5 | 2.3 | 0.61 |
| C2 | | | | | |
| Example | 0.1 | 3 | 1.1 | 4.0 | 0.60 |
| C3 | | | | | |
| Example | 0.08 | 2 | 0.6 | 4.6 | 0.55 |
| C4 | | | | | |
| Example | 5 | 25 | 3.2 | 3.5 | 0.60 |
| C5 | | | | | |
| Example | 10 | 40 | 8.5 | 3.2 | 0.60 |
| C6 | | | | | |
| Example | 12 | 43 | 14.5 | 4.4 | 0.55 |
| C7 | | | | | |

TABLE 31

| | After | After | After | After | Estimated |
|---|---|---|---|---|---|
| | initial | 1000 hr, | 1500 hr, | 2000 hr, | potential after |
| | potential, V | V | V | V | 40,000 hr, V |
| Example C1 | 0.61 | 0.61 | 0.61 | 0.61 | 0.58 |
| Example C2 | 0.61 | 0.61 | 0.61 | 0.61 | 0.58 |
| Example C3 | 0.60 | 0.60 | 0.60 | 0.60 | 0.57 |
| Example C4 | 0.55 | 0.55 | 0.55 | 0.55 | 0.51 |
| Example C5 | 0.60 | 0.60 | 0.60 | 0.60 | 0.57 |
| Example C6 | 0.60 | 0.60 | 0.60 | 0.60 | 0.57 |
| Example C7 | 0.55 | 0.55 | 0.55 | 0.55 | 0.51 |

The comparison of the gas permeability of the electrolyte layer shows that, for Examples C5 to C7, the gas permeability is in the preferred gas permeability range Q≦2.8×10⁻⁹ ms⁻¹Pa⁻¹ but not in the more preferred gas permeability range Q≦2.8×10⁻¹⁰ ms⁻¹Pa⁻¹. On the other hand, for Examples C1 to C4, the gas permeability is in the more preferred range Q≦2.8×10⁻¹⁰ ms⁻¹Pa⁻¹. When the gas permeability of the electrolyte is taken into consideration, it is apparent that a relationship represented by formula d1>d2>d3 wherein d1 represents the pore diameter of the air electrode; d2 represents the pore diameter of the first layer; and d3 represents the pore diameter of the second layer is preferably satisfied.

Further, it is apparent that the porosity of the second layer is more preferably 3 to 40%.

A test was carried out for the thickness of the second layer in the air-side electrode reaction layer.

### Example C8

A fuel cell was prepared in the same manner as in Example C1, except that the thickness of the second layer was 3 μm.

### Example C9

A fuel cell was prepared in the same manner as in Example C1, except that the thickness of the second layer was 5 μm.

### Example C10

A fuel cell was prepared in the same manner as in Example C1, except that the thickness of the second layer was 30 μm.

### Example C11

A fuel cell was prepared in the same manner as in Example C1, except that the thickness of the second layer was 50 μm.

### Example C12

A fuel cell was prepared in the same manner as in Example C1, except that the thickness of the second layer was 55 μm.

The determination of Mn content of the electrolyte in its surface on the fuel electrode side, a gas leakage test, a power generation test, and a durability test were carried out for the fuel cells thus obtained. The results were as shown in tables below.

TABLE 32

| | | | | Initial |
|---|---|---|---|---|
| | Thickness, | Gas permeability, | Mn content, | potential, |
| | μm | ×10⁻¹⁰ ms⁻¹Pa⁻¹ | wt % | V |
| Example C1 | 10 | 1.8 | 2.8 | 0.61 |
| Example C8 | 3 | 0.3 | 4.4 | 0.55 |
| Example C9 | 5 | 0.8 | 3.9 | 0.59 |
| Example C10 | 30 | 2.8 | 1.2 | 0.62 |
| Example C11 | 50 | 10.0 | 0.3 | 0.60 |
| Example C12 | 55 | 17.5 | 0.2 | 0.55 |

TABLE 33

| | | | | | Estimated |
|---|---|---|---|---|---|
| | | After | After | After | potential, |
| | After initial | 1000 hr, | 1500 hr, | 2000 hr, | after |
| | potential, V | V | V | V | 40,000 hr, V |
| Example C1 | 0.61 | 0.61 | 0.61 | 0.61 | 0.58 |
| Example C8 | 0.55 | 0.55 | 0.55 | 0.55 | 0.51 |
| Example C9 | 0.59 | 0.59 | 0.59 | 0.59 | 0.56 |
| Example C10 | 0.62 | 0.62 | 0.62 | 0.62 | 0.59 |
| Example C11 | 0.60 | 0.60 | 0.60 | 0.60 | 0.57 |
| Example C12 | 0.55 | 0.55 | 0.55 | 0.55 | 0.52 |

The above results show that the thickness of the second layer is more preferably in the range of 5 to 50 μm.

Further, it is apparent that the content of the manganese component in the fuel electrode-side surface of the electrolyte is more preferably 0.3 to 4% by weight.

A test was carried out for the thickness of the first layer in the air-side electrode reaction layer.

### Example C13

A fuel cell was prepared in the same manner as in Example C1, except that the thickness of the first layer was 3 μm.

### Example C14

A fuel cell was prepared in the same manner as in Example C1, except that the thickness of the first layer was 5 μm.

### Example C15

A fuel cell was prepared in the same manner as in Example C1, except that the thickness of the first layer was 30 μm.

### Example C16

A fuel cell was prepared in the same manner as in Example C1, except that the thickness of the first layer was 50 μm.

### Example C17

A fuel cell was prepared in the same manner as in Example C1, except that the thickness of the first layer was 55 μm.

The determination of Mn content of the electrolyte in its surface on the fuel electrode side, a gas leakage test, a power generation test, and a durability test were carried out for the fuel cells thus obtained. The results were as shown in tables below.

TABLE 34

| | | | | Initial |
|---|---|---|---|---|
| | Thickness, | Gas permeability, | Mn content, | potential, |
| | μm | ×10⁻¹⁰ ms⁻¹Pa⁻¹ | wt % | V |
| Example C1 | 20 | 1.8 | 2.8 | 0.61 |
| Example C13 | 3 | 4.0 | 4.5 | 0.55 |
| Example C14 | 5 | 2.5 | 4.0 | 0.58 |
| Example C15 | 30 | 1.5 | 2.7 | 0.61 |
| Example C16 | 50 | 2.8 | 2.5 | 0.59 |
| Example C17 | 55 | 4.0 | 2.4 | 0.55 |

TABLE 35

| | | | | | Estimated |
|---|---|---|---|---|---|
| | | After | After | After | potential, |
| | After initial | 1000 hr, | 1500 hr, | 2000 hr, | after |
| | potential, V | V | V | V | 40,000 hr, V |
| Example C1 | 0.61 | 0.61 | 0.61 | 0.61 | 0.58 |
| Example C13 | 0.55 | 0.55 | 0.55 | 0.55 | 0.51 |
| Example C14 | 0.58 | 0.58 | 0.58 | 0.58 | 0.55 |
| Example C15 | 0.61 | 0.61 | 0.61 | 0.61 | 0.58 |
| Example C16 | 0.59 | 0.59 | 0.59 | 0.59 | 0.56 |
| Example C17 | 0.55 | 0.55 | 0.55 | 0.55 | 0.52 |

The above results show that the thickness of the first layer is more preferably in the range of 5 to 50 μm.

A test was carried out with the material for the first layer and the material for the second layer in the air-side electrode reaction layer being varied.

### Example C18

ScYSZ was prepared as a material for the second layer. The composition of ScYSZ was 90 mol % ZrO₂-5 mol % Sc₂O₃-5 mol % Y₂O₃. An aqueous solution of nitrate of Zr, an aqueous solution of nitrate of Sc, and an aqueous solution of nitrate of Y were provided and were mixed with each other so as to give the above composition, followed by coprecipitation with oxalic acid. Heat treatment was then carried out to prepare a raw material powder having a regulated particle diameter. The average particle diameter was 2 μm. A fuel cell was prepared in the same manner as in Example C1 except for the above matter.

### Example C19

A layer formed of an intimate mixture composed of an intimate mixture of (La₁₋ₓAₓ)_{y}MnO₃ with SSZ was formed as a first layer. The composition of the intimate mixture was La_{0.75}Sr_{0.25}MnO₃/90 mol % ZrO₂-10 mol % Sc₂O₃=50/50 (weight ratio). An aqueous solution of nitrate of La, an aqueous solution of nitrate of Sr, an aqueous solution of nitrate of Mn, an aqueous solution of nitrate of Zr, and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 5 μm. A fuel cell was prepared in the same manner as in Example C1 exept for the above matter.

### Example C20

A layer formed of an intimate mixture of (La₁₋ₓAₓ)_{y}(Mn_{1-z}Ni_{z})O₃ with SSZ was formed as a first layer. The composition of the intimate mixture was (La_{0.75}Sr_{0.25})(Mn_{0.95}Ni_{0.05})O₃/90 mol % ZrO₂-10 mol % Sc₂O₃=50/50 (weight ratio). An aqueous solution of nitrate of La, an aqueous solution of nitrate of Sr, an aqueous solution of nitrate of Mn, an aqueous solution of nitrate of Ni, an aqueous solution of nitrate of Zr, and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 5 μm. A fuel cell was prepared in the same manner as in Example C1 except for the above matter.

### Example C21

A layer formed of an intimate mixture of (La₁₋ₓAₓ)_{y}(Mn_{1-z}Ni_{z})O₃ with ScYSZ was formed as a first layer. The composition of the intimate mixture was (La_{0.75}Sr_{0.25})(MnO₉₅Ni_{0.05})O₃/90 mol % ZrO₂-5 mol % Sc₂O₃-5 mol % Y₂O₃=50/50 (weight ratio). An aqueous solution of nitrate of La, an aqueous solution of nitrate of Sr, an aqueous solution of nitrate of Mn, an aqueous solution of nitrate of Ni, an aqueous solution of nitrate of Zr, an aqueous solution of nitrate of Y, and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 5 μm. A fuel cell was prepared in the same manner as in Example C1 except for the above matter.

The determination of Mn content of the electrolyte in its surface on the fuel electrode side, a gas leakage test, a power generation test, and a durability test were carried out for the fuel cells thus obtained. The results were as shown in tables below.

TABLE 36

| | Gas permeability, | Mn content, | Initial |
|---|---|---|---|
| | ×10⁻¹⁰ ms⁻¹Pa⁻¹ | wt % | potential, V |
| Example C1 | 1.8 | 2.8 | 0.61 |
| Example C18 | 1.0 | 3.0 | 0.61 |
| Example C19 | 2.4 | 2.4 | 0.64 |
| Example C20 | 1.8 | 1.5 | 0.69 |
| Example C21 | 1.0 | 1.7 | 0.68 |

TABLE 37

| | | | | | Estimated |
|---|---|---|---|---|---|
| | After | After | After | After | potential, |
| | initial | 1000 hr, | 1500 hr, | 2000 hr, | after |
| | potential, V | V | V | V | 40,000 hr, V |
| Example C1 | 0.61 | 0.61 | 0.61 | 0.61 | 0.58 |
| Example C18 | 0.59 | 0.59 | 0.59 | 0.59 | 0.56 |
| Example C19 | 0.64 | 0.64 | 0.64 | 0.64 | 0.61 |
| Example C20 | 0.69 | 0.69 | 0.69 | 0.69 | 0.66 |
| Example C21 | 0.68 | 0.68 | 0.68 | 0.68 | 0.65 |

Construction of Electrolyte

### Example C22

ScYSZ having a composition of 90 mol % ZrO₂-5 mol % Sc₂O₃-5 mol % Y₂O₃ was prepared as a material for an electrolyte. An aqueous solution of nitrate of Zr, an aqueous solution of nitrate of Y, and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.5 μm. A fuel cell was prepared in the same manner as in Example C1 except for the above matter.

### Example C23

SSZ having a composition of 90 mol % ZrO₂-10 mol % Sc₂O₃ was prepared as a material for an electrolyte. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.5 μm. A fuel cell was prepared in the same manner as in Example C1 except for the above matter.

### Example C24

SSZ having a composition of 90 mol % ZrO₂-10 mol % Sc₂O₃ and YSZ having a composition of 90 mol % ZrO₂-10 mol % Y₂O₃ were provided as materials for an electrolyte. YSZ was coated by slurry coating onto the surface of the second layer, SSZ was then coated by slurry coating onto the surface of YSZ, and the assembly was sintered at 1400° C. The thickness of each of the layers was 15 μm. A fuel cell was prepared in the same manner as in Example C1 except for the above matter.

### Example C25

SSZ having a composition of 90 mol % ZrO₂-10 mol % Sc₂O₃ and YSZ having a composition of 90 mol % ZrO₂-10 mol % Y₂O₃ were provided as materials for an electrolyte. SSZ was coated by slurry coating onto the surface of the second layer, YSZ was then coated by slurry coating onto the surface of SSZ, and SSZ was further coated by slurry coating onto the surface of YSZ. The layers were co-sintered at 1400° C. The thickness of each of the layers was 10 μm. A fuel cell was prepared in the same manner as in Example C1 except for the above matter.

The determination of Mn content of the electrolyte in its surface on the fuel electrode side, a gas leakage test, a power generation test, and a durability test were carried out for the fuel cells thus obtained. The results were as shown in tables below.

TABLE 38

| | Gas | | |
|---|---|---|---|
| | permeability, | Mn content, | Initial |
| | ×10⁻¹⁰ ms⁻¹Pa⁻¹ | wt % | potential, V |
| Example C1 | 1.8 | 2.8 | 0.61 |
| Example C22 | 1.6 | 2.3 | 0.63 |
| Example C23 | 8.5 | 1.6 | 0.64 |
| Example C24 | 1.8 | 1.8 | 0.65 |
| Example C25 | 2.1 | 1.6 | 0.66 |

TABLE 39

| | | | | | Estimated |
|---|---|---|---|---|---|
| | | After | After | After | potential, |
| | After initial | 1000 hr, | 1500 hr, | 2000 hr, | after |
| | potential, V | V | V | V | 40,000 hr, V |
| Example C1 | 0.61 | 0.61 | 0.61 | 0.61 | 0.58 |
| Example C22 | 0.63 | 0.63 | 0.63 | 0.63 | 0.60 |
| Example C23 | 0.64 | 0.64 | 0.64 | 0.64 | 0.61 |
| Example C24 | 0.65 | 0.65 | 0.65 | 0.65 | 0.62 |
| Example C25 | 0.66 | 0.66 | 0.66 | 0.66 | 0.63 |

### Example D1

(1) Preparation of Air Electrode Support

Lanthanum manganite containing Sr in solid solution and having a composition represented by La_{0.75}Sr_{0.25}MnO₃ was used as an air electrode. After preparation by coprecipitation, heat treatment was carried out to prepare a raw material powder for an air electrode. The raw material powder had an average particle diameter of 30 μm. The raw material powder was extruded into a cylindrical form. The cylindrical molded product was fired at 1500° C. to prepare an air electrode support. The air electrode support had a pore diameter of 14 μm, a porosity of 45%, and a wall thickness of 1.5 mm.

(2) Preparation of Air-Side Electrode Reaction Layer

A layer formed of an intimate mixture composed of an intimate mixture of (La₁₋ₓAₓ)_{y}MnO₃ with YSZ and having a composition of La_{0.75}Sr_{0.25}MnO₃/90 mol % ZrO₂-10 mol % Y₂O₃=50/50 (weight ratio) was formed as an air-side electrode reaction layer. An aqueous solution of nitrate of La, an aqueous solution of nitrate of Sr, an aqueous solution of nitrate of Mn, an aqueous solution of nitrate of Zr, and an aqueous solution of nitrate of Y were provided and were mixed with each other so as to give the above composition, followed by coprecipitation with oxalic acid. Heat treatment was then carried out to prepare a raw material powder having a regulated particle diameter. The average particle diameter was 5 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. The slurry was coated onto the surface of the air electrode support, and the coating was then sintered at 1400° C. The thickness was 30 μm.

(3) Preparation of Slurry for Elecrolyte:

YSZ was provided as a material for an electrolyte. The composition of YSZ was 90 mol % ZrO₂-10 mol % Y₂O₃. An aqueous solution of nitrate of Zr and an aqueous solution of nitrate of Y were provided and were mixed with each other so as to give the above composition, followed by coprecipitation with oxalic acid. Heat treatment was then carried out to prepare a raw material powder having a regulated particle diameter. The average particle diameter was 0.5 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 140 mPas.

(4) Preparation of Electrolyte

The slurry prepared above was coated onto the surface of the air-side electrode reaction layer to form a coating which was then sintered at 1400° C. The thickness of the electrolyte thus formed was 30 μm. In this case, the air electrode support in its part on which an interconnector film is to be formed in a later step was masked so as not to be coated. The porosity was 1%.

(5) Preparation of Slurry for Porous Layer Formed of Zirconia-Containing Fluorite Oxide

SSZ was provided as a material for a porous layer formed of zirconia-containing fluorite oxide. The composition of SSZ was 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.5 μm. This powder (20 parts by weight) was mixed with 100 parts by weight of a solvent (ethanol), 5 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 200 mPas.

(6) Preparation of Porous Layer Formed of Zirconia-Containing Fluorite Oxide

The slurry prepared above was coated onto the surface of the electrolyte layer, and the coating was sintered at 1400° C. The thickness of the porous layer thus formed was 20 μm. In this case, the air electrode support in its part on which an interconnector film is to be formed in a later step was masked so as not to be coated. The porous layer had a porosity of 15% and a pore diameter of 0.3 μm.

(7) Preparation of Slurry for Fuel-Side Electrode Reaction Layer

NiO/SSZ having a composition of NiO/(ZrO₂)_{0.90}(Sc₂O₃)_{0.10} was prepared as a material for a fuel-side electrode reaction layer. An aqueous solution of nitrate of Ni, an aqueous solution of nitrate of Zr, and an aqueous solution of nitrate of Sc were provided and were mixed with each other so as to give the above composition, and oxalic acid was then added for precipitation. The precipitate and the supernatant were dried, followed by heat treatment and particle diameter regulation to prepare a raw material. In this case, two types of compositions for the fuel-side electrode reaction layer, that is, NiO/(ZrO₂)_{0.90}(Sc₂O₃)_{0.10}=20/80 and 50/50 (weight ratio) were prepared. For both the cases, the average particle diameter was 0.5 μm. This powder (100 parts by weight) was mixed with 500 parts by weight of an organic solvent (ethanol), 10 parts by weight of a binder (ethylcellulose), 5 parts by weight of a dispersant (polyoxyethylene alkylphosphate), 1 part by weight of an antifoaming agent (sorbitan sesquioleate), and 5 parts by weight of a plasticizer (DBP). The mixture was then thoroughly stirred to prepare a slurry. This slurry had a viscosity of 70 mPas.

(8) Preparation of Fuel-Side Electrode Reaction Layer

The porous layer formed in the above step (6) was masked so that the effective area was 150 cm². The slurry NiO/(ZrO₂)_{0.90}(Sc₂O₃)_{0.10} (average particle diameter)=20/80 (0.5 μm) and the slurry NiO/(ZrO₂)_{0.90}(Sc₂O₃)_{0.10}=50/50 (0.5 μm) were coated on the porous layer in that order. The layer thickness (after sintering) was 10 μm.

(9) Preparation of Slurry for Fuel Electrode:

NiO/YSZ having a composition of NiO/(ZrO₂)_{0.90}(Y₂O₃)_{0.10} was prepared as a material for a fuel electrode. An aqueous solution of nitrate of Ni, an aqueous solution of nitrate of Zr, and an aqueous solution of nitrate of Y were provided and were mixed with each other so as to give the above composition, and oxalic acid was then added for precipitation. The precipitate and the supernatant were dried, followed by heat treatment and particle diameter regulation to prepare a raw material. In this case, a material having a composition of NiO/(ZrO₂)_{0.90}(Y₂O₃)_{0.10}=70/30 (weight ratio) was prepared. The average particle diameter was 2 μm. This powder (100 parts by weight) was mixed with 500 parts by weight of an organic solvent (ethanol), 20 parts by weight of a binder (ethylcellulose), 5 parts by weight of a dispersant (polyoxyethylene alkylphosphate), 1 part by weight of an antifoaming agent (sorbitan sesquioleate), and 5 parts by weight of a plasticizer (DBP). The mixture was then thoroughly stirred to prepare a slurry. This slurry had a viscosity of 250 mPas.

(10) Preparation of Fuel Electrode

The slurry for a fuel electrode was coated onto the fuel-side electrode reaction layer. The film thickness (after sintering) was 90 μm. Further, the fuel-side electrode reaction layer and the fuel electrode were co-sintered at 1400° C.

(11) Preparation of Interconnector:

An interconnector having a composition of lanthanum chromite containing Ca in solid solution represented by La_{0.70}Ca_{0.30}CrO₃ was prepared. A raw material powder was prepared by spray pyrolysis and was then heat treated. The average particle diameter was 1 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. An interconnector was formed by slurry coating using this slurry and was then sintered at 1400° C. The thickness of the interconnector after sintering was 40 μm.

The thickness referred to herein is a thickness determined by cutting the fuel cell, observing a cut section between the air electrode and the fuel electrode under SEM and calculating the thickness based on the scale of the photograph.

### Example D2

A fuel cell was prepared in the same manner as in Example D1, except that the thickness of the porous layer was 5 μm.

### Example D3

A fuel cell was prepared in the same manner as in Example D1, except that the thickness of the porous layer was 10 μm.

### Example D4

A fuel cell was prepared in the same manner as in Example D1, except that the thickness of the porous layer was 30 μm.

### Example D5

A fuel cell was prepared in the same manner as in Example D1, except that the thickness of the porous layer was 40 μm.

TABLE 40

| | Gas permeability, | Mn | |
|---|---|---|---|
| | ×10⁻¹⁰ ms⁻¹Pa⁻¹ | content, wt % | Initial potential, V |
| Example D1 | 1.8 | 1.5 | 0.59 |
| Example D2 | 4.4 | 3.5 | 0.54 |
| Example D3 | 2.9 | 2.8 | 0.58 |
| Example D4 | 2.8 | 0.9 | 0.58 |
| Example D5 | 5.1 | 0.5 | 0.55 |

TABLE 41

| | After | After | After | After | Estimated |
|---|---|---|---|---|---|
| | initial | 1000 hr, | 1500 hr, | 2000 hr, | potential, after |
| | potential, V | V | V | V | 40,000 hr, V |
| Example D1 | 0.59 | 0.59 | 0.59 | 0.59 | 0.56 |
| Example D2 | 0.54 | 0.54 | 0.54 | 0.54 | 0.51 |
| Example D3 | 0.58 | 0.58 | 0.58 | 0.58 | 0.55 |
| Example D4 | 0.58 | 0.58 | 0.58 | 0.58 | 0.55 |
| Example D5 | 0.55 | 0.55 | 0.55 | 0.55 | 0.52 |

A test was carried out with the porosity and pore diameter of the porous layer being varied.

### Example D6

SSZ was provided as a material for a porous layer formed of zirconia-containing fluorite oxide. The composition of SSZ was 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.3 μm. This powder (20 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. The slurry was coated onto the surface of the electrolyte to form a coating which was then sintered at 1400° C. The porous layer thus formed had a thickness of 20 μm, a porosity of 3%, and a pore diameter of 0.1 μm. A fuel cell was formed in the same manner as in Example D1 except for the above matter.

### Example D7

SSZ was provided as a material for a porous layer formed of zirconia-containing fluorite oxide. The composition of SSZ was 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.3 μm. This powder (20 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. The slurry was coated onto the surface of the electrolyte to form a coating which was then sintered at 1380° C. The porous layer thus formed had a thickness of 20 μm, a porosity of 8%, and a pore diameter of 0.05 μm. A fuel cell was formed in the same manner as in Example D1 except for the above matter.

### Example D8

SSZ was provided as a material for a porous layer formed of zirconia-containing fluorite oxide. The composition of SSZ was 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 1 μm. This powder (20 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. The slurry was coated onto the surface of the electrolyte to form a coating which was then sintered at 1400° C. The porous layer thus formed had a thickness of 20 μm, a porosity of 15%, and a pore diameter of 0.8 μm. A fuel cell was formed in the same manner as in Example D1 except for the above matter.

### Example D9

SSZ was provided as a material for a porous layer formed of zirconia-containing fluorite oxide. The composition of SSZ was 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 1 μm. This powder (20 parts by weight) was mixed with 100 parts by weight of a solvent (ethanol), 5 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. The slurry was coated onto the surface of the electrolyte to form a coating which was then sintered at 1400° C. The porous layer thus formed had a thickness of 20 μm, a porosity of 20%, and a pore diameter of 2 μm. A fuel cell was formed in the same manner as in Example D1 except for the above matter.

### Example D10

SSZ was provided as a material for a porous layer formed of zirconia-containing fluorite oxide. The composition of SSZ was 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 1 μm. This powder (20 parts by weight) was mixed with 100 parts by weight of a solvent (ethanol), 5 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. The slurry was coated onto the surface of the electrolyte to form a coating which was then sintered at 1350° C. The porous layer thus formed had a thickness of 20 μm, a porosity of 30%, and a pore diameter of 1.2 μm. A fuel cell was formed in the same manner as in Example D1 except for the above matter.

### Example D11

SSZ was provided as a material for a porous layer formed of zirconia-containing fluorite oxide. The composition of SSZ was 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.2 μm. This powder (30 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. The slurry was coated onto the surface of the electrolyte to form a coating which was then sintered at 1400° C. The porous layer thus formed had a thickness of 20 μm, a porosity of 2%, and a pore diameter of 0.04 μm. A fuel cell was formed in the same manner as in Example D1 except for the above matter.

### Example D12

SSZ was provided as a material for a porous layer formed of zirconia-containing fluorite oxide. The composition of SSZ was 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 2 μm. This powder (20 parts by weight) was mixed with 100 parts by weight of a solvent (ethanol), 5 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. The slurry was coated onto the surface of the electrolyte to form a coating which was then sintered at 1400° C. The porous layer thus formed had a thickness of 20 μm, a porosity of 32%, and a pore diameter of 2.5 μm. A fuel cell was formed in the same manner as in Example D1 except for the above matter.

TABLE 42

| | | Pore | Gas | | |
|---|---|---|---|---|---|
| | | diameter, | permeability, | Mn content, | Initial |
| | Porosity, % | μm | ×10⁻¹⁰ ms⁻¹Pa⁻¹ | wt % | potential, V |
| Example D1 | 12 | 0.3 | 1.8 | 1.5 | 0.59 |
| Example D6 | 3 | 0.1 | 0.6 | 3.3 | 0.57 |
| Example D7 | 8 | 0.05 | 1.5 | 2.6 | 0.58 |
| Example D8 | 15 | 0.8 | 2.9 | 1.4 | 0.59 |
| Example D9 | 20 | 2 | 4.1 | 1.2 | 0.58 |
| Example D10 | 30 | 1.2 | 10.7 | 0.8 | 0.57 |
| Example D11 | 2 | 0.03 | 0.5 | 3.7 | 0.53 |
| Example D12 | 33 | 2.5 | 17.2 | 0.5 | 0.58 |

TABLE 43

| | After | | | | Estimated |
|---|---|---|---|---|---|
| | initial | After | | After | potential, |
| | potential, V | 1000 hr, V | After 1500 hr, V | 2000 hr, V | after 40,000 hr, V |
| Example D1 | 0.59 | 0.59 | 0.59 | 0.59 | 0.56 |
| Example D6 | 0.57 | 0.57 | 0.57 | 0.57 | 0.54 |
| Example D7 | 0.58 | 0.58 | 0.58 | 0.58 | 0.55 |
| Example D8 | 0.59 | 0.59 | 0.59 | 0.59 | 0.56 |
| Example D9 | 0.58 | 0.58 | 0.58 | 0.58 | 0.55 |
| Example D10 | 0.57 | 0.57 | 0.57 | 0.57 | 0.54 |
| Example D11 | 0.53 | 0.53 | 0.53 | 0.53 | 0.50 |
| Example D12 | 0.53 | 0.53 | 0.53 | 0.53 | 0.50 |

A test was carried out for the material for the porous layer.

### Example D13

ScYSZ was provided as a material for the porous layer. The composition for ScYSZ was 90 mol % ZrO₂-5 mol % Sc₂O₃-5 mol % Y₂O₃. An aqueous solution of nitrate of Zr, an aqueous solution of nitrate of Sc, and an aqueous solution of nitrate of Y were mixed together to give the above composition, followed by coprecipitation with oxalic acid. A fuel cell was prepared in the same manner as in Example D1 except for the above matter.

### Example D14

YSZ was provided as a material for the porous layer. The composition for YSZ was 90 mol % ZrO₂-10 mol % Y₂O₃. An aqueous solution of nitrate of Zr and an aqueous solution of nitrate of Y were mixed together to give the above composition, followed by coprecipitation with oxalic acid. A fuel cell was prepared in the same manner as in Example D1 except for the above matter.

### Comparative Example D5

A layer formed of a cerium-containing oxide represented by (CeO₂)_{0.8}(Sm₂O₃)_{0.1} was provided between an electrolyte and a fuel-side electrode reaction layer. An aqueous solution of nitrate of Ce and an aqueous solution of nitrate of Sm were provided and mixed together to give the above composition, followed by coprecipitation with oxalic acid. Heat treatment was further carried out to prepare a raw material powder having a regulated particle diameter. The raw material powder had an average particle diameter of 0.5 μm, a porosity of 18%, and a pore diameter of 0.5 μm. A fuel cell was prepared in the same manner as in Example D1, except that this layer was provided.

The determination of Mn content of the electrolyte in its surface on the fuel electrode side, a gas leakage test, a power generation test, and a durability test were carried out for the fuel cells thus obtained. The results were as shown in tables below.

TABLE 44

| | Gas | | |
|---|---|---|---|
| | permeability, | Mn content, | |
| | ×10⁻¹⁰ ms⁻¹Pa⁻¹ | wt % | Initial potential, V |
| Example D1 | 1.8 | 1.5 | 0.59 |
| Example D13 | 1.3 | 1.7 | 0.58 |
| Example D14 | 1.3 | 2.0 | 0.56 |
| Comparative | 4.0 | 0.2 | 0.55 |
| Example D5 | | | |

TABLE 45

| | | | | | Estimated |
|---|---|---|---|---|---|
| | After initial | After | After | After | potential, |
| | potential, V | 1000 hr, V | 1500 hr, V | 2000 hr, V | after 40,000 hr, V |
| Example D1 | 0.59 | 0.59 | 0.59 | 0.59 | 0.56 |
| Example D13 | 0.58 | 0.58 | 0.58 | 0.58 | 0.55 |
| Example D14 | 0.56 | 0.56 | 0.56 | 0.56 | 0.53 |
| Comparative | 0.55 | 0.55 | 0.545 | 0.54 | 0.35 |
| Example D5 | | | | | |

A test was carried out for a material for an air side electrode reaction layer.

### Example D15

A layer formed of an intimate mixture of (La₁₋ₓAₓ)_{y}(Mn_{1-z}Ni_{z})O₃ with SSZ was formed as an air-side electrode reaction layer. The composition of the intimate mixture was (La_{0.75}Sr_{0.25})(Mn_{0.95}Ni_{0.05})O₃/90 mol % ZrO₂-10 mol % Sc₂O₃=50/50 (weight ratio). An aqueous solution of nitrate of La, an aqueous solution of nitrate of Sr, an aqueous solution of nitrate of Mn, an aqueous solution of nitrate of Ni, an aqueous solution of nitrate of Zr, and an aqueous solution of nitrate of Sc were prepared and mixed together to give the above composition, followed by coprecipitation with oxalic acid. Heat treatment was further carried out to prepare a raw material powder having a regulated particle diameter. The raw material powder had an average particle diameter of 5 μm. A fuel cell was prepared in the same manner as in Example D1, except for the above matter.

The determination of Mn content of the electrolyte in its surface on the fuel electrode side, a gas leakage test, a power generation test, and a durability test were carried out for the fuel cells thus obtained. The results were as shown in tables below.

TABLE 46

| | Gas permeability, | | Initial |
|---|---|---|---|
| | ×10⁻¹⁰ ms⁻¹Pa⁻¹ | Mn content, wt % | potential, V |
| Example D1 | 1.8 | 1.5 | 0.59 |
| Example D15 | 1.8 | 1.2 | 0.66 |

TABLE 47

| | | | | | Estimated |
|---|---|---|---|---|---|
| | After initial | | | | potential, |
| | potential, V | After 1000 hr, V | After 1500 hr, V | After 2000 hr, V | after 40,000 hr, V |
| Example D1 | 0.59 | 0.59 | 0.59 | 0.59 | 0.56 |
| Example D15 | 0.66 | 0.66 | 0.66 | 0.66 | 0.63 |

A test was carried out with the construction of the electrolyte being varied.

### Example D16

ScYSZ having a composition of 90 mol % ZrO₂-5 mol % SC₂O₃-5 mol % Y₂O₃ was prepared as a material for an electrolyte. An aqueous solution of nitrate of Zr, an aqueous solution of nitrate of Y, and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.5 μm. A fuel cell was prepared in the same manner as in Example D1 except for the above matter.

### Example D17

SSZ having a composition of 90 mol % ZrO₂-10 mol % Sc₂O₃ was prepared as a material for an electrolyte. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.5 μm. A fuel cell was prepared in the same manner as in Example D1 except for the above matter.

### Example D18

SSZ having a composition of 90 mol % ZrO₂-10 mol % Sc₂O₃ and YSZ having a composition of 90 mol % ZrO₂-10 mol % Y₂O₃ were provided as materials for an electrolyte. SSZ was coated by slurry coating onto the surface of the air-side electrode reaction layer, and YSZ was then coated by slurry coating onto the surface of SSZ, and the assembly was sintered at 1400° C. The thickness of each of the layers was 15 μm. A fuel cell was prepared in the same manner as in Example D1 except for the above matter.

### Example D19

SSZ having a composition of 90 mol % ZrO₂-10 mol % Sc₂O₃ and YSZ having a composition of 90 mol % ZrO₂-10 mol % Y₂O₃ were provided as materials for an electrolyte. SSZ was coated by slurry coating onto the surface of the air-side electrode reaction layer, YSZ was then coated by slurry coating onto the surface of SSZ, and SSZ was further coated by slurry coating onto the surface of YSZ. The layers were co-sintered at 1400° C. The thickness of each of the layers was 10 μm. A fuel cell was prepared in the same manner as in Example D1 except for the above matter.

The determination of Mn content of the electrolyte in its surface on the fuel electrode side, a gas leakage test, a power generation test, and a durability test were carried out for the fuel cells thus obtained. The results were as shown in tables below.

TABLE 48

| | Gas | | |
|---|---|---|---|
| | permeability, | | Initial |
| | ×10⁻¹⁰ ms⁻¹Pa⁻¹ | Mn content, wt % | potential, V |
| Example D1 | 1.8 | 1.5 | 0.59 |
| Example D16 | 1.6 | 1.1 | 0.61 |
| Example D17 | 10.1 | 0.5 | 0.60 |
| Example D18 | 2.7 | 1.1 | 0.63 |
| Example D19 | 3.5 | 0.9 | 0.63 |

TABLE 49

| | | | | | Estimated |
|---|---|---|---|---|---|
| | | | | | potential, |
| | After initial | | | | after |
| | potential, V | After 1000 hr, V | After 1500 hr, V | After 2000 hr, V | 40,000 hr, V |
| Example D1 | 0.59 | 0.59 | 0.59 | 0.59 | 0.56 |
| Example D16 | 0.61 | 0.61 | 0.61 | 0.61 | 0.58 |
| Example D17 | 0.60 | 0.60 | 0.60 | 0.60 | 0.57 |
| Example D18 | 0.63 | 0.63 | 0.63 | 0.63 | 0.60 |
| Example D19 | 0.63 | 0.63 | 0.63 | 0.63 | 0.60 |

### Example E1

A fuel cell was prepared in the same manner as in Example D1, except that the following two-layer structure was adopted in the air-side electrode reaction layer.

(1) Formation of Air-Side Electrode Reaction Layer (First Layer)

A layer formed of an intimate mixture of (La₁₋ₓAₓ)_{y}MnO₃ with YSZ was formed as a first layer using a material having a composition of La_{0.75}Sr_{0.25}MnO₃/90 mol % ZrO₂-10 mol % Y₂O₃=50/50 (weight ratio). An aqueous solution of nitrate of La, an aqueous solution of nitrate of Sr, an aqueous solution of nitrate of Mn, an aqueous solution of nitrate of Zr, and an aqueous solution of nitrate of Y were provided and were mixed with each other so as to give the above composition, followed by coprecipitation with oxalic acid. Heat treatment was then carried out to prepare a raw material powder having a regulated particle diameter. The average particle diameter was 5 μm. The powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. The slurry was coated onto the surface of the air electrode support (outer diameter 15 mm, wall thickness 1.5 mm, effective length 400 mm) to form a coating which was then sintered at 1400° C. The first layer thus formed had a pore diameter of 5 μm, a porosity of 28%, and a thickness of 20 μm.

(2) Formation of Air-Side Electrode Reaction Layer (Second Layer)

SSZ having a composition of 90 mol % ZrO₂-10 mol % Sc₂O₃ was prepared as a material for a second layer. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 2 μm. This powder (40 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. This slurry had a viscosity of 100 mPas. The slurry was coated onto the surface of the first layer to form a coating which was then sintered at 1400° C. The second layer had a pore diameter of 1.5 μm, a porosity of 14%, and a thickness of 10 μm.

### Example E2

A fuel cell was prepared in the same manner as in Example E1, except that the thickness of the porous layer was 5 μm.

### Example E3

A fuel cell was prepared in the same manner as in Example E1, except that the thickness of the porous layer was 10 μm.

### Example E4

A fuel cell was prepared in the same manner as in Example E1, except that the thickness of the porous layer was 30 μm.

### Example E5

A fuel cell was prepared in the same manner as in Example E1, except that the thickness of the porous layer was 40 μm.

The determination of Mn content of the electrolyte in its surface on the fuel electrode side, a gas leakage test, a power generation test, and a durability test were carried out for the fuel cells thus obtained. The results were as shown in tables below.

TABLE 50

| | Gas | | |
|---|---|---|---|
| | permeability, | | |
| | ×10⁻¹⁰ ms⁻¹Pa⁻¹ | Mn content, wt % | Initial potential, V |
| Example E1 | 2.3 | 1.1 | 0.66 |
| Example E2 | 4.2 | 1.4 | 0.64 |
| Example E3 | 2.6 | 1.3 | 0.66 |
| Example E4 | 2.4 | 0.7 | 0.66 |
| Example E5 | 4.6 | 0.3 | 0.65 |

TABLE 51

| | After | | | | Estimated |
|---|---|---|---|---|---|
| | initial | After | After | | potential |
| | potential, V | 1000 hr, V | 1500 hr, V | After 2000 hr, V | after 40,000 hr, V |
| Example E1 | 0.66 | 0.66 | 0.66 | 0.66 | 0.63 |
| Example E2 | 0.64 | 0.64 | 0.64 | 0.64 | 0.61 |
| Example E3 | 0.66 | 0.66 | 0.66 | 0.66 | 0.63 |
| Example E4 | 0.66 | 0.66 | 0.66 | 0.66 | 0.63 |
| Example E5 | 0.65 | 0.65 | 0.65 | 0.65 | 0.62 |

A test was carried out for the pore diameter of the second layer in the air-side electrode reaction layer.

### Example E6

A fuel cell was prepared in the same manner as in Example E1, except that the average particle diameter of the raw material for the second layer was brought to 0.5 μm, the raw material was applied by slurry coating onto the surface of the first layer, and the coating was then sintered at 1350° C.

### Example E7

A fuel cell was prepared in the same manner as in Example E1, except that the average particle diameter of the raw material for the second layer was brought to 0.5 μm, the raw material was applied by slurry coating onto the surface of the first layer, and the coating was then sintered at 1380° C.

### Example E8

A fuel cell was prepared in the same manner as in Example E1, except that the average particle diameter of the raw material for the second layer was brought to 0.5 μm, the raw material was applied by slurry coating onto the surface of the first layer, and the coating was then sintered at 1400° C.

### Example E9

A fuel cell was prepared in the same manner as in Example E1, except that the average particle diameter of the raw material for the second layer was brought to 2 μm, the raw material was applied by slurry coating onto the surface of the first layer, and the coating was then sintered at 1430° C.

### Example E10

A fuel cell was prepared in the same manner as in Example E1, except that the average particle diameter of the raw material for the second layer was brought to 5 μm, the raw material was applied by slurry coating onto the surface of the first layer, and the coating was then sintered at 1430° C.

### Example E11

A fuel cell was prepared in the same manner as in Example E1, except that the average particle diameter of the raw material for the second layer was brought to 5 μm, the raw material was applied by slurry coating onto the surface of the first layer, and the coating was then sintered at 1450° C.

TABLE 52

| | Pore | | Gas | | |
|---|---|---|---|---|---|
| | diameter, | | permeability, | Mn content, | Initial |
| | μm | Porosity, % | ×10⁻¹⁰ ms⁻¹Pa⁻¹ | wt % | potential, V |
| Example E1 | 2 | 14 | 2.3 | 1.1 | 0.66 |
| Example E6 | 0.2 | 6 | 1.3 | 1.4 | 0.66 |
| Example E7 | 0.1 | 3 | 1.1 | 1.4 | 0.66 |
| Example E8 | 0.08 | 2 | 0.6 | 1.5 | 0.63 |
| Example E9 | 5 | 25 | 3.2 | 2.5 | 0.66 |
| Example E10 | 10 | 40 | 8.5 | 2.2 | 0.65 |
| Example E11 | 12 | 43 | 14.5 | 3.3 | 0.63 |

TABLE 53

| | After | | | | |
|---|---|---|---|---|---|
| | initial | After | After | After | Estimated potential, |
| | potential, V | 1000 hr, V | 1500 hr, V | 2000 hr, V | after 40,000 hr, V |
| Example E1 | 0.66 | 0.66 | 0.66 | 0.66 | 0.63 |
| Example E6 | 0.66 | 0.66 | 0.66 | 0.66 | 0.63 |
| Example E7 | 0.66 | 0.66 | 0.66 | 0.66 | 0.63 |
| Example E8 | 0.63 | 0.63 | 0.63 | 0.63 | 0.60 |
| Example E9 | 0.66 | 0.66 | 0.66 | 0.66 | 0.63 |
| Example E10 | 0.65 | 0.65 | 0.65 | 0.65 | 0.62 |
| Example E11 | 0.63 | 0.63 | 0.63 | 0.63 | 0.60 |

The comparison of the gas permeability of the electrolyte shows that, for Examples 9 to 11, the gas permeability is in the preferred gas permeability range Q≦2.8×10⁻⁹ ms⁻¹Pa⁻¹ but not in the more preferred gas permeability range Q≦2.8×10⁻¹⁰ ms⁻¹Pa⁻¹. On the other hand, for Examples E1 and 6 to 8, the gas permeability is in the more preferred range Q≦2.8×10⁻¹⁰ ms⁻¹Pa⁻¹. When the gas permeability of the electrolyte is taken into consideration, it is apparent that a relationship represented by formula d1>d2>d3 wherein d1 represents the pore diameter of the air electrode; d2 represents the pore diameter of the first layer; and d3 represents the pore diameter of the second layer is preferably satisfied.

A test was carried out for the thickness of the second layer in the air-side electrode reaction layer.

### Example E12

A fuel cell was prepared in the same manner as in Example E1, except that the thickness of the second layer was 3 μm.

### Example E13

A fuel cell was prepared in the same manner as in Example E1, except that the thickness of the second layer was 5 μm.

### Example E14

A fuel cell was prepared in the same manner as in Example E1, except that the thickness of the second layer was 30 μm.

### Example E15

A fuel cell was prepared in the same manner as in Example E1, except that the thickness of the second layer was 50 μm.

### Example E16

A fuel cell was prepared in the same manner as in Example E1, except that the thickness of the second layer was 55 μm.

The determination of Mn content of the electrolyte in its surface on the fuel electrode side, a gas leakage test, a power generation test, and a durability test were carried out for the fuel cells thus obtained. The results were as shown in tables below.

TABLE 54

| | | | Mn | |
|---|---|---|---|---|
| | Thickness, | Gas permeability, | content, | Initial |
| | μm | ×10⁻¹⁰ ms⁻¹Pa⁻¹ | wt % | potential, V |
| Example E1 | 10 | 2.3 | 1.1 | 0.66 |
| Example E12 | 3 | 0.3 | 1.5 | 0.62 |
| Example E13 | 5 | 0.8 | 1.4 | 0.65 |
| Example E14 | 30 | 2.8 | 0.7 | 0.66 |
| Example E15 | 50 | 10.0 | 0.3 | 0.65 |
| Example E16 | 55 | 17.5 | 0.2 | 0.62 |

TABLE 55

| | After | | | | Estimated |
|---|---|---|---|---|---|
| | initial | After | After | After | potential, |
| | potential, V | 1000 hr, V | 1500 hr, V | 2000 hr, V | after 40,000 hr, V |
| Example E1 | 0.66 | 0.66 | 0.66 | 0.66 | 0.63 |
| Example E12 | 0.62 | 0.62 | 0.62 | 0.62 | 0.59 |
| Example E13 | 0.65 | 0.65 | 0.65 | 0.65 | 0.62 |
| Example E14 | 0.66 | 0.66 | 0.66 | 0.66 | 0.63 |
| Example E15 | 0.65 | 0.65 | 0.65 | 0.65 | 0.62 |
| Example E16 | 0.62 | 0.62 | 0.62 | 0.62 | 0.59 |

A test was carried out for the thickness of the first layer in the air-side electrode reaction layer.

### Example E17

A fuel cell was prepared in the same manner as in Example E1, except that the thickness of the first layer was 3 μm.

### Example E18

A fuel cell was prepared in the same manner as in Example E1, except that the thickness of the first layer was 5 μm.

### Example E19

A fuel cell was prepared in the same manner as in Example E1, except that the thickness of the first layer was 30 μm.

### Example E20

A fuel cell was prepared in the same manner as in Example E1, except that the thickness of the first layer was 50 μm.

### Example E21

A fuel cell was prepared in the same manner as in Example E1, except that the thickness of the first layer was 55 μm.

The determination of Mn content of the electrolyte in its surface on the fuel electrode side, a gas leakage test, a power generation test, and a durability test were carried out for the fuel cells thus obtained. The results were as shown in tables below.

TABLE 56

| | | Gas | | |
|---|---|---|---|---|
| | | permeability, | Mn | |
| | Thickness, | ×10⁻¹⁰ | content, | Initial |
| | μm | ms⁻¹Pa⁻¹ | wt % | potential, V |
| Example E1 | 20 | 2.3 | 1.1 | 0.66 |
| Example E17 | 3 | 4.0 | 3.3 | 0.62 |
| Example E18 | 5 | 2.5 | 2.6 | 0.65 |
| Example E19 | 30 | 1.5 | 0.8 | 0.66 |
| Example E20 | 50 | 2.8 | 0.4 | 0.65 |
| Example E21 | 55 | 4.0 | 0.3 | 0.62 |

TABLE 57

| | After | | | | Estimated |
|---|---|---|---|---|---|
| | initial | | | | potential, |
| | potential, V | After 1000 hr, V | After 1500 hr, V | After 2000 hr, V | after 40,000 hr, V |
| Example E1 | 0.66 | 0.66 | 0.66 | 0.66 | 0.63 |
| Example E17 | 0.62 | 0.62 | 0.62 | 0.62 | 0.59 |
| Example E18 | 0.65 | 0.65 | 0.65 | 0.65 | 0.62 |
| Example E19 | 0.66 | 0.66 | 0.66 | 0.66 | 0.63 |
| Example E20 | 0.65 | 0.65 | 0.65 | 0.65 | 0.62 |
| Example E21 | 0.62 | 0.62 | 0.62 | 0.62 | 0.59 |

A test was carried out with the porosity and pore diameter of the porous layer.

### Example E22

SSZ was provided as a material for a porous layer formed of zirconia-containing fluorite oxide. The composition of SSZ was 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.3 μm. This powder (20 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. The slurry was coated onto the surface of the electrolyte to form a coating which was then sintered at 1400° C. The porous layer thus formed had a thickness of 20 μm, a porosity of 3%, and a pore diameter of 0.1 μm. A fuel cell was formed in the same manner as in Example E1 except for the above matter.

### Example E23

SSZ was provided as a material for a porous layer formed of zirconia-containing fluorite oxide. The composition of SSZ was 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.3 μm. This powder (20 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. The slurry was coated onto the surface of the electrolyte to form a coating which was then sintered at 1380° C. The porous layer thus formed had a thickness of 20 μm, a porosity of 8%, and a pore diameter of 0.05 μm. A fuel cell was formed in the same manner as in Example E1 except for the above matter.

### Example E24

SSZ was provided as a material for a porous layer formed of zirconia-containing fluorite oxide. The composition of SSZ was 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 1 μm. This powder (20 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. The slurry was coated onto the surface of the electrolyte to form a coating which was then sintered at 1400° C. The porous layer thus formed had a thickness of 20 μm, a porosity of 15%, and a pore diameter of 0.8 μm. A fuel cell was formed in the same manner as in Example E1 except for the above matter.

### Example E25

SSZ was provided as a material for a porous layer formed of zirconia-containing fluorite oxide. The composition of SSZ was 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 1 μm. This powder (20 parts by weight) was mixed with 100 parts by weight of a solvent (ethanol), 5 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. The slurry was coated onto the surface of the electrolyte to form a coating which was then sintered at 1400° C. The porous layer thus formed had a thickness of 20 μm, a porosity of 20%, and a pore diameter of 2 μm. A fuel cell was formed in the same manner as in Example E1 except for the above matter.

### Example E26

SSZ was provided as a material for a porous layer formed of zirconia-containing fluorite oxide. The composition of SSZ was 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 1 μm. This powder (20 parts by weight) was mixed with 100 parts by weight of a solvent (ethanol), 5 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. The slurry was coated onto the surface of the electrolyte to form a coating which was then sintered at 1350° C. The porous layer thus formed had a thickness of 20 μm, a porosity of 30%, and a pore diameter of 1.2 μm. A fuel cell was formed in the same manner as in Example E1 except for the above matter.

### Example E27

SSZ was provided as a material for a porous layer formed of zirconia-containing fluorite oxide. The composition of SSZ was 90 mol % ZrO₂-10 mol % SC₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.2 μm. This powder (30 parts by weight) was mixed with 100 parts by weight of a solvent (ethanol), 2 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. The slurry was coated onto the surface of the electrolyte to form a coating which was then sintered at 1400° C. The porous layer thus formed had a thickness of 20 μm, a porosity of 2%, and a pore diameter of 0.04 μm. A fuel cell was formed in the same manner as in Example E1 except for the above matter.

### Example E28

SSZ was provided as a material for a porous layer formed of zirconia-containing fluorite oxide. The composition of SSZ was 90 mol % ZrO₂-10 mol % Sc₂O₃. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 2 μm. This powder (20 parts by weight) was mixed with 100 parts by weight of a solvent (ethanol), 5 parts by weight of a binder (ethylcellulose), 1 part by weight of a dispersant (polyoxyethylene alkylphosphate), and 1 part by weight of an antifoaming agent (sorbitan sesquioleate). The mixture was then thoroughly stirred to prepare a slurry. The slurry was coated onto the surface of the electrolyte to form a coating which was then sintered at 1400° C. The porous layer thus formed had a thickness of 20 μm, a porosity of 32%, and a pore diameter of 2.5 μm. A fuel cell was formed in the same manner as in Example E1 except for the above matter.

TABLE 58

| | | | Gas | | |
|---|---|---|---|---|---|
| | Poros- | Pore | permeability, | Mn | Initial |
| | ity, | diameter, | ×10⁻¹⁰ | content, | potential, |
| | % | μm | ms⁻¹Pa⁻¹ | wt % | V |
| Example E1 | 12 | 0.3 | 2.3 | 1.1 | 0.66 |
| Example E22 | 3 | 0.1 | 0.6 | 2.2 | 0.65 |
| Example E23 | 8 | 0.05 | 1.5 | 1.9 | 0.66 |
| Example E24 | 15 | 0.8 | 2.9 | 0.9 | 0.66 |
| Example E25 | 20 | 2 | 4.1 | 0.7 | 0.66 |
| Example E26 | 30 | 1.2 | 10.7 | 0.4 | 0.65 |
| Example E27 | 2 | 0.03 | 0.5 | 2.4 | 0.62 |
| Example E28 | 33 | 2.5 | 17.2 | 0.3 | 0.62 |

TABLE 59

| | | | | | Estimated |
|---|---|---|---|---|---|
| | | After | After | After | potential, |
| | After initial | 1000 hr, | 1500 hr, | 2000 hr, | after |
| | potential, V | V | V | V | 40,000 hr, V |
| Example E1 | 0.66 | 0.66 | 0.66 | 0.66 | 0.63 |
| Example E22 | 0.65 | 0.65 | 0.65 | 0.65 | 0.62 |
| Example E23 | 0.66 | 0.66 | 0.66 | 0.66 | 0.63 |
| Example E24 | 0.66 | 0.66 | 0.66 | 0.66 | 0.63 |
| Example E25 | 0.66 | 0.66 | 0.66 | 0.66 | 0.63 |
| Example E26 | 0.65 | 0.65 | 0.65 | 0.65 | 0.62 |
| Example E27 | 0.62 | 0.62 | 0.62 | 0.62 | 0.59 |
| Example E28 | 0.62 | 0.62 | 0.62 | 0.62 | 0.59 |

A test was carried out for the material for the first layer and the second layer in the air-side electrode reaction layer.

### Example E29

ScYSZ was prepared as a material for the second layer. The composition of ScYSZ was 90 mol % ZrO₂-5 mol % Sc₂O₃-5 mol % Y₂O₃. An aqueous solution of nitrate of Zr, an aqueous solution of nitrate of Sc, and an aqueous solution of nitrate of Y were provided and were mixed with each other so as to give the above composition, followed by coprecipitation with oxalic acid. Heat treatment was then carried out to prepare a raw material powder having a regulated particle diameter. The average particle diameter was 2 μm. A fuel cell was prepared in the same manner as in Example E1 except for the above matter.

### Example E30

A layer formed of an intimate mixture composed of an intimate mixture of (La₁₋ₓAₓ)_{y}MnO₃ with SSZ was formed as a first layer. The composition of the intimate mixture was La_{0.75}Sr_{0.25}MnO₃/90 mol % ZrO₂-10 mol % Sc₂O₃=50/50 (weight ratio). An aqueous solution of nitrate of La, an aqueous solution of nitrate of Sr, an aqueous solution of nitrate of Mn, an aqueous solution of nitrate of Zr, and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 5 μm. A fuel cell was prepared in the same manner as in Example E1 except for the above matter.

### Example E31

A layer formed of an intimate mixture of (La₁₋ₓAₓ)_{y}(Mn_{1-z}Ni_{z})O₃ with SSZ was formed as a first layer. The composition of the intimate mixture was (La_{0.75}Sr_{0.25})(Mn_{0.95}Ni_{0.05})O₃/90 mol % ZrO₂-10 mol % Sc₂O₃=50/50 (weight ratio). An aqueous solution of nitrate of La, an aqueous solution of nitrate of Sr, an aqueous solution of nitrate of Mn, an aqueous solution of nitrate of Ni, an aqueous solution of nitrate of Zr, and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 5 μm. A fuel cell was prepared in the same manner as in Example E1 except for the above matter.

### Example E32

A layer formed of an intimate mixture of (La₁₋ₓAₓ)_{y}(Mn_{1-z}Ni_{z})O₃ with ScYSZ was formed as a first layer. The composition of the intimate mixture was (La_{0.75}Sr_{0.25})(Mn_{0.95}Ni_{0.05})O₃/90 mol % ZrO₂-5 mol % Sc₂O₃-5 mol % Y₂O₃=50/50 (weight ratio). An aqueous solution of nitrate of La, an aqueous solution of nitrate of Sr, an aqueous solution of nitrate of Mn, an aqueous solution of nitrate of Ni, an aqueous solution of nitrate of Zr, an aqueous solution of nitrate of Y, and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 5 μm. A fuel cell was prepared in the same manner as in Example E1 except for the above matter.

The determination of Mn content of the electrolyte in its surface on the fuel electrode side, a gas leakage test, a power generation test, and a durability test were carried out for the fuel cells thus obtained. The results were as shown in tables below.

TABLE 60

| | Gas permeability, | | Initial |
|---|---|---|---|
| | ×10⁻¹⁰ ms⁻¹Pa⁻¹ | Mn content, wt % | potential, V |
| Example E1 | 2.3 | 1.1 | 0.66 |
| Example E29 | 1.4 | 1.3 | 0.65 |
| Example E30 | 2.6 | 1.0 | 0.69 |
| Example E31 | 2.4 | 0.8 | 0.72 |
| Example E32 | 1.8 | 0.9 | 0.71 |

TABLE 61

| | | | | | Estimated |
|---|---|---|---|---|---|
| | After | After | After | After | potential, |
| | initial | 1000 hr, | 1500 hr, | 2000 hr, | after |
| | potential, V | V | V | V | 40,000 hr, V |
| Example E1 | 0.66 | 0.66 | 0.66 | 0.66 | 0.63 |
| Example E29 | 0.65 | 0.65 | 0.65 | 0.65 | 0.62 |
| Example E30 | 0.69 | 0.69 | 0.69 | 0.69 | 0.66 |
| Example E31 | 0.72 | 0.72 | 0.72 | 0.72 | 0.69 |
| Example E32 | 0.71 | 0.71 | 0.71 | 0.71 | 0.68 |

A test was carried out for the material for the porous layer.

### Example E33

ScYSZ was provided as a material for a porous layer formed of zirconia-containing fluorite oxide. The composition of ScYSZ was 90 mol % ZrO₂-5 mol % Sc₂O₃-5mol % Y₂O₃. An aqueous solution of nitrate of Zr, an aqueous solution of nitrate of Sc, and an aqueous solution of nitrate of Y were provided and were mixed with each other so as to give the above composition, followed by coprecipitation with oxalic acid. A fuel cell was formed in the same manner as in Example E1 except for the above matter.

### Example E34

YSZ was provided as a material for a porous layer formed of zirconia-containing fluorite oxide. The composition of YSZ was 90 mol % ZrO₂-10 mol % Y₂O₃. An aqueous solution of nitrate of Zr and an aqueous solution of nitrate of Y were provided and were mixed with each other so as to give the above composition, followed by coprecipitation with oxalic acid. A fuel cell was formed in the same manner as in Example E1 except for the above matter.

### Comparative Example E8

A layer formed of a cerium-containing oxide represented by (CeO₂)_{0.8}(Sm₂O₃)_{0.1} was provided between an electrolyte and a fuel-side electrode reaction layer. An aqueous solution of nitrate of Ce and an aqueous solution of nitrate of Sm were provided and mixed together to give the above composition, followed by coprecipitation with oxalic acid. Heat treatment was further carried out to prepare a raw material powder having a regulated particle diameter. The raw material powder had an average particle diameter of 0.5 μm, a porosity of 18%, and a pore diameter of 0.5 μm. A fuel cell was prepared in the same manner as in Example E1, except that this layer was provided instead of the porous layer.

TABLE 62

| | Gas permeability, | Mn content, | |
|---|---|---|---|
| | ×10⁻¹⁰ ms⁻¹Pa⁻¹ | wt % | Initial potential, V |
| Example E1 | 2.3 | 1.1 | 0.66 |
| Example E33 | 1.7 | 1.5 | 0.65 |
| Example E34 | 1.7 | 1.7 | 0.63 |
| Comparative | 4.8 | 0.1 | 0.65 |
| Example E8 | | | |

TABLE 63

| | | | | | Estimated |
|---|---|---|---|---|---|
| | | After | After | After | potential, |
| | After initial | 1000 hr, | 1500 hr, | 2000 hr, | after |
| | potential, V | V | V | V | 40,000 hr, V |
| Example E1 | 0.66 | 0.66 | 0.66 | 0.66 | 0.63 |
| Example E33 | 0.65 | 0.65 | 0.65 | 0.65 | 0.62 |
| Example E34 | 0.63 | 0.63 | 0.63 | 0.63 | 0.60 |
| Comparative | 0.65 | 0.65 | 0.645 | 0.64 | 0.45 |
| Example E8 | | | | | |

A test was carried out with the construction of the electrolyte being varied.

### Example E35

ScYSZ having a composition of 90 mol % ZrO₂-5 mol % Sc₂O₃-5 mol % Y₂O₃ was prepared as a material for an electrolyte. An aqueous solution of nitrate of Zr, an aqueous solution of nitrate of Y, and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.5 μm. A fuel cell was prepared in the same manner as in Example E1 except for the above matter.

### Example E36

SSZ having a composition of 90 mol % ZrO₂-10 mol % Sc₂O₃ was prepared as a material for an electrolyte. An aqueous solution of nitrate of Zr and an aqueous solution of nitrate of Sc were provided and were mixed with each other so as to give the above composition, followed by coprecipitation with oxalic acid. Heat treatment was then carried out to prepare a raw material powder having a regulated particle diameter. The average particle diameter was 0.5 μm. A fuel cell was prepared in the same manner as in Example E1 except for the above matter.

### Example E37

SSZ having a composition of 90 mol % ZrO₂-10 mol % Sc₂O₃ and YSZ having a composition of 90 mol % ZrO₂-10 mol % Y₂O₃ were provided as materials for an electrolyte. YSZ was coated by slurry coating onto the surface of the second layer, and SSZ was then coated by slurry coating onto the surface of YSZ, and the assembly was sintered at 1400° C. The thickness of each of the layers was 15 μm. A fuel cell was prepared in the same manner as in Example E1 except for the above matter.

### Example E38

SSZ having a composition of 90 mol % ZrO₂-10 mol % Sc₂O₃ and YSZ having a composition of 90 mol % ZrO₂-10 mol % Y₂O₃ were provided as materials for an electrolyte. SSZ was coated by slurry coating onto the surface of the second layer, and YSZ was then coated by slurry coating onto the surface of SSZ, and the assembly was sintered at 1400° C. The thickness of each of the layers was 15 μm. A fuel cell was prepared in the same manner as in Example E1 except for the above matter.

### Example E39

SSZ having a composition of 90 mol % ZrO₂-10 mol % Sc₂O₃ and YSZ having a composition of 90 mol % ZrO₂-10 mol % Y₂O₃ were provided as materials for an electrolyte. SSZ was coated by slurry coating onto the surface of the second layer, YSZ was then coated by slurry coating onto the surface of SSZ, and SSZ was further coated by slurry coating onto the surface of YSZ. The layers were co-sintered at 1400° C. The thickness of each of the layers was 10 μm. A fuel cell was prepared in the same manner as in Example E1 except for the above matter.

TABLE 64

| | Gas | | |
|---|---|---|---|
| | permeability, | Mn content, | |
| | ×10⁻¹⁰ ms⁻¹Pa⁻¹ | wt % | Initial potential, V |
| Example E1 | 2.3 | 1.1 | 0.66 |
| Example E35 | 1.4 | 1.0 | 0.68 |
| Example E36 | 10.1 | 0.4 | 0.68 |
| Example E37 | 1.8 | 0.6 | 0.69 |
| Example E38 | 2.5 | 0.6 | 0.69 |
| Example E39 | 2.1 | 0.4 | 0.69 |

TABLE 65

| | | | | | Estimated |
|---|---|---|---|---|---|
| | | After | After | After | potential, |
| | After initial | 1000 hr, | 1500 hr, | 2000 hr, | after |
| | potential, V | V | V | V | 40,000 hr, V |
| Example E1 | 0.66 | 0.66 | 0.66 | 0.66 | 0.63 |
| Example E35 | 0.68 | 0.68 | 0.68 | 0.68 | 0.65 |
| Example E36 | 0.68 | 0.68 | 0.68 | 0.68 | 0.65 |
| Example E37 | 0.69 | 0.69 | 0.69 | 0.69 | 0.66 |
| Example E38 | 0.69 | 0.69 | 0.69 | 0.69 | 0.66 |
| Example E39 | 0.69 | 0.69 | 0.69 | 0.69 | 0.66 |

1. A solid oxide fuel cell comprising at least an electrolyte, an air electrode, and a fuel electrode, wherein
the air electrode comprises a perovskite oxide containing at least manganese, and
the content of manganese in the surface of a layer which is in contact with the fuel electrode is 0.3 to 4% by weight, where the surface is on the fuel electrode side of the layer.

2. The solid oxide fuel cell according to claim 1, wherein the layer in contact with the fuel electrode is the electrolyte.

3. The solid oxide fuel cell according to claim 1, wherein
a porous layer is provided between the fuel electrode and the electrolyte,
the layer in contact with the fuel electrode is the porous layer,
the porous layer is formed of a zirconia-containing fluorite oxide, has a thickness of 5 to 40 μm, and a porosity larger than the electrolyte.

4. The solid oxide fuel cell according to claim 1, wherein an air-side electrode reaction layer is provided between the air electrode and the electrolyte.

5. The solid oxide fuel cell according to claim 1, wherein the content of manganese in the electrolyte in its surface on the air electrode side is larger than the content of the manganese component in the electrolyte in its surface on the fuel electrode side.

6. The solid oxide fuel cell according to claim 1, wherein the content of manganese in the electrolyte in its surface on the fuel electrode side is 0.6 to 3.5% by weight.

7. The solid oxide fuel cell according to claim 1, wherein the content of manganese in the electrolyte in its surface on the fuel electrode side is 0.9 to 3% by weight.

8. The solid oxide fuel cell according to claim 1, wherein the content of manganese in the electrolyte in its surface on the air electrode side is less than 10% by weight.

9. The solid oxide fuel cell according to claim 1, wherein the content of manganese in the electrolyte in its surface on the air electrode side is less than 6% by weight.

10. The solid oxide fuel cell according to claim 4, wherein the air-side electrode reaction layer comprises a mixed electrically conductive ceramic which comprises a manganese- and nickel-containing perovskite oxide and a zirconia-containing oxide and the air-side electrode reaction layer has interconnected open pores.

11. The solid oxide fuel cell according to claim 4, wherein the air-side electrode reaction layer comprises a mixed electrically conductive ceramic which comprises a manganese- and nickel-containing perovskite oxide and cerium oxide and the air-side electrode reaction layer has interconnected open pores.

12. The solid oxide fuel cell according to claim 4, wherein the air-side electrode reaction layer comprises a mixed electrically conductive ceramic which comprises a manganese- and nickel-containing perovskite oxide and a lanthanum- and gallium-containing perovskite oxide and the air-side electrode reaction layer has interconnected open pores.

13. The solid oxide fuel cell according to claim 10, wherein the content of the manganese- and nickel-containing perovskite oxide in the air-side electrode reaction layer is 30 to 70% by weight.

14. The solid oxide fuel cell according to claim 10, wherein the manganese- and nickel-containing perovskite oxide is represented by (Ln₁₋ₓAₓ)_{y}(Mn_{1-z}Ni_{z})O₃ wherein Ln represents one or at least two elements selected from the group consisting of Sc, Y, La, Ce, Pr, Nd, Pm, Sm, Eu, Gd, Tb, Dy, Ho, Er, Tm, Yb, and Lu; A represents Ca or Sr; x satisfies 0.15≦x≦0.3; y satisfies 0.97≦y≦1; and z satisfies 0.02≦z≦0.10.

15. The solid oxide fuel cell according to claim 10, wherein the zirconia-containing oxide is zirconia containing scandia in solid solution.

16. The solid oxide fuel cell according to claim 10, wherein the zirconia-containing oxide is zirconia containing scandia and yttria in solid solution.

17. The solid oxide fuel cell according to claim 11, wherein the cerium oxide is represented by (CeO₂)_{1-2X1}(J₂O₃)_{X1} wherein J represents Sm, Gd, or Y; and X1 satisfies 0.05≦X1≦0.15.

18. The solid oxide fuel cell according to claim 4, wherein the air-side electrode reaction layer comprises at least two layers of a first layer on the air electrode side and a second layer on the electrolyte side.

19. The solid oxide fuel cell according to claim 18, wherein
the first layer comprises a mixture of a manganese-containing perovskite oxide with zirconia containing scandia and/or yttria in solid solution and has interconnected open pores, and
the second layer comprises zirconia containing scandia in solid solution and has a porosity larger than the electrolyte.

20. The solid oxide fuel cell according to claim 18, wherein
the first layer comprises a mixture of a manganese-containing perovskite oxide with cerium containing oxide and has interconnected open pores, and
the second layer comprises zirconia containing scandia in solid solution and has a porosity larger than the electrolyte.

21. The solid oxide fuel cell according to claim 18, wherein
the first layer comprises a mixture of a manganese-containing perovskite oxide with a lanthanum- and gallium-containing perovskite oxide and has interconnected open pores, and
the second layer comprises zirconia containing scandia in solid solution and has a porosity larger than the electrolyte.

22. The solid oxide fuel cell according to claim 18, wherein
the first layer comprises a lanthanum- and cobalt-containing perovskite oxide and has interconnected open pores, and
the second layer comprises zirconia containing scandia in solid solution and has a porosity larger than the electrolyte.

23. The solid oxide fuel cell according to claim 18, wherein
the first layer comprises a mixture of a manganese-containing perovskite oxide with zirconia containing scandia and/or yttria in solid solution and has interconnected open pores, and
the second layer comprises cerium oxide and has a porosity larger than the electrolyte.

24. The solid oxide fuel cell according to claim 18, wherein the diameter of pores in the second layer is 0.1 to 10 μm.

25. The solid oxide fuel cell according to claim 18, which satisfies a relationship represented by formula d1>d2>d3 wherein d1 represents the diameter of pores in the air electrode; d2 represents the diameter of pores in the first layer; and d3 represents the diameter of pores in the second layer.

26. The solid oxide fuel cell according to claim 18, wherein the second layer has a porosity of 3 to 40%.

27. The solid oxide fuel cell according to claim 18 which satisfies a relationship represented by formula a1≧a2≧a3>a4 wherein a1 represents the porosity of the air electrode; a2 represents the porosity of the first layer; a3 represents the porosity of the second layer; and a4 represents the porosity of the electrolyte.

28. The solid oxide fuel cell according to claim 18, wherein the second layer has a thickness of 5 to 50 μm.

29. The solid oxide fuel cell according to claim 18, wherein the first layer has a thickness of 5 to 50 μm.

30. The solid oxide fuel cell according to claim 23, wherein the cerium oxide constituting the second layer is represented by (CeO₂)_{1-2X1}(J₂O₃)_{X1} wherein J represents Sm, Gd, or Y; and X1 satisfies 0.05≦X1≦0.15.

31. The solid oxide fuel cell according to claim 20, wherein the manganese-containing perovskite oxide constituting the first layer is a lanthanum manganite represented by (La₁₋ₓAₓ)_{y}MnO₃ wherein A represents Ca or Sr; x satisfies 0.15≦x≦0.3; and y satisfies 0.97≦y≦1.

32. The solid oxide fuel cell according to claim 20, wherein the manganese-containing perovskite oxide constituting the first layer is a lanthanum manganite represented by (La₁₋ₓAₓ)_{y}(Mn_{1-z}Ni_{z})O₃ wherein A represents Ca or Sr; x satisfies 0.15≦x≦0.3; y satisfies 0.97≦y≦1; and z satisfies 0.02≦z≦0.10.

33. The solid oxide fuel cell according to claim 20, wherein the cerium oxide constituting the first layer is represented by (CeO₂)_{1-2X1}(J₂O₃)_{X1} wherein J represents Sm, Gd, or Y; and X1 satisfies 0.05≦X1≦0.15.

34. The solid oxide fuel cell according to claim 1, wherein the electrolyte comprises a layer formed of zirconia containing scandia and/or yttria in solid solution.

35. The solid oxide fuel cell according to claim 1, wherein the electrolyte comprises at least two layers of a layer which is provided on the air-side electrode reaction layer side and comprises zirconia containing yttria in solid solution and a layer which is provided on the fuel electrode side and comprises zirconia containing scandia in solid solution.

36. The solid oxide fuel cell according to claim 1, wherein the electrolyte comprises at least two layers of a layer which is provided on the air-side electrode reaction layer side and comprises zirconia containing scandia in solid solution and a layer which is provided on the fuel electrode side and comprises zirconia containing yttria in solid solution.

37. The solid oxide fuel cell according to claim 1, wherein the electrolyte comprises at least three layers of a layer which comprises zirconia containing scandia in solid solution, a layer which comprises zirconia containing yttria in solid solution, and a layer which comprises zirconia containing scandia in solid solution stacked in that order.

38. The solid oxide fuel cell according to any one of claim 1, wherein the air electrode is formed of a lanthanum manganite represented by (La₁₋ₓAₓ)_{y}MnO₃ wherein A represents Ca or Sr; x satisfies 0.15≦x≦0.3; and y satisfies 0.97≦y≦1.

39. The solid oxide fuel cell according to claim 3, wherein the content of manganese in the electrolyte in its surface on the air electrode side is larger than the content of manganese in the porous layer, formed of a fluorite oxide, in its surface on the fuel electrode side.

40. The solid oxide fuel cell according to claim 39, wherein the content of the manganese component in the porous layer, formed of a fluorite oxide, in its surface on the fuel electrode side is 0.6 to 3.5% by weight.

41. The solid oxide fuel cell according to claim 39, wherein the content of the manganese component in the porous layer, formed of a fluorite oxide, in its surface on the fuel electrode side is 0.9 to 3% by weight.

42. The solid oxide fuel cell according to claim 3, wherein the porous layer formed of fluorite oxide has a porosity of 3 to 30%.

43. The solid oxide fuel cell according to claim 3, which satisfies a relationship represented by formula a1<a2<a3 wherein a1 represents the porosity of the electrolyte; a2 represents the porosity of the porous layer formed of the fluorite oxide; and a3 represents the porosity of the fuel electrode.

44. The solid oxide fuel cell according to claim 3, wherein the diameter of pores in the porous layer formed of the fluorite oxide is 0.05 to 2 μm.

45. The solid oxide fuel cell according to claim 3, wherein the fluorite oxide is zirconia containing scandia in solid solution.

46. The solid oxide fuel cell according to any one of claim 3, wherein the fluorite oxide is zirconia containing scandia and yttria in solid solution.

47. The solid oxide fuel cell according to claim 2, wherein the electrolyte in its film surface on the fuel electrode side has such a crystal grain size distribution that the 3% diameter of the crystal grains is not less than 3 μm and the 97% diameter of the crystal grains is not more than 20 μm.
